(19) United States
(12) Patent Application Publication
(10) Pub. No.: US 2026/0308293 A1
(43) Pub. Date: Oct. 8, 2026

(54) SOLUTION PHASE POLYMERIZATION PROCESS

(71) Applicant: NOVA Chemicals (International) S.A., Fribourg (CH)

(72) Inventors: Vinod KONAGANTI, Calgary (CA); Sepideh KASIRI, Calgary (CA); Brian MOLLOY, Calgary (CA); Larry VAN ASSELDONK, Sarnia (CA); Peter ZORICAK, Calgary (CA); Fazle SIBTAIN, Calgary (CA)

(73) Assignee: NOVA Chemicals (International) S.A., Fribourg (CH)

(21) Appl. No.: 19/481,738

(22) PCT Filed: May 3, 2024
(86) PCT No.: PCT/IB2024/054322

§ 371 Date: Nov. 5, 2025

Related U.S. Application Data
(60) Provisional application No. 63/502,163, filed on May 15, 2023.

(51) Int. Cl. C08F 210/16

(52) U.S. Cl. CPC C08F 210/16

(57) ABSTRACT

A solution phase polymerization process utilizes multiple reactors connected in series to make a polyethylene composition. Two different single site catalysts are fed to a first upstream reactor and a Ziegler-Natta catalyst is fed to a second downstream reactor. Optionally, a third polymerization reactor, also connected in series is employed. The single site catalysts fed to the first reactor include a metallocene catalyst and a phosphinimine catalyst. The solution phase polymerization process affords a polyethylene composition comprising a first polyethylene, a second polyethylene, and optionally a third polyethylene.

### TECHNICAL FIELD

Multiple solution phase polymerization reactors are used in combination with mixed single site catalysts (a metallocene catalyst and a phosphinimine catalyst) as well as a Ziegler-Natta catalyst to provide a polyethylene composition.

### BACKGROUND ART

Solution polymerization processes are generally carried out at temperatures above the melting point of the ethylene homopolymer or copolymer product being made. In a typical solution polymerization process, catalyst components, process solvent, ethylene, an alpha-olefin such as 1-octene and hydrogen are fed under pressure to one or more reactors.

For ethylene polymerization, or ethylene copolymerization, reactor temperatures can range from about 80° C. to about 300° C. while pressures generally range from about 3 MPag to about 45 MPag. The ethylene homopolymer or copolymer produced remains dissolved in the solvent under reactor conditions. The residence time of the solvent in the reactor is relatively short, for example, from about 1 second to about 20 minutes. The solution polymerization process can be operated under a wide range of process conditions that allow the production of a wide variety of polyethylenes. Post reactor, the polymerization reaction is quenched to prevent further polymerization, by adding a catalyst deactivator, and optionally passivated, by adding an acid scavenger. Once deactivated (and optionally passivated), the polymer solution is passed to a polymer recovery operation (a devolatilization system) where the ethylene homopolymer or copolymer is separated from process solvent, unreacted residual ethylene and unreacted optional a-olefin(s).

### SUMMARY OF INVENTION

An embodiment is a continuous solution phase polymerization process to make a polyethylene composition, the process comprising:
feeding ethylene, a process solvent, a metallocene catalyst, a phosphinimine catalyst, optionally one or more than one α-olefin and optionally hydrogen into a first polymerization reactor to produce a first effluent stream comprising a first polyethylene which is made in the first reactor;
feeding the first effluent stream, ethylene, a process solvent, a Ziegler-Natta catalyst, optionally one or more than one α-olefin and optionally hydrogen into a second polymerization reactor configured in series with the first polymerization reactor to produce a second effluent stream comprising the first polyethylene, and a second polyethylene which is made in the second reactor; and
a) recovering the polyethylene composition from the second effluent stream; or,
b) feeding the second effluent stream, optionally ethylene, optionally a process solvent, optionally a polymerization catalyst selected from a single site catalyst or a Ziegler-Natta catalyst, optionally one or more than one α-olefin, and optionally hydrogen into a third polymerization reactor configured in series with the second polymerization reactor to produce a third effluent stream comprising the first polyethylene, the second polyethylene, and a third polyethylene which is made in the third reactor; and
recovering the polyethylene composition from the third effluent stream.

An embodiment is a continuous solution phase polymerization process to make a polyethylene composition, the process comprising:
feeding ethylene, a process solvent, a metallocene catalyst, a phosphinimine catalyst, optionally one or more than one α-olefin and optionally hydrogen into a first polymerization reactor to produce a first effluent stream comprising a first polyethylene which is made in the first reactor;
feeding the first effluent stream, ethylene, a process solvent, a Ziegler-Natta catalyst, optionally one or more than one α-olefin and optionally hydrogen into a second polymerization reactor configured in series with the first polymerization reactor to produce a second effluent stream comprising the first polyethylene, and a second polyethylene which is made in the second reactor; and
recovering the polyethylene composition from the second effluent stream.

An embodiment is a continuous solution phase polymerization process to make a polyethylene composition, the process comprising:
feeding ethylene, a process solvent, a metallocene catalyst, a phosphinimine catalyst, optionally one or more than one α-olefin and optionally hydrogen into a first polymerization reactor to produce a first effluent stream comprising a first polyethylene which is made in the first reactor;
feeding the first effluent stream, ethylene, a process solvent, a Ziegler-Natta catalyst, optionally one or more than one α-olefin and optionally hydrogen into a second polymerization reactor configured in series with the first polymerization reactor to produce a second effluent stream comprising the first polyethylene, and a second polyethylene which is made in the second reactor;
feeding the second effluent stream, optionally ethylene, optionally a process solvent, optionally a polymerization catalyst selected from a single site catalyst or a Ziegler-Natta catalyst, optionally one or more than one α-olefin, and optionally hydrogen into a third polymerization reactor configured in series with the second polymerization reactor to produce a third effluent stream comprising the first polyethylene, the second polyethylene, and a third polyethylene which is made in the third reactor; and
recovering the polyethylene composition from the third effluent stream.

In an embodiment a first polymerization reactor is operated at lower temperature than a second polymerization reactor.

In an embodiment a metallocene catalyst is defined the formula (I):

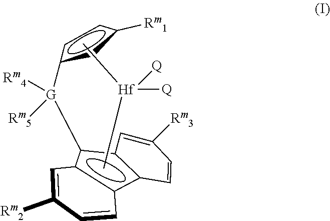

wherein G is a group 14 element selected from carbon, silicon, germanium, tin or lead; R^{m}₁ is a hydrogen atom, a C₁₋₂₀ hydrocarbyl radical, a C₁₋₂₀ alkoxy radical or a C₆₋₁₀ aryl oxide radical; R^{m}₂ and R^{m}₃ are independently selected from a hydrogen atom, a C₁₋₂₀ hydrocarbyl radical, a C₁₋₂₀ alkoxy radical or a C₆₋₁₀ aryl oxide radical; R^{m}₄ and R^{m}₅ are independently selected from a hydrogen atom, a C₁₋₂₀ hydrocarbyl radical, a C₁₋₂₀ alkoxy radical or a C₆₋₁₀ aryl oxide radical; and Q is independently an activatable leaving group.

In an embodiment a phosphinimine catalyst is defined by the formula (II):

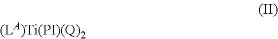

wherein L^{A} is selected from the group consisting of unsubstituted cyclopentadienyl, substituted cyclopentadienyl, unsubstituted indenyl, substituted indenyl, unsubstituted fluorenyl and substituted fluorenyl; PI is a phosphinimine ligand; and Q is independently an activatable leaving group.

In an embodiment a first, a second and an optional third polymerization reactor each operate at a temperature of from 80° C. to 310° C. and a pressure of from 3 MPag to 45 MPag.

In an embodiment a first polymerization reactor operates at a temperature which is at least 15° C. lower than the temperature at which a second polymerization reactor operates.

In an embodiment a first polymerization reactor operates at a temperature which is at least 30° C. lower than the temperature at which a second polymerization reactor operates.

In an embodiment a first polymerization reactor operates at a temperature of from 125° C. to 180° C.

In an embodiment a second polymerization reactor operates at a temperature of from 165° C. to 205° C.

In an embodiment a third polymerization reactor operates at a temperature of from 185° C. to 240° C.

In an embodiment a first polymerization reactor is a stirred tank reactor.

In an embodiment a second polymerization reactor is a stirred tank reactor.

In an embodiment a third polymerization reactor is a tubular reactor.

In an embodiment a molar ratio of a metallocene catalyst to a phosphinimine catalyst fed to a first polymerization reactor is at least 80:20.

In an embodiment a molar ratio of a metallocene catalyst to a phosphinimine catalyst fed to a first polymerization reactor is at least 90:10.

In an embodiment a molar ratio of a metallocene catalyst to a phosphinimine catalyst fed to a first polymerization reactor is at least 95:5.

In an embodiment a molar ratio of a metallocene catalyst to a phosphinimine catalyst fed to a first polymerization reactor is from 90:10 to 99:1.

In an embodiment a molar ratio of a metallocene catalyst to a phosphinimine catalyst fed to a first polymerization reactor is from 95:5 to 99:1.

In an embodiment a first polyethylene made in a first polymerization reactor comprises a higher molecular weight polyethylene component made by a metallocene catalyst and a lower molecular weight polyethylene component made by a phosphinimine catalyst.

In an embodiment a higher molecular weight polyethylene component made by a metallocene catalyst has a lower density than the density of a lower molecular weight polyethylene component made by a phosphinimine catalyst.

In an embodiment when one or more than one α-olefin is fed to the first polymerization reactor a higher molecular weight polyethylene component made by a metallocene catalyst has more short chain branches per thousand carbon atoms, SCB/1000 carbon atoms, than a lower molecular weight polyethylene component made by a phosphinimine catalyst.

In an embodiment, a polyethylene composition has a molecular weight distribution, Mw/Mn, of from 2.0 to 5.0.

In an embodiment, a polyethylene composition has a unimodal profile in a gel permeation chromatogram.

In an embodiment, a polyethylene composition has a reversed comonomer incorporation.

In an embodiment, a polyethylene composition has a multimodal profile in a temperature rising elution fractionation analysis.

In an embodiment, a polyethylene composition has an activation energy of flow, Ea, of greater than 30 kJ/mol.

In an embodiment, a polyethylene composition has an activation energy of flow, Ea, of greater than 30 kJ/mol and less than 80 kJ/mol.

### BRIEF DESCRIPTION OF DRAWINGS

FIGS. 1 and 2 are presented for the purpose of illustrating selected embodiments of this disclosure; it being understood, that the embodiments in this disclosure are not limited to the precise arrangement of, or the number of, vessels and feed streams shown.

FIG. 1 illustrates a continuous solution polymerization process where a first and second polymerization reactor are configured in series to one another, where the second reactor receives effluent from the first reactor.

FIG. 2 illustrates a continuous solution polymerization process where a first, second, and third polymerization reactor are configured in series to one another, where the second reactor receives effluent from the first reactor and a third reactor receives effluent from the second reactor.

FIG. 3 shows the gel permeation chromatographs with Fourier transform infra-red (GPC-FTIR) detection obtained for polyethylene compositions made according to the present disclosure. The comonomer content, shown as the number of short chain branches per 1000 carbons (y-axis), is given relative to the copolymer molecular weight (x-axis). The upwardly sloping line (from left to right) is the short chain branching (in short chain branches per 1000 carbons atoms) determined by FTIR.

FIG. 4A shows the temperature rising elution fractionation (TREF) analysis and profile of polyethylene compositions made according to the present disclosure.

FIG. 4B shows the corresponding weight percent of polymer material eluting in a TREF analysis at a temperature of below 79° C. as plotted against the mol ratio of metallocene catalyst to phosphinimine catalyst used in a polymerization reactor.

FIG. 5 shows the gel permeation chromatographs with refractive index detection (GPC-RI) obtained for polyethylene compositions (Examples 1-5) made according to the present disclosure.

FIG. 6 shows the gel permeation chromatographs with Fourier transform infra-red (GPC-FTIR) detection obtained for polyethylene compositions (Examples 1-5) made according to the present disclosure. The comonomer content, shown as the number of short chain branches per 1000 carbons (y-axis), is given relative to the copolymer molecular weight (x-axis). The upwardly sloping line (from left to right) is the short chain branching (in short chain branches per 1000 carbons atoms) determined by FTIR. As can be seen in the Figure, the number of short chain branches increases at higher molecular weights, and hence the comonomer incorporation is said to be “reversed” for Examples 1-5.

FIG. 7 shows the temperature rising elution fractionation (CTREF) analysis and profile of polyethylene compositions made according to the present disclosure (Examples 1-5).

FIG. 8 shows the differential scanning calorimetry analysis (DSC) and profile of polyethylene compositions made according to the present disclosure (Examples 1-5).

FIG. 9 shows the viscosity profiles from DMA frequency sweep experiments (complex viscosity, h* in Pa·s vs. the frequency, w in radians/s) carried out at 190° C. for polyethylene compositions made according to the present disclosure (Examples 1-5).

FIG. 10 shows the Van Gurp Palmen plots obtained from DMA frequency sweep experiments (the phase angle, delta in degrees vs. complex modulus, G* in Pa) carried out at 190° C. for polyethylene compositions made according to the present disclosure (Examples 1-5).

FIG. 11 shows the gel permeation chromatographs with refractive index (GPC-RI) detection obtained for polyethylene compositions (Examples 6-9) made according to the present disclosure.

FIGS. 12A and 12B show the gel permeation chromatographs with Fourier transform infra-red (GPC-FTIR) detection obtained for polyethylene compositions (Examples 6-9) made according to the present disclosure. The comonomer content, shown as the number of short chain branches per 1000 carbons (y-axis), is given relative to the copolymer molecular weight (x-axis). The upwardly sloping line (from left to right) is the short chain branching (in short chain branches per 1000 carbons atoms) determined by FTIR.

FIG. 13 shows the temperature rising elution fractionation (CTREF) analysis and profile of polyethylene compositions made according to the present disclosure (Examples 6-9).

### DEFINITIONS

As used herein, the term “monomer” refers to a small molecule that may chemically react and become chemically bonded with itself or other monomers to form a polymer.

As used herein, the term “a-olefin” or “alpha-olefin” is used to describe a monomer having a linear hydrocarbon chain containing from 3 to 20 carbon atoms having a double bond at one end of the chain; an equivalent term is “linear a-olefin”. As used herein, the term “polyethylene” or “ethylene polymer”, refers to macromolecules produced from ethylene monomers and optionally one or more additional monomers; regardless of the specific catalyst or specific process used to make the ethylene polymer. In the polyethylene art, the one or more additional monomers are called “comonomer(s)” and often include a-olefins. The term “homopolymer” refers to a polymer that contains only one type of monomer. An “ethylene homopolymer” is made using only ethylene as a polymerizable monomer. The term “copolymer” refers to a polymer that contains two or more types of monomer. An “ethylene copolymer” is made using ethylene and one or more other types of polymerizable monomer. Common polyethylenes include high density polyethylene (HDPE), medium density polyethylene (MDPE), linear low density polyethylene (LLDPE), very low density polyethylene (VLDPE), ultralow density polyethylene (ULDPE), plastomer and elastomers. The term polyethylene also includes polyethylene terpolymers which may include two or more comonomers in addition to ethylene. The term polyethylene also includes combinations of, or blends of, the polyethylenes described above.

As used herein, the terms “hydrocarbyl”, “hydrocarbyl radical” or “hydrocarbyl group” refers to linear or branched, aliphatic, olefinic, acetylenic and aryl (aromatic) radicals comprising hydrogen and carbon that are deficient by one hydrogen. The term “cyclic hydrocarbyl group” connotes hydrocarbyl groups that comprise cyclic moieties and which may have one or more than one cyclic aromatic ring, and/or one or more than one non-aromatic ring. The term “acyclic hydrocarbyl group” connotes hydrocarbyl groups that do not have cyclic moieties such as aromatic or non-aromatic ring structures present within them.

As used herein, the phrase “heteroatom” includes any atom other than carbon and hydrogen that can be bound to carbon. The term “heteroatom containing” or “heteroatom containing hydrocarbyl group” means that one or more than one non carbon atom(s) may be present in the hydrocarbyl groups. Some non-limiting examples of non-carbon atoms that may be present is a heteroatom containing hydrocarbyl group are N, O, S, P and Si as well as halides such as for example Br and metals such as Sn. Some non-limiting examples of heteroatom containing hydrocarbyl groups include for example aryloxy groups, alkoxy groups, alkylaryloxy groups, and arylalkoxy groups. Further non-limiting examples of heteroatom containing hydrocarbyl groups generally include for example imines, amine moieties, oxide moieties, phosphine moieties, ethers, ketones, heterocyclics, oxazolines, thioethers, and the like.

In an embodiment of the disclosure, a heteroatom containing hydrocarbyl group is a hydrocarbyl group containing from 1 to 3 atoms selected from the group consisting of boron, aluminum, silicon, germanium, nitrogen, phosphorous, oxygen and sulfur.

The terms “cyclic heteroatom containing hydrocarbyl” or “heterocyclic” refer to ring systems having a carbon backbone that further comprises at least one heteroatom selected from the group consisting of for example boron, aluminum, silicon, germanium, nitrogen, phosphorous, oxygen and sulfur.

In an embodiment of the disclosure, a cyclic heteroatom containing hydrocarbyl group is a cyclic hydrocarbyl group containing from 1 to 3 atoms selected from the group consisting of boron, aluminum, silicon, germanium, nitrogen, phosphorous, oxygen and sulfur.

As used herein, an “alkyl radical” or “alkyl group” includes linear, branched and cyclic paraffin radicals that are deficient by one hydrogen radical; non-limiting examples include methyl (—CH₃) and ethyl (—CH₂CH₃) radicals. The term “alkenyl radical” or “alkenyl group” refers to linear, branched and cyclic hydrocarbons containing at least one carbon-carbon double bond that is deficient by one hydrogen radical. The term “alkynyl radical” or “alkynyl group” refers to linear, branched and cyclic hydrocarbons containing at least one carbon-carbon triple bond that is deficient by one hydrogen radical.

As used herein, the term “aryl radical” or “aryl group” includes phenyl, naphthyl, pyridyl and other radicals whose molecules have an aromatic ring structure; non-limiting examples include naphthalene, phenanthrene and anthracene. An “alkylaryl” group is an alkyl group having an aryl group pendant there from; non-limiting examples include benzyl, phenethyl and tolylmethyl. An “arylalkyl” is an aryl group having one or more alkyl groups pendant there from; non-limiting examples include tolyl, xylyl, mesityl and cumyl.

An “alkoxy group” is an oxy group having an alkyl group pendant there from; and includes for example a methoxy group, an ethoxy group, an iso-propoxy group, and the like. An “alkylaryloxy group” is an oxy group having an alkylaryl group pendent there from (for clarity, the alkyl moiety is bonded to the oxy moiety and the aryl group is bonded to the alkyl moiety).

An “aryloxy” group is an oxy group having an aryl group pendant there from; and includes for example a phenoxy group and the like. An “arylalkyloxy group” is an oxy group having an arylalkyl group pendent there from (for clarity, the aryl moiety is bonded to the oxy moiety and the alkyl group is bonded to the aryl moiety).

In the present disclosure, a hydrocarbyl group or a heteroatom containing hydrocarbyl group may be further specifically defined as being unsubstituted or substituted. As used herein the term “unsubstituted” means that hydrogen radicals are bounded to the molecular group that is referred to by the term unsubstituted. The term “substituted” means that the group referred to by this term possesses one or more moieties that have replaced one or more hydrogen radicals in any position within the group; non-limiting examples of moieties include halogen radicals (F, Cl, Br), an alkyl group, an alkylaryl group, an arylalkyl group, an alkoxy group, an aryl group, an aryloxy group, an amido group, a silyl group or a germanyl group, hydroxyl groups, carbonyl groups, carboxyl groups, amine groups, phosphine groups, phenyl groups, naphthyl groups, C₁ to C₁₀ alkyl groups, C₂ to C₁₀ alkenyl groups, and combinations thereof.

In embodiments of the disclosure, any hydrocarbyl group and/or any heteroatom containing hydrocarbyl group may be unsubstituted or substituted.

The short chain branching (i.e. the short chain branching per thousand backbone carbon atoms, SCB/1000Cs) is the branching due to the presence of an a-olefin comonomer in the polyethylene and will for example have two carbon atoms for a 1-butene comonomer, or four carbon atoms for a 1-hexene comonomer, or six carbon atoms for a 1-octene comonomer, etc.

### DESCRIPTION OF EMBODIMENTS

The present disclosure is directed to a continuous solution phase polymerization process in which at least two polymerization reactors are configured in series with one another and in which at least two different single site polymerization catalysts are both fed to an upstream polymerization reactor, and a Ziegler-Natta polymerization catalyst is fed to a downstream polymerization reactor.

Single site polymerization catalysts, non-limiting examples of which include phosphinimine catalysts, metallocene catalysts, and constrained geometry catalysts, as well as so-called post-metallocene catalysts such as, for example, those having a tetradentate, bis(biphenylphenoxy) ligand are well known to persons skilled in the art. Ziegler-Natta catalyst systems are also well known to those skilled in the art.

In an embodiment of the disclosure, the two different single site polymerization catalysts which are used together in a single upstream polymerization reactor (by feeding the two different single site catalyst to the same upstream reactor) are a metallocene catalyst and a phosphinimine catalyst.

In an embodiment, an upstream reactor is a first polymerization reactor and a downstream reactor is a second polymerization reactor configured in series with the first polymerization reactor. Optionally, further downstream reactors may be used in embodiments of the disclosure. For example, in an embodiment of the disclosure a third polymerization reactor is connected in series with the second polymerization reactor.

In embodiments, a first polymerization reactor can be a continuously stirred tank reactor, a loop reactor or a tubular reactor. In an embodiment, a first polymerization reactor is a continuously stirred tank reactor.

In embodiments, a second polymerization reactor can be a continuously stirred tank reactor, a loop reactor or a tubular reactor. In an embodiment, a second polymerization reactor is a continuously stirred tank reactor.

Optionally a third polymerization reactor may also be used. In an embodiment, the third polymerization reactor is located downstream of a second polymerization reactor which is located downstream of a first polymerization reactor, where each of the first, second and third polymerization reactors are arranged in series with one another.

In embodiments, a third polymerization reactor can be a continuously stirred tank reactor, a loop reactor or a tubular reactor. In an embodiment a third polymerization reactor is a tubular reactor.

In embodiments of the disclosure a Ziegler-Natta catalyst or a single site catalyst is fed to a third polymerization reactor.

### The Metallocene Catalyst

Although the use of any metallocene catalyst is contemplated in embodiments of the present disclosure, some non-limiting examples of metallocene type catalysts which may be useful in embodiments of the disclosure can be found in U.S. Pat. Nos. 4,701,432; 4,808,561; 4,935,397; 4,937,301; 5,324,800; 5,633,394; 6,002,033 and 6,489,413, each of which are incorporated herein by reference.

In an embodiment of the disclosure, the metallocene catalyst is a bridged metallocene catalyst.

In an embodiment of the disclosure, the metallocene catalyst has the formula I:

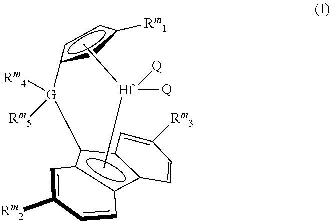

In Formula (I): M is a group 4 metal selected from titanium, zirconium or hafnium; G is a group 14 element selected from carbon, silicon, germanium, tin or lead; R^{m}₁ is a hydrogen atom, a C₁₋₂₀ hydrocarbyl radical, a C₁₋₂₀ alkoxy radical or a C₆₋₁₀ aryl oxide radical; R^{m}₂ and R^{m}₃ are independently selected from a hydrogen atom, a C₁₋₂₀ hydrocarbyl radical, a C₁₋₂₀ alkoxy radical or a C₆₋₁₀ aryl oxide radical; R^{m}₄ and R^{m}₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, G is carbon.

In an embodiment, R^{m}₄ and R^{m}₅ are independently an aryl group.

In an embodiment, R^{m}₄ and Rms are independently a phenyl group or a substituted phenyl group.

In an embodiment, R^{m}₄ and R^{m}₅ are a phenyl group.

In an embodiment, R^{m}₄ and Rms are independently a substituted phenyl group.

In an embodiment, R^{m}₄ and Rms are a substituted phenyl group, wherein the phenyl group is substituted with a substituted silyl group.

In an embodiment, R^{m}₄ and R^{m}₅ are a substituted phenyl group, wherein the phenyl group is substituted with a trialkyl silyl group.

In an embodiment, R^{m}₄ and Rms are a substituted phenyl group, wherein the phenyl group is substituted at the para position with a trialkylsilyl group. In an embodiment, R^{m}₄ and Rms are a substituted phenyl group, wherein the phenyl group is substituted at the para position with a trimethylsilyl group. In an embodiment, R₄ and R₅ are a substituted phenyl group, wherein the phenyl group is substituted at the para position with a triethylsilyl group.

In an embodiment, R^{m}₄ and R^{m}₅ are independently an alkyl group.

In an embodiment, R^{m}₄ and R^{m}₅ are independently an alkenyl group.

In an embodiment, R^{m}₁ is hydrogen.

In an embodiment, R^{m}₁ is an alkyl group.

In an embodiment, R^{m}₁ is an aryl group.

In an embodiment, R^{m}₁ is an alkenyl group.

In an embodiment, R^{m}₂ and R^{m}₃ are independently a hydrocarbyl group having from 1 to 30 carbon atoms.

In an embodiment, R^{m}₂ and R^{m}₃ are independently an aryl group.

In an embodiment, R^{m}₂ and R^{m}₃ are independently an alkyl group.

In an embodiment, R^{m}₂ and R^{m}₃ are independently an alkyl group having from 1 to 20 carbon atoms.

In an embodiment, R^{m}₂ and R^{m}₃ are independently a phenyl group or a substituted phenyl group.

In an embodiment, R^{m}₂ and R^{m}₃ are a tert-butyl group.

In an embodiment, R^{m}₂ and R^{m}₃ are hydrogen.

In an embodiment M is hafnium, Hf.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g. a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g. 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g. chloride) or a hydrocarbyl (e.g. methyl, benzyl).

In an embodiment of the disclosure, the metallocene catalyst is diphenylmethylene(cyclopentadienyl)(2,7-di-t-butylfluorenyl)hafnium dichloride having the molecular formula: [(2,7-tBu₂Flu)Ph₂C(Cp)HfCl₂].

In an embodiment of the disclosure the metallocene catalyst is diphenylmethylene(cyclopentadienyl)(2,7-di-t-butylfluorenyl)hafnium dimethide having the molecular formula: [(2,7-tBu₂Flu)Ph₂C(Cp)HfMe₂].

In addition to the single site catalyst molecule per se (e.g. the metallocene complex), an active single site polymerization catalyst may further comprise one or more of the following: an alkylaluminoxane co-catalyst and an ionic or boron-based activators. The active single site polymerization catalyst may in some embodiments further comprise a hindered phenol. In some embodiments organoaluminum compounds are also used.

Without wishing to be bound by theory, the alkylaluminoxanes used in the present disclosure are complex aluminum compounds of the formula: R₂Al¹O(RAl¹O)ₘAl¹R₂, wherein each R is independently selected from the group consisting of C₁₋₂₀ hydrocarbyl radicals and m is from 3 to 50.

In an embodiment of the disclosure, R of the alkylaluminoxane, is a methyl radical and m is from 10 to 40.

The alkylaluminoxanes are typically used in substantial molar excess compared to the amount of group 4 transition metal in the single site catalyst (e.g., the metallocene catalyst molecule). In embodiments, the Al¹: group 4 transition metal molar ratios may be from about 5:1 to about 10,000:1, or from about 10:1 to about 1000:1, or from about 30:1 to about 500:1.

In an embodiment of the disclosure, the alkylaluminoxane co-catalyst is methylaluminoxane (MAO).

In an embodiment of the disclosure, the alkylaluminoxane co-catalyst is modified methylaluminoxane (MMAO).

It is well known in the art, that alkylaluminoxanes can serve multiple roles as a catalyst alkylator, a catalyst activator, and a scavenger. Hence, an alkylaluminoxane activator is often used in combination with activatable ligands such as halogens.

The boron-based catalyst activator (which in some embodiments is also known as an “ionic activator”) may be selected from the group consisting of: (i) compounds of the formula [R¹]⁺ [B(R²)₄]⁻ wherein B is a boron atom, R¹ is a cyclic C₅₋₇ aromatic cation or a triphenyl methyl cation and each R² is independently selected from the group consisting of phenyl radicals which are unsubstituted or substituted with from 3 to 5 substituents selected from the group consisting of a fluorine atom, a C₁₋₄ alkyl or alkoxy radical which is unsubstituted or substituted by a fluorine atom; and a silyl radical of the formula —Si—(R*)₃; wherein each R* is independently selected from the group consisting of a hydrogen atom and a C₁₋₄ alkyl radical; and (ii) compounds of the formula [(R³)ₜZH]⁺ [B(R²)₄]⁻ wherein B is a boron atom, H is a hydrogen atom, Z is a nitrogen atom or phosphorus atom, t is 2 or 3 and R³ is selected from the group consisting of C₁₋₃₀ alkyl radicals, a phenyl radical which is unsubstituted or substituted by up to three C₁₋₄ alkyl radicals, or one R³ taken together with a nitrogen atom may form an anilinium radical and R² is as defined above; and (iii) compounds of the formula B(R²)₃ wherein R² is as defined above.

In some embodiments, in the above compounds, preferably R² is a pentafluorophenyl radical, and R¹ is a triphenylmethyl cation, Z is a nitrogen atom and R³ is a C₁₋₄ alkyl radical or one R³ taken together with a nitrogen atom forms an anilinium radical (e.g., PhR³₂NH⁺, which is substituted by two R³ radicals such as for example two C₁₋₄ alkyl radicals).

Examples of boron-based catalyst activator compounds capable of ionizing a single site catalyst (e.g. the metallocene catalyst molecule) and which may be used in embodiments of the disclosure include the following: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra (o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra (o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra)phenyl)boron, tri(methylphenyl)phosphonium tetra(phenyl)boron, tri(dimethylphenyl)phosphonium tetra(phenyl)boron, tropylium tetrakispentafluorophenyl borate, triphenylmethylium tetrakispentafluorophenyl borate, benzene (diazonium) tetrakispentafluorophenyl borate, tropylium phenyltris-pentafluorophenyl borate, triphenylmethylium phenyl-trispentafluorophenyl borate, benzene (diazonium) phenyltrispentafluorophenyl borate, tropylium tetrakis (2,3,5,6-tetrafluorophenyl) borate, triphenylmethylium tetrakis (2,3,5,6-tetrafluorophenyl) borate, benzene (diazonium) tetrakis (3,4,5-trifluorophenyl) borate, tropylium tetrakis (3,4,5-trifluorophenyl) borate, benzene (diazonium) tetrakis (3,4,5-trifluorophenyl) borate, tropylium tetrakis (1,2,2-trifluoroethenyl) borate, trophenylmethylium tetrakis (1,2,2-trifluoroethenyl) borate, benzene (diazonium) tetrakis (1,2,2-trifluoroethenyl) borate, tropylium tetrakis (2,3,4,5-tetrafluorophenyl) borate, triphenylmethylium tetrakis (2,3,4,5-tetrafluorophenyl) borate, and benzene (diazonium) tetrakis (2,3,4,5-tetrafluorophenyl) borate.

Further specific examples of boron-based catalyst activator compounds capable of ionizing a single site catalyst (e.g. the metallocene catalyst molecule) and which may be used in embodiments of the present disclosure are disclosed in U.S. Pat. Nos. 5,919,983, 6,121,185, 10,730,964 and 11,041,031.

In an embodiment of the disclosure, the boron-based catalyst activator comprises [(hydrogenated tallow alkyl)₂(Me)NH][B(C₆F₅)₄], N,N-dimethylaniliniumtetrakispentafluorophenyl borate (“[Me_{z}NHPh][B(C₆F₅)₄]”), or triphenylmethylium tetrakispentafluorophenyl borate (“[Ph₃C][B(C₆F₅)₄]”), and/or trispentafluorophenyl boron.

In an embodiment of the disclosure, the boron-based catalyst activator comprises [(hydrogenated tallow alkyl)₂(Me)NH][B(C₆F₅)₄], N,N-dimethylaniliniumtetrakispentafluorophenyl borate (“[Me₂NHPh][B(C₆F₅)₄]”), or triphenylmethylium tetrakispentafluorophenyl borate (“[Ph₃C][B(C₆F₅)₄]”), or trispentafluorophenyl boron.

In an embodiment of the disclosure, the boron-based catalyst activator comprises an ionic activator selected from the group consisting of [(hydrogenated tallow alkyl)₂(Me)NH][B(C₆F₅)₄], N,N-dimethylaniliniumtetrakispentafluorophenyl borate (“[Me₂NHPh][B(C₆F₅)₄]”), and triphenylmethylium tetrakispentafluorophenyl borate (“[Ph₃C][B(C₆F₅)₄]”).

In an embodiment of the disclosure, the boron-based catalyst activator is N, N-dimethylaniliniumtetrakispentafluorophenyl borate (“[Me₂NHPh][B(C₆F₅)₄]”).

In an embodiment of the disclosure, the boron-based catalyst activator is triphenylmethylium tetrakispentafluorophenyl borate (“[Ph₃C][B(C₆F₅)₄]”).

In an embodiment of the disclosure, the boron-based catalyst activator is [(hydrogenated tallow alkyl)₂(Me)NH][B(C₆F₅)₄].

In embodiments, the boron-based catalyst activator may be used in amounts which provide a molar ratio of group 4 transition metal (i.e., in the metallocene catalyst molecule) to boron that will be from about 1:0.5 to about 1:10, or from about 1:1 to about 1:6.

Optionally, in embodiments of the disclosure, the single site polymerization catalyst may further include an organoaluminum compound defined by the formula:

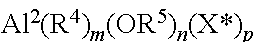

wherein R⁴ and R⁵ are each independently C₁ to C₂₀ hydrocarbyl groups; X* is a halide; m+n+p=3; and m≥1.

In an embodiment of the disclosure, the organoaluminum compound used is defined by the formula:

Al³R⁶ₓ(OR⁷)_{y} wherein x is from 1 to 3, x+y=3, R⁶ is a C₁ to C₁₀ hydrocarbyl group, and R⁷ is an alkyl or an aryl group.

In particular embodiments, organoaluminum compounds include triethylaluminum, triisobutyl aluminum, tri-n-octylaluminum and diethyl aluminum ethoxide.

In embodiments of the present disclosure, a hindered phenol compound is used in combination with a metallocene catalyst, a boron-based catalyst activator and an alkylaluminoxane co-catalyst to provide an active polymerization catalyst.

Generally, hindered phenol compounds (or “sterically hindered” phenol compounds) are phenols having one or more bulky substituent, such as a sterically bulky hydrocarbyl group, non-limited examples of which include a tert-butyl group and a 1-adamantyl group.

In embodiments of the disclosure, a hindered phenol compound, will have a sterically bulky hydrocarbyl group on at least one or both of the carbon atoms adjacent to the carbon atom bonded to a hydroxy group (e.g., a bulky hydrocarbyl group is located at one or both of the 2 and 6 locations of a hindered phenol moiety).

In embodiments of the disclosure, a hindered phenol compound, comprises a 2,6-dihydrocarbyl group substituted hindered phenol moiety.

In embodiments of the disclosure, a hindered phenol compound comprises a 2,6-dihydrocarbyl group substituted hindered phenol moiety, which moiety is further optionally substituted at one or more of the 3, 4 and 5 locations with a hydrocarbyl group or a heteroatom containing hydrocarbyl group.

Non-limiting examples of hindered phenol compounds which may be employed in embodiments of the present disclosure include butylated phenolic antioxidants, butylated hydroxytoluene; 2,6-di-tertiarybutyl-4-ethyl phenol; 4,4′-methylenebis (2,6-di-tertiary-butylphenol); 1,3,5-trimethyl-2,4,6-tris(3,5-di-tert-butyl-4-hydroxybenzyl)benzene and octadecyl-3-(3′,5′-di-tert-butyl-4′-hydroxyphenyl) propionate.

In embodiments, a hindered phenol compound is present in an amount which provides a molar ratio of aluminum from an alkylaluminoxane co-catalyst to the hindered phenol compound (i.e., the ratio of Al¹:hindered phenol compound) of from about 1:1 to about 10:1, or from about 2:1 to about 5:1.

Optionally, in embodiments, a hindered phenol compound is added to an alkylaluminoxane co-catalyst prior to contact of the alkylaluminoxane with one or more other components of the olefin polymerization catalyst (e.g., the metallocene catalyst molecule).

To produce an active single site catalyst system the quantity and mole ratios of the three or four components: the single site catalyst molecule (e.g. the metallocene), the alkylaluminoxane, the boron-based activator, and the optional hindered phenol are optimized.

### The Phosphinimine Catalyst

Although the use of any phosphinimine catalyst is contemplated in embodiments of the present disclosure, some non-limiting examples of phosphinimine type catalysts which may be useful in embodiments of the disclosure can be found in U.S. Pat. Nos. 6,063,879; 6,235,672; 6,277,931; 6,342,463; 6,372,864; 6,777,509; 6,984,695 and 8,431,657, each of which are incorporated herein by reference.

In an embodiment of the disclosure, the phosphinimine catalyst has the formula II:

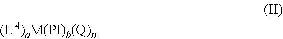

wherein (L^{A}) represents is cyclopentadienyl-type ligand; M represents a metal atom selected from the group consisting of Ti, Zr, and Hf; PI represents a phosphinimine ligand; Q represents an activatable ligand as already defined above; a is 0 or 1; b is 1 or 2; (a+b)=2; n is 1 or 2, and; the sum of (a+b+n) equals the valance of the metal M.

As used herein, the term “cyclopentadienyl-type” ligand is meant to include ligands which contain at least one five-carbon ring which is bonded to the metal via eta-5 (or in some cases eta-3) bonding. Thus, the term “cyclopentadienyl-type” includes, for example, unsubstituted cyclopentadienyl, singly or multiply substituted cyclopentadienyl, unsubstituted indenyl, singly or multiply substituted indenyl, unsubstituted fluorenyl and singly or multiply substituted fluorenyl. Hydrogenated versions of indenyl and fluorenyl ligands are also contemplated for use in the current disclosure, so long as the five-carbon ring which bonds to the metal via eta-5 (or in some cases eta-3) bonding remains intact. Substituents for a cyclopentadienyl ligand, an indenyl ligand (or hydrogenated version thereof) and a fluorenyl ligand (or hydrogenated version thereof) may be selected from the group consisting of a C₁₋₃₀ hydrocarbyl radical (which hydrocarbyl radical may be unsubstituted or further substituted by for example a halide and/or a hydrocarbyl group; for example a suitable substituted C₁₋₃₀ hydrocarbyl radical is a pentafluorobenzyl group such as —CH₂C₆F₅); a halogen atom; a C₁₋₈ alkoxy radical; a C₆₋₁₀ aryl or aryloxy radical (each of which may be further substituted by for example a halide and/or a hydrocarbyl group); an amido radical which is unsubstituted or substituted by up to two C₁₋₈ alkyl radicals; a phosphido radical which is unsubstituted or substituted by up to two C₁₋₈ alkyl radicals; a silyl radical of the formula-Si(R¢)₃ wherein each R^{e} is independently selected from the group consisting of hydrogen, a C₁₋₈ alkyl or alkoxy radical, C₆₋₁₀ aryl or aryloxy radicals; and a germanyl radical of the formula —Ge(R¢)₃ wherein R¢ is as defined directly above.

The phosphinimine ligand, PI, is defined by formula:

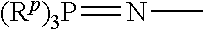

wherein the RP groups are independently selected from: a hydrogen atom; a halogen atom; C₁₋₂₀ hydrocarbyl radicals which are unsubstituted or substituted with one or more halogen atom(s); a C₁₋₈ alkoxy radical; a C₆₋₁₀ aryl radical; a C₆₋₁₀ aryloxy radical; an amido radical; a silyl radical of formula —Si(R^{s})₃, wherein the R⁵ groups are independently selected from, a hydrogen atom, a C₁₋₈ alkyl or alkoxy radical, a C₆₋₁₀ aryl radical, a C₆₋₁₀ aryloxy radical, or a germanyl radical of formula —Ge(R^{G})₃, wherein the R^{G} groups are defined as R⁵ is defined in this paragraph.

In an embodiment of the disclosure, the metal, M in the phosphinimine catalyst is titanium, Ti.

In an embodiment of the disclosure, the phosphinimine catalyst is cyclopentadienyl tri(tertiarybutyl)phosphinimine titanium dichloride, Cp((t-Bu)₃PN)TiCl₂.

In an embodiment of the disclosure, the phosphinimine catalyst is cyclopentadienyl tri(tertiarybutyl)phosphinimine titanium dimethide, Cp((t-Bu)₃PN)TiMe₂.

As already discussed above, in addition to the single site catalyst molecule per se (e.g. a phosphinimine catalyst molecule), an active single site catalyst system may further comprise one or more of the following: an alkylaluminoxane co-catalyst and an ionic or boron-based activator, both of which, have already been defined above. The single site catalyst system may also optionally comprise a hindered phenol, as well as an organoaluminum compound, each as already defined above.

The alkylaluminoxanes are typically used in substantial molar excess compared to the amount of group 4 transition metal in the single site catalyst (e.g., the phosphinimine catalyst molecule). In embodiments, the Al¹:group 4 transition metal molar ratios may be from about 5:1 to about 10,000:1, or from about 10:1 to about 1000:1, or from about 30:1 to about 500:1.

In embodiments, the boron-based catalyst activator may be used in amounts which provide a molar ratio of group 4 transition metal (i.e., in the phosphinimine catalyst molecule) to boron that will be from about 1:0.5 to about 1:10, or from about 1:1 to about 1:6.

In embodiments, a hindered phenol compound is present in an amount which provides a molar ratio of aluminum from an alkylaluminoxane co-catalyst to the hindered phenol compound (i.e., the ratio of Al¹:hindered phenol compound) of from about 1:1 to about 10:1, or from about 2:1 to about 5:1.

Optionally, in embodiments, a hindered phenol compound is added to an alkylaluminoxane co-catalyst prior to contact of the alkylaluminoxane with one or more other components of the olefin polymerization catalyst (e.g., the phosphinimine catalyst molecule).

To produce an active single site catalyst system the quantity and mole ratios of the three or four components: the single site catalyst molecule (e.g. the phosphinimine single site catalyst molecule), the alkylaluminoxane, the boron-based activator, and the optional hindered phenol may be optimized.

### The Ziegler Natta Catalyst

A Ziegler-Natta catalyst may be an in-line Ziegler-Natta catalyst system or a batch Ziegler-Natta catalyst system. The term “in-line Ziegler-Natta catalyst system” refers to the continuous synthesis of a small quantity of an active Ziegler-Natta catalyst system and immediately injecting this catalyst into at least one continuously operating reactor, wherein the catalyst polymerizes ethylene and one or more optional α-olefins to form an ethylene polymer. The terms “batch Ziegler-Natta catalyst system” or “batch Ziegler-Natta procatalyst” refer to the synthesis of a much larger quantity of catalyst or procatalyst in one or more mixing vessels that are external to, or isolated from, the continuously operating solution polymerization process. Once prepared, the batch Ziegler-Natta catalyst system, or batch Ziegler-Natta procatalyst, is transferred to a catalyst storage tank. The term “procatalyst” refers to an inactive catalyst system (inactive with respect to ethylene polymerization); the procatalyst is converted into an active catalyst by adding an alkyl aluminum co-catalyst. As needed, the procatalyst is pumped from the storage tank to at least one continuously operating reactor, wherein an active catalyst polymerizes ethylene and one or more optional α-olefins to form a ethylene copolymer. The procatalyst may be converted into an active catalyst in the reactor or external to the reactor, or on route to the reactor.

A wide variety of compounds can be used to synthesize an active Ziegler-Natta catalyst system. The following describes various compounds that may be combined to produce an active Ziegler-Natta catalyst system. Those skilled in the art will understand that the embodiments in this disclosure are not limited to the specific compounds disclosed.

An active Ziegler-Natta catalyst system may be formed from: a magnesium compound, a chloride compound, a metal compound, an alkyl aluminum co-catalyst and an aluminum alkyl. As will be appreciated by those skilled in the art, Ziegler-Natta catalyst systems may contain additional components; a non-limiting example of an additional component is an electron donor, e.g. amines or ethers.

A non-limiting example of an active in-line (or batch) Ziegler-Natta catalyst system which may be used in embodiments of the disclosure can be prepared as follows. In the first step, a solution of a magnesium compound is reacted with a solution of a chloride compound to form a magnesium chloride support suspended in solution. Non-limiting examples of magnesium compounds include Mg(R¹)₂; wherein the R¹ groups may be the same or different, linear, branched or cyclic hydrocarbyl radicals containing 1 to 10 carbon atoms. Non-limiting examples of chloride compounds include R²Cl; wherein R² represents a hydrogen atom, or a linear, branched or cyclic hydrocarbyl radical containing 1 to 10 carbon atoms. In the first step, the solution of magnesium compound may also contain an aluminum alkyl compound. Non-limiting examples of aluminum alkyl compounds include Al(R³)₃, wherein the R³ groups may be the same or different, linear, branched or cyclic hydrocarbyl radicals containing from 1 to 10 carbon atoms. In the second step a solution of the metal compound is added to the solution of magnesium chloride and the metal compound is supported on the magnesium chloride. Non-limiting examples of suitable metal compounds include M(X)ₙ or MO(X)ₙ; where M represents a metal selected from Group 4 through Group 8 of the Periodic Table, or mixtures of metals selected from Group 4 through Group 8; O represents oxygen; X represents chloride or bromide; and n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In an embodiment of the disclosure, a suitable metal compound is titanium tetrachloride, TiCl₄. In the third step a solution of an alkyl aluminum co-catalyst is added to the metal compound supported on the magnesium chloride. A wide variety of alkyl aluminum co-catalysts are suitable, as expressed by formula:

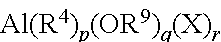

wherein the R⁴ groups may be the same or different, hydrocarbyl groups having from 1 to 10 carbon atoms; the OR⁹ groups may be the same or different, alkoxy or aryloxy groups wherein R⁹ is a hydrocarbyl group having from 1 to 10 carbon atoms bonded to oxygen; X is chloride or bromide; and (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active in-line (or batch) Ziegler-Natta catalyst system, can be carried out in a variety of solvents; non-limiting examples of solvents include linear or branched C₅ to C₁₂ alkanes or mixtures thereof.

To produce an active in-line Ziegler-Natta catalyst formulation the quantity and mole ratios of the five components, a magnesium compound, a chloride compound, a metal compound, an alkyl aluminum co-catalyst and an aluminum alkyl are optimized.

### The Solution Phase Polymerization Process

Solution polymerization processes for the homopolymerization of ethylene or the copolymerization of ethylene with one or more than one alpha-olefin are well known in the art (see for example U.S. Pat. Nos. 6,372,864 and 6,777,509). These processes are conducted in the presence of an inert hydrocarbon solvent, typically, a C₅₋₁₂ hydrocarbon which may be unsubstituted or substituted by C₁₋₄ alkyl group such as pentane, methyl pentane, hexane, heptane, octane, cyclohexane, methylcyclohexane and hydrogenated naphtha. An example of a suitable solvent which is commercially available is “Isopar E” (C₈₋₁₂ aliphatic solvent, Exxon Chemical Co.).

The polymerization temperature in a conventional solution phase process may be from about 80° C. to about 310° C. In an embodiment of the disclosure the polymerization temperature in a solution phase polymerization process is from about 120° C. to about 250° C. In further embodiments, a solution phase polymerization process is carried out at a temperature of at least 140° C., or at least 160° C., or at least 170° C., or at least 180° C., or at least 190° C.

The polymerization pressure in a solution phase polymerization process may be a “medium pressure process”, meaning that the pressure in the reactor is less than about 6,000 psi (about 42,000 kiloPascals or kPa). In embodiments of the disclosure, the polymerization pressure in a solution phase polymerization process may be from about 10,000 to about 40,000 kPa, or from about 14,000 to about 22,000 kPa (i.e. from about 2,000 psi to about 3,000 psi).

Suitable monomers for copolymerization with ethylene include C₃₋₂₀ alpha-olefins (including mono- and di-olefins). Some non-limiting examples of comonomers which may be copolymerized with ethylene in embodiments of the disclosure include C₃₋₁₂ alpha-olefins which are unsubstituted or substituted by up to two C₁₋₆ alkyl radicals; C₈₋₁₂ vinyl aromatic monomers which are unsubstituted or substituted by up to two substituents selected from the group consisting of C₁₋₄ alkyl radicals; and C₄₋₁₂ straight chained or cyclic diolefins which are unsubstituted or substituted by a C₁₋₄ alkyl radical. Illustrative non-limiting examples of such alpha-olefins are one or more of propylene, 1-butene, 1-pentene, 1-hexene, 1-octene and 1-decene, styrene, alpha methyl styrene, and the constrained-ring cyclic olefins such as cyclobutene, cyclopentene, dicyclopentadiene norbornene, alkyl-substituted norbornenes, alkenyl-substituted norbornenes and the like (e.g., 5-methylene-2-norbornene, 5-ethylidene-2-norbornene, and bicyclo-(2,2,1)-hepta-2,5-diene).

In solution polymerization, the monomers are dissolved/dispersed in a solvent either prior to being fed to the reactor (or for gaseous monomers the monomer may be fed to a reactor so that it will dissolve in the polymerization reaction mixture). Prior to mixing, the solvent and monomers are generally purified to remove potential catalyst poisons such as water, oxygen or metal impurities. The feedstock purification may employ standard well known practices in the art, such as for example the use of molecular sieves, alumina beds and oxygen removal catalysts, all of which are known to be useful for the purification of polymerizable monomers. The solvent itself, as well, (e.g., methyl pentane, cyclohexane, hexane or toluene) may be treated in a similar manner to remove potential catalyst poisons.

The feedstock monomers or other solution process components (e.g., solvent) may be heated or cooled prior to feeding to a solution phase polymerization reactor.

In embodiments of the disclosure, the olefin polymerization catalyst components (e.g., a polymerization catalyst molecule, a boron-based catalyst activator, an alkylaluminoxane, and a hindered phenol compound) may be premixed in the solvent used for the polymerization reaction or they may be fed as separate streams to a polymerization reactor. In some embodiments, premixing may be desirable to provide a reaction time for the olefin polymerization catalyst system components prior to entering a polymerization reaction zone (e.g., a polymerization reactor). Examples, of such an “in line mixing” technique are described in a number of patents, such as U.S. Pat. No. 5,589,555.

In an embodiment of the disclosure, a solution phase polymerization process is a continuous process. By the term “continuous process” it is meant that the polymerization process flows (e.g., solvent, ethylene, optional alpha-olefin comonomer, olefin polymerization catalyst system components, etc.) are continuously fed to a polymerization zone (e.g., a polymerization reactor) where a polymer (e.g., ethylene homopolymer or ethylene copolymer) is formed and from which the polymer is continuously removed via a process flow effluent steam.

In a solution phase polymerization process generally, a reactor is operated under conditions which achieve a thorough mixing of the reactants and the residence time (or alternatively, the “hold up time”) of the olefin polymerization catalyst (e.g., the activated single site catalyst complex) in a reactor will depend on the design and the capacity of the reactor.

In embodiments, the residence time of a polymerization catalyst in a given reactor will be from a few seconds to about 20 minutes. In further embodiments, the residence time of a polymerization catalyst in a given reactor will be less than about 10 minutes, or less than about 5 minutes, or less than about 3 minutes.

In an embodiment of the disclosure, a solution phase polymerization process is carried out in at least two polymerization reactors.

In an embodiment of the disclosure, a solution phase polymerization process is carried out in at least two polymerization reactors configured in series with one another.

In an embodiment of the disclosure, a solution phase polymerization process is carried out in at least two continuously stirred tank reactors (“CSTRs”).

In an embodiment of the disclosure, a solution phase polymerization process is carried out in at least two sequentially arranged continuously stirred tank reactors (CSTRs) with the process flows being transferred from a first upstream CSTR reactor to a second downstream CSTR.

In an embodiment of the disclosure, a solution phase polymerization process is carried out in at least three polymerization reactors.

In an embodiment of the disclosure, a solution phase polymerization process is carried out in three polymerization reactors.

In an embodiment of the disclosure, a solution phase polymerization process is carried out in at least three polymerization reactors configured in series with one another.

In an embodiment of the disclosure, a solution phase polymerization process is carried out in three polymerization reactors configured in series with one another.

In an embodiment of the disclosure, a solution phase polymerization process is carried out in at least three sequentially arranged polymerization reactors, with the process flows being transferred from the first reactor to the second reactor and from the second reactor to the third reactor.

In an embodiment of the disclosure, a solution phase polymerization process is carried out in three sequentially arranged polymerization reactors, with the process flows being transferred from the first reactor to the second reactor and from the second reactor to the third reactor.

In an embodiment of the disclosure, a solution phase polymerization process is carried out in two sequentially arranged first and second reactors, each of which is a continuously stirred tank reactor (CSTR), with the process flows being transferred from the first upstream CSTR reactor to the second downstream CSTR and a third reactor which is a tubular reactor, where the third reactor is arranged sequentially to the second reactor so that process flows are transferred from the second reactor to the third reactor.

In an embodiment a first reactor is a continuously stirred tank reactor.

In an embodiment a second reactor is a continuously stirred tank reactor.

In embodiments a third reactor is a continuously stirred tank reactor or a tubular reactor (also known as a plug flow reactor).

In an embodiment a third reactor is a tubular reactor (also known as a plug flow reactor).

In an embodiment of the disclosure, a solution phase polymerization process is carried out in two sequentially arranged continuously stirred tank reactors and a tubular reactor which receives process flows from the second continuously stirred tank reactor.

In embodiments a first, second and third polymerization reactors operate at a temperature of from 80° C. to 310° C.

In embodiments, a first, second and third polymerization reactors operate at a pressure of from 3 MPag to 45 MPag.

In embodiments a first, second and third polymerization reactors operate at a temperature of from 80° C. to 310° C. and a pressure of from 3 MPag to 45 MPag.

In an embodiment, a continuous solution phase polymerization process comprises a first stirred tank polymerization reactor configured in series with a second stirred tank polymerization reactor and the mean reactor temperature in the first reactor is lower than the mean reactor temperature in the second reactor.

In an embodiment, a continuous solution phase polymerization process comprises a first stirred tank polymerization reactor configured in series with a second stirred tank polymerization reactor which is in turn configured in series with a third polymerization reactor, and the mean reactor temperature in the first reactor is lower than the mean reactor temperature in the second reactor.

In an embodiment, a continuous solution phase polymerization process comprises a first stirred tank polymerization reactor configured in series with a second stirred tank polymerization reactor which is in turn configured in series with a third polymerization reactor, and the mean reactor temperature in the first reactor is lower than the mean reactor temperature in the second reactor and the mean reactor temperature in the third reactor.

In an embodiment, a continuous solution phase polymerization process comprises a first stirred tank polymerization reactor configured in series with a second stirred tank polymerization reactor which is in turn configured in series with a third polymerization reactor, and the mean reactor temperature in the first reactor is lower than the mean reactor temperature in the second reactor, and the mean reactor temperature in the second reactor is lower than the mean temperature in the third reactor.

In embodiments, a first polymerization reactor operates at a temperature which is at least 15° C. lower, or at least 20° C., or at least 25° C. lower, or at least 30° C. lower, or at least 35° C. lower, or at least 40° C. lower, than the temperature at which a second polymerization reactor operates.

In embodiments, a first polymerization reactor operates at a temperature of from 130° C. to 220° C. In further embodiments, a first polymerization reactor operates at a temperature of from 125° C. to 180° C., or from 130° C. to 180° C., or from 135° C. to 180° C., or from 140° C. to 180° C., or from 125° C. to 175° C., or from 125° C. to 170° C., or from 125° C. to 165° C., or from 135° C. to 175° C., or from 135° C. to 170° C., or from 140° C. to 175° C., or from 140° C. to 170° C., or from 135° C. to 165° C., or from 140° C. to 180° C., or from 145° C. to 175° C., or from 145° C. to 170° C., or from 150° C. to 180° C., or from 150° C. to 175° C., or from 150° C. to 170° C., or from 155° C. to 170° C., or from 160° C. to 170° C.

In embodiments, a second polymerization reactor operates at a temperature of from 160° C. to 220° C. In further embodiments, a second polymerization reactor operates at a temperature of from 165° C. to 210° C., or from 165° C. to 205° C., or from 165° C. to 200° C., or from 170° C. to 210° C., or from 170° C. to 205° C., or from 170° C. to 200° C., or from 175° C. to 210° C., or from 175° C. to 205° C., or from 175° C. to 200° C., or from 180° C. to 210° C., or from 180° C. to 205° C., or from 180° C. to 200° C., or from 185° C. to 210° C., or from 185° C. to 205° C., or from 185° C. to 200° C., or from 190° C. to 210° C., or from 190° C. to 205° C., or from 190° C. to 200° C.

In embodiments, a third polymerization reactor operates at a temperature of from 160° C. to 240° C. In further embodiments, a third polymerization reactor operates at a temperature of from 165° C. to 230° C., 165° C. to 220° C., 165° C. to 210° C., or from 165° C. to 205° C., or from 165° C. to 200° C., or from 170° C. to 240° C., or from 170° C. to 230° C., or from 170° C. to 220° C., or from 170° C. to 210° C., or from 170° C. to 205° C., or from 170° C. to 200° C., or from 175° C. to 240° C., or from 175° C. to 230° C., or from 175° C. to 220° C., or from 175° C. to 210° C., or from 175° C. to 205° C., or from 175° C. to 200° C., or from 180° C. to 240° C., or from 180° C. to 230° C., or from 180° C. to 220° C., or from 180° C. to 210° C., or from 180° C. to 205° C., or from 180° C. to 200° C., or from 185° C. to 210° C., or from 185° C. to 205° C., or from 185° C. to 200° C., or from 190° C. to 240° C., or from 190° C. to 230° C., or from 190° C. to 220° C., or from 190° C. to 210° C., or from 190° C. to 205° C., or from 190° C. to 200° C. In still further embodiments, a third polymerization reactor operates at a temperature of at least 195° C., or at least 200° C., or at least 205° C., or at least 210° C. or at least 215° C., or at least 220° C., or at least 225° C., or at least 230° C.

The term “tubular reactor” is meant to convey its conventional meaning: namely a simple tube, which unlike a CSTR is generally not agitated using an impeller, stirrer or the like. In embodiments, a tubular reactor will have a length/diameter (L/D) ratio of at least 10/1. In embodiments, a tubular reactor is operated adiabatically. By way of a general non-limiting description and without wishing to be bound by theory, in a tubular reactor, as a polymerization reaction progresses, the monomer (e.g., ethylene) and/or comonomer (e.g., alpha-olefin) is increasingly consumed and the temperature of the solution increases along the length of the tube (which may improve the efficiency of separating the unreacted comonomer from the polymer solution). In embodiments, the temperature increase along the length of a tubular reactor may be greater than about 3° C. In embodiments, a tubular reactor is located downstream of a CSTR, and the discharge temperature from the tubular reactor may be at least about 3° C. greater than the discharge temperature from the CSTR (and from which process flows are fed to the tubular reactor).

In embodiments, a tubular reactor may have feed ports for the addition of additional polymerization catalyst system components such as single site pre-polymerization catalysts, Ziegler-Natta catalyst components, catalyst activators, cocatalysts, and hindered phenol compounds, or for the addition of monomer, comonomer, hydrogen, etc. In an alternative embodiment, no additional polymerization catalyst components are added to a tubular reactor.

In an embodiment, the total volume of a tubular reactor used in combination with at least one CSTR is at least about 10 volume percent (vol %) of the volume of at the least one CSTR, or from about 30 vol % to about 200 vol % of the at least one CSTR (for clarity, if the volume of the at least one CSTR is 1000 liters, then the volume of the tubular reactor is at least about 100 liters, or from about 300 to 2000 liters).

As discussed above, the temperature within a tubular reactor may increase along its length. The maximum temperature difference between the inlet and outlet of a tubular reactor may in some embodiments of the disclosure be about 100° C., or about 60° C., or about 40° C. The minimum temperature difference between the inlet and outlet of a tubular reactor may in some embodiments be about 0° C., or about 3° C., or about 10° C.

In embodiments, a tubular reactor is operated in an adiabatic fashion or it is heated.

In embodiments, on leaving the reactor system, non-reactive components may be removed (and optionally recovered) and the resulting polymer (e.g. the polyethylene composition) may be finished in a conventional manner (e.g. using a devolatilization process). In an embodiment, a two-stage devolatilization process may be employed to recover a polymer composition from a polymerization process solvent.

As discussed above, in the present disclosure, two different site catalysts (e.g. a metallocene catalyst and a phosphinimine catalyst) are fed to a first upstream reactor and a Ziegler-Natta catalyst is fed to a second downstream reactor. Optionally, a polymerization catalyst selected from a single site catalyst and a Ziegler-Natta catalyst is fed to an optionally present third reactor.

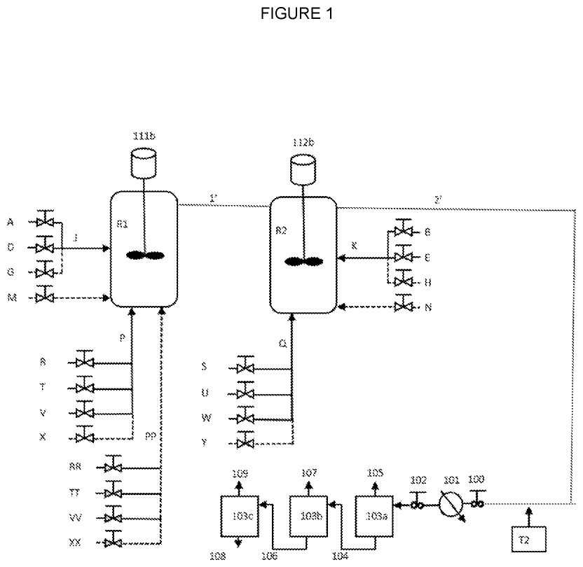

Some embodiments of a continuous solution phase polymerization process comprising a first continuously stirred polymerization reactor and a second continuously stirred polymerization reactor, where the first and second reactors are connected in series, are described with reference to FIG. 1.

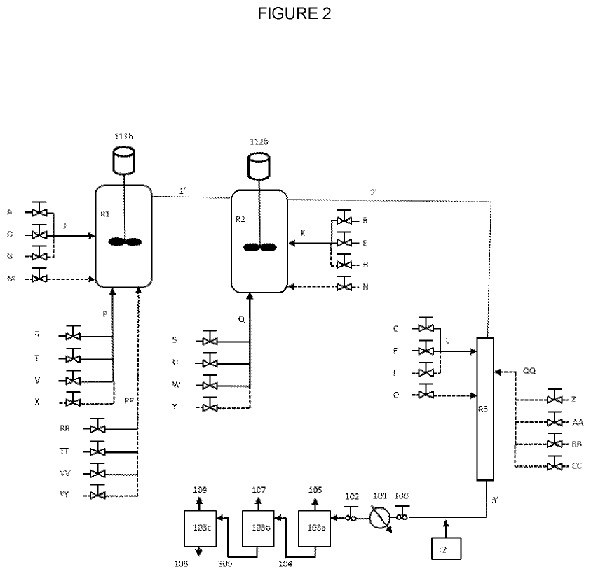

Some embodiments of a continuous solution phase polymerization process comprising a first continuously stirred polymerization reactor, a second continuously stirred polymerization reactor, and a third polymerization reactor which is a tubular reactor, where the first, second and third polymerization reactors are connected in series are described with reference to FIG. 2.

Reactors 1 and 2, R1 and R2 respectively are continuously stirred by stirring assembly 111b and 112b respectively which includes a motor external to the reactor and an agitator within the reactor.

Referring to FIGS. 1 and 2, process solvent may be injected into two reactors configured in series with one another, upstream reactor 1, “R1” and downstream reactor 2, “R2” via streams A and B and optionally into the third reactor, reactor 3, “R3” via stream C. Ethylene may be injected into reactors R1 and R2 via streams D and E. Optionally, ethylene may be injected into reactor R3, via stream F. Optional α-olefin may be injected into reactors 1, 2 and 3 via streams G, H, and I respectively. As shown in FIGS. 1 and 2, the process solvent, ethylene and optional α-olefin feed streams may be combined to form reactor feed streams J, K and L that feed reactors R1, R2 and R3, respectively. Optionally, hydrogen may be injected into reactors R1, R2 and R3 via streams M, N and O respectively.

It is not important that streams J and/or K, and/or L are actually formed; that is, in an alternate embodiment (not shown), the reactor feed streams can be combined in all possible combinations, including independently injecting each stream directly into the reactor.

In an embodiment, a mixed single site catalyst system is fed to the first reactor. In an embodiment, a mixed single site catalyst system which includes a metallocene catalyst and a phosphinimine catalyst is fed to the first reactor. In an embodiment and with reference to FIGS. 1 and 2, a mixed single site catalyst system which includes a metallocene catalyst and a phosphinimine catalyst is injected into reactor 1 via stream P.

In an embodiment, two single site catalysts are fed to the first reactor separately using separate feed streams. In an embodiment, two different single site catalysts including a metallocene catalyst and a phosphinimine catalyst are fed to the first reactor separately using separate feed streams. In an embodiment and with reference to FIGS. 1 and 2, a metallocene catalyst may be fed to first reactor R1, via stream P, and a phosphinimine single site catalyst may be fed to the first reactor R1, via stream PP.

In embodiments, the molar ratio of the metallocene catalyst to the phosphinimine catalyst fed to the first polymerization reactor is at least 40:60, or at least 50:50, or at least 60:40, or at least 70:40, or at least 80:20, or at least 90:10, or at least 95:5.

In embodiments, the molar ratio of the metallocene catalyst to the phosphinimine catalyst fed to the first polymerization reactor is from 40:60 to 99:1, or from 50:50 to 99:1, or from 60:40 to 99:1, or from 70:30 to 99:1, or from 80:20 to 99:1, or from 90:10 to 99:1, or from 95:1 to 99:1, or from 40:60 to 95:5, or from 50:50 to 95:5, or from 60:40 to 95:5, or from 70:30 to 95:5, or from 80:20 to 95:5, or from 90:10 to 95:5.

When an α-olefin is injected into reactors 1 and/or 2, an ethylene copolymer is produced in reactors 1 and 2, respectively. If an α-olefin is not added to the first reactor, then an ethylene homopolymer is formed in the first reactor. If an α-olefin is not added to a downstream reactor, such as reactor 2 or 3, then ethylene homopolymers may be formed, but ethylene copolymers may be formed if α-olefin is added to an upstream reactor and is not completely consumed in the upstream reactor and so flows into reactor 2 or 3.

In embodiments, and with reference to FIGS. 1 and 2:
stream R and/or RR may contain a borane-based activator dissolved in a solvent;
stream T and/or TT may contain one single site catalyst or a mixture of single site catalysts, such as for example a metallocene catalyst and a phopshinimine catalyst, each dissolved in a solvent; and
stream V and/or VV may contain one or more further single site catalyst components such as an alkylaluminoxane co-catalyst dissolved in a solvent.

In embodiments, further optional catalyst component streams, such as stream X and/or XX may contain a hindered phenol dissolved in a solvent.

In embodiments, an alkylaluminoxane co-catalyst is combined with a hindered phenol before being contacted with one or more of the other single site catalyst components (e.g. the metallocene and/or phosphinimine catalyst molecule).

The solvents used to carry or dissolve the single site catalyst molecules or other single site catalyst components to the first reactor, such as activators, cocatalysts, etc. may be the same or different.

In an embodiment, and with reference to FIGS. 1 and 2 a Ziegler-Natta catalyst is injected into the second reactor (R2) which is downstream and connected in series with the first reactor (R1). The Ziegler-Natta catalyst may be prepared in line as discussed above and fed to the second reactor using a catalyst component mixing tree, which in embodiments of the disclosure, and with reference to FIGS. 1 and 2, may be represented by one or more feed streams (S, U, W, Y, etc.) entering the second reactor by feed stream Q, or the Ziegler-Natta catalyst may be prepared in batch mode, stored in a holding tank and activated before being fed to the second reactor, or activated on route to the second reactor, via feed stream Q.

In an embodiment and with reference to FIG. 2, a Ziegler-Natta catalyst is injected into a third reactor, R3 which is downstream and connected in series with the second reactor, R2. The Ziegler-Natta catalyst may be prepared in line as discussed above and fed to the second reactor using a catalyst component mixing tree, which in embodiments, and with reference to FIG. 2, may be represented by one or more feed streams (Z, AA, BB, CC, etc.) entering the third reactor by feed stream QQ, or the Ziegler-Natta catalyst may be prepared in batch mode, stored in a holding tank and activated before being fed to the third reactor, or on route to the third reactor via feed stream QQ.

An efficient in-line Ziegler-Natta catalyst may be formed by optimizing the following molar ratios: aluminum alkyl/magnesium compound; chloride compound/magnesium compound; alkyl aluminum co-catalyst/metal compound; and aluminum alkyl/metal compound; as well as the time these compounds have to react and equilibrate.

In embodiments and with reference to FIGS. 1 and 2:
stream Y and optionally stream CC may contain a binary blend of a magnesium compound and an aluminum alkyl (e.g. triethylaluminum) in process solvent;
stream W and optionally stream BB may contain a solution of a chloride compound in process solvent;
stream U and optionally stream AA may contain a metal compound (e.g. TiCl₄);
stream S and optionally stream Z may contain an alkyl aluminum co-catalyst (e.g. diethylaluminumethoxide).

In embodiments, the upper limit on the (aluminum alkyl)/(magnesium compound) molar ratio may be about 70, or about 50, or about 30, while the lower limit on the (aluminum alkyl)/(magnesium compound) molar ratio may be about 3.0, or about 5.0, or about 1.0.

In embodiments, and with reference to FIGS. 1 and 2, stream Y is combined with stream W and optionally stream CC is combined with stream BB; and the intermixing of these steams produces a magnesium chloride catalyst support.

In embodiments, the upper limit on the (chloride compound)/(magnesium compound) molar ratio may be about 4, or about 3.5, or about 3.0, while the lower limit on the (chloride compound)/(magnesium compound) molar ratio may be about 1.0, or about 1.5, or about 1.9. In further embodiments, the (chloride compound)/(magnesium compound) molar ratio may be from about 1.8 to about 2.2.

In embodiments, the upper limit on the (magnesium compound)/(metal compound) molar ratio may be about 50, or about 25, or about 20, while the lower limit on the (magnesium compound)/(metal compound) molar ratio may be 1, or about 2.0, or about 3.0. In further embodiments, the (magnesium compound)/(metal compound) molar ratio may be from about 5.0 to about 15.0.

In embodiments, the upper limit on the (aluminum alkyl)/(metal compound) molar ratio is about 2, or about 1.5, or about 1.0, while the lower limit on the (aluminum alkyl)/(metal compound) molar ratio may be about 0.05, or about 0.075, or about 0.1. In further embodiments, the (aluminum alkyl)/(metal compound) molar ratio is from about 0.25 to about 0.75.

The time between the addition of the chloride compound and the addition of the magnesium compound may be controlled; and may be designated by a first “hold-up-time”, hereafter HUT-1 (the first Hold-Up-Time). HUT-1 is the time for streams Y and W and optionally streams CC and BB to equilibrate and form a magnesium chloride support. In embodiments, the upper limit on HUT-1 may be about 70 seconds, or about 60 seconds, or about 50 seconds, while the lower limit on HUT-1 may be about 5 seconds, or about 10 seconds, or about 20 seconds. HUT-1 is controlled by adjusting the length of the conduit between stream W injection and stream U injection port (and optionally stream BB injection port and stream AA injection port), as well as controlling the flow rates of streams Y and W (and optionally steams CC and BB).

The time between the addition of metal compound and the addition of the alkyl aluminum co-catalyst may be controlled and may be designated by a second “hold-up-time”, hereafter HUT-2 (the second Hold-Up-Time). HUT-2 is the time for the magnesium chloride support and the metal compound to react (i.e. the time for streams U and optionally AA to react and equilibrate with the streams containing the magnesium chloride support which are the combined streams Y and W and optionally the combined streams CC and BB). In embodiments, the upper limit on HUT-2 may be about 50 seconds, or about 35 seconds, or about 25 seconds, while the lower limit on HUT-2 may be about 2 seconds, or about 6 seconds, or about 10 seconds. HUT-2 is controlled by adjusting the length of the conduit between stream U injection port and stream S injection port (and optionally stream AA injection port and stream Z injection port), as well as controlling the flow rates of streams Y, Wand U (and optionally streams CC, BB and AA).

In embodiments, the upper limit on the (alkyl aluminum co-catalyst)/(metal compound) molar ratio may be about 10, or about 7.5, or about 6.0, or about 3.0 while the lower limit on the (alkyl aluminum co-catalyst)/(metal compound) molar ratio may be 0, or about 0.5, or about 1.0, or about 2.0. In further embodiments, the (alkyl aluminum co-catalyst)/(metal compound) molar ratio may be from about 1.0 to about 2.5.

The time between the addition of the alkyl aluminum co-catalyst and the injection of the final in-line Ziegler-Natta catalyst formulation into reactor may be controlled, may be controlled, and may be designated by a third “hold-up-time”, hereafter HUT-3 (the third Hold-Up-Time). HUT-3 is the time for the alkyl aluminum co-catalyst to intermix and equilibrate with the other catalyst components in order to form the final in-line Ziegler-Natta catalyst formulation. In embodiments, the upper limit on HUT-3 may be about 15 seconds, or about 10 seconds, or about 8 seconds, while the lower limit on HUT-3 may be about 0.5, or about 1 second, or about 2 seconds. HUT-3 is controlled by adjusting the length of the conduit between stream S injection port (and optionally stream Z injection port) and the catalyst injection port in the second reactor (and optionally the catalyst injection port in the third reactor), and by controlling the flow rates of streams Y, W, U and S (and optionally streams CC, BB, AA, and Z).

Optionally, 100% of the alkyl aluminum co-catalyst (e.g. diethylaluminum ethoxide), may be injected directly into the second reactor (not shown in the Figures). Optionally, a portion of the alkyl aluminum co-catalyst, may be injected directly into the second reactor (not shown in the Figures) and the remaining portion of the alkyl aluminum co-catalyst can be fed to the second reactor by stream S.

Optionally, 100% of the alkyl aluminum co-catalyst (e.g. diethylaluminum ethoxide), may be injected directly into the third reactor (not shown in the Figures). Optionally, a portion of the alkyl aluminum co-catalyst, may be injected directly into the third reactor (not shown in the Figures) and the remaining portion of the alkyl aluminum co-catalyst can be fed to the third reactor by stream Z.

The quantity of the Ziegler-Natta catalyst fed to the second reactor or optionally to the third reactor may be is expressed as the parts-per-million (ppm) of the metal compound, or its metal (e.g. Ti) in the reactor. In embodiments, the upper limit on the amount of metal compound fed to the second and optionally to the third reactor may be about 10 ppm, or about 8 ppm, or about 6 ppm, while the lower limit may be about 0.5 ppm, or about 1 ppm, or about 2 ppm.

Any combination of the streams employed to prepare and deliver the in-line Ziegler-Natta catalyst to reactor 2 or to reactor 3 may be heated or cooled.

In an embodiment and with reference to FIG. 2, a single site catalyst is injected via stream QQ into a third reactor, R3 which is downstream and connected in series with the second reactor, R2.

In an embodiment of the disclosure, and with reference to FIG. 2:
stream Z may contain an ionic activator dissolved in a catalyst component solvent;
stream AA may contain a single site catalyst (i.e. an organometallic complex, such for example, a metallocene catalyst or a phosphinimine catalyst), dissolved in a catalyst component solvent; and
stream BB may contain an alkylaluminoxane co-catalyst dissolved in a catalyst component solvent.

In embodiments, further optional catalyst component streams, such as stream CC may contain a hindered phenol dissolved in a solvent.

In embodiments, an alkylaluminoxane co-catalyst is combined with a hindered phenol before being contact with one or more of the other single site catalyst components.

The solvents used to carry or dissolve the single site catalyst molecules or other single site catalyst components to the third reactor, such as activators, cocatalysts, etc. may be the same or different.

In embodiments, an alkylaluminoxane co-catalyst is combined with a hindered phenol before being contact with one or more single site catalyst components.

The solvents used to carry or dissolve the single site catalyst molecules or other single site catalyst components such as activators, cocatalysts, etc. may be the same or different.

In an embodiment of the disclosure, at least two different single site catalysts, including site catalyst molecules per se (e.g. a metallocene catalyst and a phosphinimine catalyst), as well as cocatalysts, activators and optional hindered phenol components, are each fed to a first upstream polymerization reactor using a catalyst delivery system substantially as described in U.S. Pat. No. 11,066,493, the disclosure of which is incorporated herein in its entirety by reference.

In an embodiment of the disclosure, a mixture comprising at least two different single site catalysts (e.g. a metallocene catalyst and a phosphinimine catalyst) as well as cocatalysts, activators and optional hindered phenol components, is fed to a first upstream polymerization reactor using a catalyst delivery system substantially as described in U.S. Pat. No. 11,066,493, the disclosure of which is incorporated herein in its entirety by reference.

In an embodiment of the disclosure, a Ziegler-Natta catalyst is fed to a second downstream polymerization reactor using a catalyst delivery system substantially as described in U.S. Pat. No. 10,987,647, the disclosure of which is incorporated herein in its entirety by reference.

In an embodiment of the disclosure, a Ziegler-Natta catalyst is fed to a third downstream polymerization reactor using a catalyst delivery system substantially as described in U.S. Pat. No. 10,987,647, the disclosure of which is incorporated herein in its entirety by reference.

In an embodiment of the disclosure, a single site catalyst, as well as cocatalysts, activators and optional hindered phenol components is fed to a third downstream polymerization reactor using a catalyst delivery system substantially as described in U.S. Pat. No. 11,066,493, the disclosure of which is incorporated herein in its entirety by reference.

In operating the continuous solution polymerization process embodiments shown in FIGS. 1 and 2 the total amount of ethylene converted in each reactor may be monitored. The term “Q^{R1}” refers to the percent of the ethylene added to R1 that is converted into a polyethylene polymer by the catalyst system. Similarly, “Q^{R2}” and “Q^{R3}” represent the percent of the ethylene added to R2 and R³ that was converted into a polyethylene polymer, in the respective reactors.

Ethylene conversions, or “Q” in each reactor can vary significantly depending on a variety of process conditions, e.g. catalyst concentration, catalyst system, impurities and poisons.

In embodiments of the disclosure, and with reference to FIGS. 1 and 2 the upper limit on both Q^{R1} and Q^{R2} may be about 99%, or about 95%, or about 90%; while the lower limit on both Q^{R1} and Q^{R2} may be from about 65%, or about 70%, or about 75%.

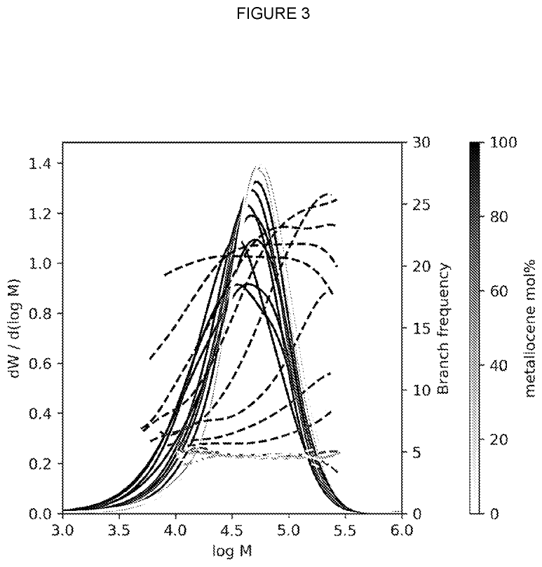

In embodiments of the disclosure, and with reference to FIG. 3, the upper limit on Q^{R3} may be about 99%, or about 95%, or about 90%; while the lower limit on Q^{R3} may be 1%, or about 5%, or about 10%.

The term “Q^{TOTAL}” represents the total or overall ethylene conversion across the entire continuous solution polymerization plant; i.e. Q^{T}=100×[weight of ethylene in the polyethylene product]/([weight of ethylene in the polyethylene product]+[weight of unreacted ethylene]). The upper limit on QT in some cases is about 99%, in other cases about 95% and in still other cases about 90%; the lower limit on QT in some cases is about 75%, in other cases about 80% and in still other cases about 85%.

In operating the continuous solution polymerization process embodiments shown in FIG. 1 the total amount of ethylene supplied to the process can be portioned or split between the two reactors R1 and R2.

This operational variable is referred to as the Ethylene Split (ES), i.e. “ES^{R1}” and “ES^{R2}” refer to the weight percent of ethylene injected in R1 and R2 respectively; with the proviso that ES^{R1}+ES^{R2}=100%. This is accomplished by adjusting the ethylene flow rates to R1 and R2.

In embodiments of the disclosure, and with reference to FIG. 1, the upper limit on ES^{R1} is about 80%, or about 75%, or about 70%, or about 65%; or about 60%, or about 55%; and the lower limit on ES^{R1} is about 10%, or about 15%, or about 20%.

In embodiments of the disclosure, and with reference to FIG. 1 the upper limit on ES^{R2} is about 60%, or about 55% or about 50%; or about 45%, or about 40%, or about 35%, or from about 30%; and the lower limit on ES^{R2} is about 5%, or about 10%, or about 15%, or about 20%, or about 25%.

In operating the continuous solution polymerization process embodiments shown in FIG. 2 the total amount of ethylene supplied to the process can be portioned or split between the three reactors R1, R2 and R³.

This operational variable is referred to as the Ethylene Split(ES), i.e. “ES^{R1}”, “ES^{R2}” and “ES^{R3}” refer to the weight percent of ethylene injected in R1, R2 and R3, respectively; with the proviso that ES^{R1}+ES^{R2}+ES^{R3}=100%. This is accomplished by adjusting the ethylene flow rates to R1, R2 and R3.

In embodiments of the disclosure, and with reference to FIG. 2, the upper limit on ES^{R1} is about 80%, or about 75%, or about 70%, or about 65%; or about 60%, or about 55%; and the lower limit on ES^{R1} is about 10%, or about 15%, or about 20%.

In embodiments of the disclosure, and with reference to FIG. 2 the upper limit on ES^{R2} is about 60%, or about 55% or about 50%; or about 45%, or about 40%, or about 35%, or from about 30%; and the lower limit on ES^{R2} is about 5%, or about 10%, or about 15%, or about 20%, or about 25%.

In embodiments of the disclosure, and with reference to FIG. 2 the upper limit on ES^{R3} is about 50%, or about 40%, or about 35%, or about 30%, or about 25%, or about 20%; and the lower limit on ES^{R3} is about 1%, or about 5%, or about 10%.

Optionally, a-olefin may be added to the continuous solution polymerization process.

If added, and with reference to FIG. 1, a-olefin may be proportioned or split between R1 and R2. This operational variable is referred to as the Comonomer Split (CS), i.e. “CS^{R1}” and “CS^{R2}” refer to the weight percent of α-olefin comonomer that is injected in R1 and R2, respectively; with the proviso that CS^{R1}+CS^{R2}=100%. This is accomplished by adjusting a-olefin flow rates to R1 and R2.

In embodiments and with reference to FIG. 1, the upper limit on CS^{R1} in some cases is 100% (i.e. 100% of the α-olefin is injected into R1), in other cases about 95% and in still other cases about 90%, while the lower limit on CS^{R1} in some cases is 0% (ethylene homopolymer produced in R1), in other cases about 5% and in still other cases about 10%.

In embodiments and with reference to FIG. 1, the upper limit on CS^{R2} in some cases is about 100% (i.e. 100% of the α-olefin is injected into reactor 2), in other cases about 95% and in still other cases about 90%, while the lower limit on CS^{R2} in some cases is 0%, in other cases about 5% and in still other cases about 10%.

If added, and with reference to FIG. 2, α-olefin may be proportioned or split between R1, R2 and R3. This operational variable is referred to as the Comonomer Split (CS), i.e. “CS^{R1}”, “CS^{R2}” and “CS^{R3}” refer to the weight percent of a-olefin comonomer that is injected in R1, R2 and R3, respectively; with the proviso that CS^{R1}+CS^{R2}+CS^{R3}=100%. This is accomplished by adjusting a-olefin flow rates to R1, R2 and R3.

In embodiments and with reference to FIG. 2, the upper limit on CS^{R1} in some cases is 100% (i.e. 100% of the α-olefin is injected into R1), in other cases about 95% and in still other cases about 90%, while the lower limit on CS^{R1} in some cases is 0% (ethylene homopolymer produced in R1), in other cases about 5% and in still other cases about 10%.

In embodiments and with reference to FIG. 2, the upper limit on CS^{R2} in some cases is about 100% (i.e. 100% of the α-olefin is injected into reactor 2), in other cases about 95% and in still other cases about 90%, while the lower limit on CS^{R2} in some cases is 0%, in other cases about 5% and in still other cases about 10%.

In embodiments, and with reference to FIG. 2, the upper limit on CS^{R3} in some cases is 100%, in other cases about 95% and in still other cases about 90%, while the lower limit on CS^{R3} in some cases is 0%, in other cases about 5% and in still other cases about 10%.

In an embodiment of the continuous solution polymerization process, and with reference to FIG. 1, reactor 1 produces exit or effluent stream 1′, and reactor 2 produces exit or effluent stream 2′.

In an embodiment of the continuous solution polymerization process, and with reference to FIG. 2, reactor 1 produces exit or effluent stream 1′, reactor 2 produces exit or effluent stream 2′, and reactor 3 produces exit or effluent stream 3′.

In embodiments where the solution phase polymerization process employs two reactors connected in series, the effluent stream from the second reactor comprises the final polyethylene composition.

In embodiments where the solution phase polymerization process employs three reactors connected in series, the effluent stream from the third reactor comprises the final polyethylene composition.

As shown in FIGS. 1 and 2, when the first and second reactors, R1 and R2 are operated in a series mode, the first effluent or exit stream 1′ will contain a first polyethylene made in the first reactor dissolved in process solvent; as well as unreacted ethylene, unreacted α-olefins (if present), unreacted hydrogen (if present), active catalysts, deactivated catalysts, catalyst components and other impurities (if present), all of which flow into the second reactor, R2.

As shown in FIGS. 1 and 2, when the first and second reactors, R1 and R2 are operated in a series mode, the second effluent or exit stream 2′ contains the first polyethylene, a second polyethylene made in the second reactor both dissolved in process solvent. The second effluent stream may also contain unreacted ethylene, unreacted α-olefins (if present), unreacted hydrogen (if present), active catalysts, deactivated catalysts, catalyst components and other impurities (if present).

In an embodiment of the disclosure, and with reference to FIG. 1, the first second effluent steam, 2′ is fed to polymer recovery to obtain the polyethylene composition.

In an embodiment of the disclosure, and with reference to FIG. 2, the second effluent stream, 2′ is fed to a third, downstream reactor, R3. As shown in FIG. 2, when the first, second and third reactors, R1, R2 and R3 are operated in a series mode, the third effluent or exit stream 3′ contains the first polyethylene, the second polyethylene and a third polyethylene made in the third reactor all of which are dissolved in process solvent. The third effluent stream may also contain unreacted ethylene, unreacted α-olefins (if present), unreacted hydrogen (if present), active catalysts, deactivated catalysts, catalyst components and other impurities (if present).

In an embodiment of the disclosure, and with reference to FIG. 2, the third effluent steam, 3′ is fed to polymer recovery to obtain the polyethylene composition.

In an embodiment, and with reference to FIG. 1, the second exit stream 2′ is deactivated by adding a catalyst deactivator from catalyst deactivator tank, T2, forming a deactivated solution which is fed to a devolatilization system to recover the polyethylene composition.

In an embodiment, and with reference to FIG. 2, the third exit stream 3′ is deactivated by adding a catalyst deactivator from catalyst deactivator tank, T2, forming a deactivated solution which is fed to a devolatilization system to recover the polyethylene composition.

In embodiments of the disclosure, the pressure in the solution polymerization reactors should be high enough to maintain the polymerization solution as a single phase solution and to provide the upstream pressure to force the polymer solution from the reactors through a heat exchanger and on to polymer recovery operations. In embodiments and with reference to FIGS. 1, and 2, the operating pressure of the solution polymerization reactors can vary over a wide range. For example, the upper limit on reactor pressure in some cases may be about 45 MPag, in other cases about 30 MPag and in still other cases about 20 MPag; and the lower limit in some cases may be about 3 MPag, in other some cases about 5 MPag and in still other cases about 7 MPag.

In an embodiment of the disclosure, one or more of the solution polymerization reactors can be operated at a pressure which is low enough for the one phase polymer solution to phase separate into a two phase liquid/liquid polymer solution.

The polyethylene composition product produced in the continuous solution polymerization process may be recovered using conventional devolatilization systems that are well known to persons skilled in the art, non-limiting examples include flash devolatilization systems and devolatilizing extruders.

In various embodiments and with reference to FIGS. 1 and 2, downstream of the second reactor, R2, or downstream of the third reactor, R3, a catalyst deactivator may be added via catalyst deactivator tank T2 forming a deactivated stream which is then fed via a pressure let down device, 100 to a devolatilization system. The devolatilization system may comprises a vapour/liquid (“V/L”) separator 103a (or alternatively a liquid/liquid separator, not shown), downstream of a heat exchanger, 101 and a second pressure let-down device 102. In embodiments, two streams are formed in V/L separator 103a (or alternatively a liquid/liquid separator); bottom stream 104 containing a polyethylene composition rich solution and gaseous overhead stream 105. Optionally, bottom stream 104 enters a second V/L separator 103b (or alternatively a liquid/liquid separator, not shown) and two streams are formed; bottom stream 106 and gaseous overhead stream 107. Optionally, bottom stream 106 enters a third V/L separator 103c (or alternatively a liquid/liquid separator, not shown) and two streams are formed; product stream 108 and gaseous overhead stream 109.

In embodiments and with reference to FIGS. 1, and 2 the product stream 108 proceeds to polymer recovery. Gaseous overhead streams 105, 107 and 109 are sent to a distillation column where solvent, ethylene and optional a-olefin are separated and recycled to the solution polymerization process.

### The First Polyethylene Made in a First Polymerization Reactor

The first polyethylene is produced in the presence of two different single site catalysts (e.g. a metallocene catalyst and a phosphinimine catalyst), and in an embodiment, and with regard to FIG. 1 or 2, is produced in an upstream reactor, reactor 1, R1.

In embodiments and referring to FIG. 1, if the optional a-olefin is not added to reactor 1 (R1), then the first polyethylene produced in R1 will be an ethylene homopolymer. If an a-olefin is added, then the first polyethylene produced in R1 will be an ethylene copolymer.

In embodiments of the disclosure, alpha-olefins which may be copolymerized with ethylene to make the first polyethylene may be selected from the group comprising 1-propene, 1-butene, 1-pentene, 1-hexene and 1-octene and mixtures thereof.

In an embodiment of the disclosure, the first polyethylene is an ethylene/1-octene copolymer.

In an embodiment the first polyethylene comprises a polyethylene component made by a metallocene catalyst and a polyethylene component made by a phosphinimine catalysts

In an embodiment the first polyethylene comprises a higher molecular weight (where molecular weight may be defined by, for example, Mn, Mw, or Mz) polyethylene component made by a metallocene catalyst and a lower molecular weight polyethylene component made by a phosphinimine catalyst.

In an embodiment the first polyethylene comprises a higher molecular weight (where molecular weight may be defined by, for example, Mn, Mw, or Mz) polyethylene component made by a phosphinimine catalyst and a lower molecular weight polyethylene component made by a metallocene catalyst.

In an embodiment the first polyethylene comprises a lower density polyethylene component made by a metallocene catalyst and a higher density polyethylene component made by a phosphinimine catalyst.

In an embodiment the first polyethylene comprises a lower density polyethylene component made by a phosphinimine catalyst and a higher density polyethylene component made by a metallocene catalyst.

In an embodiment when one or more than one α-olefin is fed to the first polymerization reactor the first polyethylene comprises a polyethylene component made by a metallocene catalyst and a polyethylene component made by a phosphinimine catalyst and the polyethylene component made by the metallocene catalyst has a higher amount of short chain branching per thousand carbon atoms (SCB/1000Cs) than polyethylene component made by the phosphinimine catalyst.

In an embodiment of the disclosure, the number of short chain branches per thousand carbon atoms in the first polyethylene is greater than the number of short chain branches per thousand carbon atoms in the second polyethylene.

In an embodiment of the disclosure, the first polyethylene copolymer has from 1 to 100 short chain branches per thousand carbon atoms, SCB1/1000Cs. In further embodiments, the first polyethylene has from 3 to 100 short chain branches per thousand carbon atoms (SCB1), or from 5 to 100 short chain branches per thousand carbon atoms (SCB1), or from 5 to 75 short chain branches per thousand carbon atoms (SCB1), or from 10 to 75 short chain branches per thousand carbon atoms (SCB1), or from 5 to 50 short chain branches per thousand carbon atoms (SCB1), or from 5 to 30 short chain branches per thousand carbon atoms, or from 10 to 50 short chain branches per thousand carbon atoms (SCB1), or from 15 to 75 short chain branches per thousand carbon atoms (SCB1), or from 3 to 50 short chain branches per thousand carbon atoms (SCB1), or from 7.5 to 50 short chain branches per thousand carbon atoms (SCB1), or from or from 5 to 40 short chain branches per thousand carbon atoms (SCB1), or from 5 to 30 short chain branches per thousand carbon atoms (SCB1), or from or from 5 to 25 short chain branches per thousand carbon atoms (SCB1).

In embodiments where an a-olefin is added to the first reactor, then the first polyethylene produced in R1 is an ethylene copolymer and the following weight ratio is one parameter used to control the density of the first polyethylene: ((a-olefin)/(ethylene))^{R1}. The upper limit on ((a-olefin)/(ethylene))^{R1} may be about 3; in other cases about 2 and in still other cases about 1. The lower limit on ((a-olefin)/(ethylene))^{R1} may be 0; in other cases about 0.25 and in still other cases about 0.5. Hereafter, the term “d1” refers to the density of the first polyethylene produced in R1. In embodiments, the upper limit on d1 may be about 0.975 g/cm³; or about 0.965 g/cm³, or about 0.955 g/cm³, while the lower limit on d1 may be about 0.855 g/cm³, or about 0.865 g/cm³, or about 0.875 g/cm³.

In embodiments of the disclosure the density, d1 may be from about 0.875 g/cm³ to about 0.965 g/cm³, or from about 0.875 g/cm³ to about 0.960 g/cm³, or from about 0.875 g/cm³ to 0.950 g/cm³, or from about 0.865 g/cm³ to about 0.940 g/cm³, or from about 0.865 g/cm³ to about 0.936 g/cm³, or from about 0.865 g/cm³ to about 0.932 g/cm³, or from about 0.865 g/cm³ to about 0.926 g/cm³, or from about 0.865 g/cm³ to about 0.921 g/cm³, or from about 0.865 g/cm³ to about 0.918 g/cm³, or from about 0.875 g/cm³ to about 0.916 g/cm³, or from about 0.875 g/cm³ to about 0.916 g/cm³, or from about 0.865 g/cm³ to about 0.912 g/cm³, or from 0.880 g/cm³ to 0.912 g/cm³.

In embodiments of the disclosure, the first polyethylene has a density, d1 of from 0.865 to 0.936 g/cm³, including any narrower ranges within this range and any values encompassed by these ranges. For example, in embodiments of the disclosure, the first polyethylene has a density, d1 of from 0.865 to 0.932 g/cm³, or from 0.865 to 0.930 g/cm³, or from 0.875 to 0.936 g/cm³, or from 0.880 to 0.936 g/cm³, or from 0.880 to 0.934 g/cm³, or from 0.880 to 0.932 g/cm³, or from 0.880 to 0.930 g/cm³, or from 0.880 to 0.928 g/cm³, or from 0.880 to 0.926 g/cm³, or from 0.880 to 0.924 g/cm³, or from 0.880 to 0.922 g/cm³, or from 0.880 to 0.920 g/cm³, or from 0.880 to 0.918 g/cm³, or from 0.880 to 0.916 g/cm³, or from 0.880 to 0.914 g/cm³, or from 0.880 to 0.912 g/cm, or from 0.880 to 0.910 g/cm³.

In an embodiment of the disclosure, the density of the first polyethylene is less than the density of the second polyethylene.

The amount of hydrogen added to the first reactor (e.g. R1) can vary over a wide range allowing the continuous solution process to produce first polyethylenes that differ greatly in melt index, hereafter I₂¹ (melt index is measured at 190° C. using a 2.16 kg load following the procedures outlined in ASTM D1238). In embodiments, and with reference to FIGS. 1 and 2, this may be accomplished by adjusting the hydrogen flow rate to the first reactor. The quantity of hydrogen added to R1 may be expressed as the parts-per-million (ppm) of hydrogen in R1 relative to the total mass in reactor R1; hereafter H₂^{R1} (ppm). In some cases H₂^{R1} (ppm) ranges from about 100 ppm to 0 ppm, in other cases from about 50 ppm to 0 ppm, in alternative cases from about 20 ppm to 0 ppm and in still other cases from about 2 ppm to 0 ppm. In embodiments of the disclosure, the upper limit on I₂¹ may be about 200 dg/min, or about 100 dg/min; or about 50 dg/min, or about 1 dg/min, while the lower limit on I₂¹ may be about 0.01 dg/min, or about 0.05 dg/min; or about 0.1 dg/min, or about 0.5 dg/min.

In embodiments of the disclosure the melt index of the first polyethylene I₂¹ may be from about 0.01 dg/min to about 100 dg/min, or from about 0.05 dg/min to about 50 dg/min, or from about 0.10 dg/min to about 50 dg/min, or from about 0.01 dg/min to about 25 dg/min, or from about 0.05 dg/min to about 25 dg/min, or from about 0.10 dg/min to about 25 dg/min, or from about 0.01 dg/min to about 10 dg/min, or from about 0.05 dg/min to about 10 dg/min, or from about 0.10 dg/min to about 10 dg/min, or from about 0.01 dg/min to about 5.0 dg/min, or from about 0.05 dg/min to about 5.0 dg/min, or from about 0.10 dg/min to about 5.0 dg/min, or from about 0.10 dg/min to about 3.0 dg/min, or from about 0.05 dg/min to about 3.0 dg/min, or from about 0.05 to 2.5 dg/min.

In an embodiment of the disclosure the melt index of the first polyethylene I₂¹ may be less than about 1.0 dg/min.

In an embodiment of the disclosure, the melt index, I₂¹ of the first polyethylene is less than the melt index, I₂² of second polyethylene.

In embodiments of the disclosure the first polyethylene has a melt index, I₂¹ of, ≤10 g/10 min, or ≤5.0 g/10 min, or ≤2.5 g/10 min, or ≤1.0 g/10 min, or <1.0 g/10 min. In another embodiment of the disclosure, the first polyethylene copolymer has a melt index, I₂¹ of from 0.001 to 10.0 g/10 min, including any narrower ranges within this range and any values encompassed by these ranges. For example, in embodiments of the disclosure, the melt index, I₂¹ of the first polyethylene may be from 0.001 to 7.5 g/10 min, or from 0.001 to 5.0 g/10 min, or from 0.001 to 2.5 g/10 min, or 0.001 to 1.0 g/10 min, or from 0.01 to 10.0 g/10 min, or from 0.01 to 7.5 g/10 min, or from 0.01 to 5.0 g/10 min, or from 0.01 to 2.5 g/10 min, or from 0.01 to 1.0 g/10 min, or from 0.1 to 10.0 g/10 min, or from 0.1 to 7.5 g/10 min, or from 0.1 to 5.0 g/10 min, or from 0.1 to 2.5 g/10 min, or from 0.1 to 1.0 g/10 min, or from 0.1 to less than 1.0 g/10 min.

In an embodiment of the disclosure, the molecular weight (where molecular weight may be defined by, for example, Mn, Mw, or Mz) of the first polyethylene is greater than the molecular weight of the second polyethylene.

In an embodiment of the disclosure, the first polyethylene has a weight average molecular weight, M_{w} of from 75,000 to 300,000 g/mol, including any narrower ranges within this range and any values encompassed by these ranges. For example, in embodiments of the disclosure, the first polyethylene has a weight average molecular weight, M_{w} of from 100,000 to 250,000 g/mol, or from 100,000 to 225,000 g/mol, or from 100,000 to 200,000 g/mol, or from 125,000 to 200,000 g/mol, or from 125,000 to 180,000 g/mol.

In embodiments of the disclosure, the upper limit on the molecular weight distribution, M_{w}/Mₙ of the first polyethylene may be about 4.0, or about 3.5, or about 3.0. In embodiments of the disclosure, the lower limit on the molecular weight distribution, M_{w}/Mₙ of the first polyethylene may be about 1.8, or about 2.0, or about 2.2, or about 2.4.

In embodiments of the disclosure, the weight percent (wt %) of the first polyethylene in the polyethylene composition (i.e. the weight percent of the first polyethylene based on the total weight of the first polyethylene, the second polyethylene and the optionally present third polyethylene) may be from about 5 wt % to about 80 wt %, including any narrower ranges within this range and any values encompassed by these ranges. For example, in embodiments of the disclosure, the weight percent (wt %) of the first polyethylene in the polyethylene composition may be from about 5 to 75 wt %; or from about 5 wt % to about 65 wt %, from about 20 wt % to about 80 wt %, or from about 20 wt % to about 75 wt %, or from about 25 wt % to about 75 wt %, or from about 30 wt % to about 70 wt %, or from about 10 wt % to about 60 wt %, or from about 10 wt % to about 50 wt %, or from about 10 wt % to about 45 wt %, or from about 10 wt % to about 40 wt %, or from about 15 wt % to about 50 wt %, or from about 15 wt % to about 40 wt %, or from about 20 to 40 wt %, or from about 20 to 35 wt %.

### The Second Polyethylene Made in a Second Polymerization Reactor

The second polyethylene is produced in the presence of a Ziegler-Natta catalyst, and in an embodiment, and with regard to FIG. 1 or 2, is produced in a downstream reactor, reactor 2, R2.

In embodiments and with reference to FIG. 1 or 2, if the optional a-olefin is not added to reactor 2 (R2), then the second polyethylene produced in R2 will be an ethylene homopolymer if there are no substantial amounts of unreacted a-olefin present in the first effluent stream coming from the first reactor, R1. If an a-olefin is added directly to the second reactor or is present in the first effluent stream, then the second polyethylene produced in R2 will be an ethylene copolymer.

In embodiments of the disclosure, alpha-olefins which may be copolymerized with ethylene to make the second polyethylene may be selected from the group comprising 1-propene, 1-butene, 1-pentene, 1-hexene and 1-octene and mixtures thereof.

In an embodiment of the disclosure, the second polyethylene is an ethylene/1-octene copolymer.

In an embodiment of the disclosure, the second polyethylene is an ethylene homopolymer.

In an embodiment of the disclosure, the number of short chain branches per thousand carbon atoms in the second polyethylene is less than the number of short chain branches per thousand carbon atoms in the first polyethylene.

In an embodiment of the disclosure, the second polyethylene has from 1 to 100 short chain branches per thousand carbon atoms (SCB2/1000Cs). In further embodiments, the second polyethylene has from 1 to 50 short chain branches per thousand carbon atoms (SCB2), or from 1 to 30 short chain branches per thousand carbon atoms (SCB2), or from 1 to 25 short chain branches per thousand carbon atoms (SCB2), or from 3 to 50 short chain branches per thousand carbon atoms (SCB2), or from 5 to 50 short chain branches per thousand carbon atoms (SCB2), or from 3 to 30 short chain branches per thousand carbon atoms (SCB2), or from 5 to 30 short chain branches per thousand carbon atoms (SCB2), or from 3 to 25 short chain branches per thousand carbon atoms (SCB2), or from 5 to 25 short chain branches per thousand carbon atoms (SCB2).

In an embodiment of the disclosure, the short chain branching in the second polyethylene can be from about 0.10 to about 10.0 short chain branches per thousand carbon atoms (SCB2/1000Cs). In further embodiments of the disclosure, the short chain branching in the second polyethylene copolymer can be from 0.10 to 7.5, or from 0.10 to 5.0, or from 0.10 to 3.0, or from 0.10 to 1.5 branches per thousand carbon atoms (SCB2/1000Cs).

In embodiments and with reference to FIGS. 1 and 2, if optional a-olefin is added directly to the second reactor, either by use of a fresh a-olefin stream and/or carried over from the first reactor in effluent stream 1′, then the second polymer formed in second reactor is an ethylene copolymer and the following weight ratio determines the density of the third polyethylene:((a-olefin)/(ethylene))^{R2}. The upper limit on ((a-olefin)/(ethylene))^{R2} may be about 3; in other cases about 2 and in still other cases about 1. The lower limit on ((a-olefin)/(ethylene))^{R2} may be 0; in other cases about 0.25 and in still other cases about 0.5. Hereafter, the term “d2” refers to the density of the second polyethylene produced in R2.

In embodiments, the upper limit on d2 may be about 0.975 g/cm³, or about 0.965 g/cm³, or about 0.955 g/cm³, while the lower limit on d2 may be about 0.89 g/cm³, or about 0.90 g/cm³, or about 0.91 g/cm³.

In embodiments of the disclosure, the upper limit on the density, d2 of the second polyethylene may be about 0.975 g/cm³, or about 0.970 g/cm³, or about 0.965 g/cm³, while the lower limit on the density, d2 of the second polyethylene may be about 0.885 g/cm³, or about 0.895 g/cm³, or about 0.890 g/cm³.

In embodiments of the disclosure the density, d2 may be from about 0.921 g/cm³ to about 0.975 g/cm³, or from about 0.926 g/cm³ to about 0.975 g/cm³, or from about 0.930 g/cm³ to about 0.975 g/cm³, or from about 0.936 g/cm³ to about 0.975 g/cm³, or from about 0.940 g/cm³ to about 0.975 g/cm³, or from about 0.945 g/cm³ to about 0.975 g/cm³, or from about 0.950 g/cm³ to about 0.975 g/cm³, or from about 0.951 g/cm³ to about 0.975 g/cm³, or from about 0.953 g/cm³ to about 0.970 g/cm³, or from about 0.953 g/cm³ to about 0.959 g/cm³, or from about 0.955 g/cm³ to about 0.975 g/cm³, or from about 0.951 g/cm³ to about 0.959 g/cm³, or from 0.936 to about 0.970 g/cm³, or from about 0.940 g/cm³ to about 0.970 g/cm³, or from about 0.945 g/cm³ to about 0.970 g/cm³, or from about 0.950 g/cm³ to about 0.970 g/cm³.

In an embodiment of the disclosure, the density of the second polyethylene is greater than the density of the first polyethylene.

The amount of hydrogen added to the second reactor (e.g. R2) can vary over a wide range allowing the continuous solution process to produce second polyethylenes that differ greatly in melt index, hereafter I₂² (melt index is measured at 190° C. using a 2.16 kg load following the procedures outlined in ASTM D1238). In embodiments, and with reference to FIGS. 1 and 2, this may be accomplished by adjusting the hydrogen flow rate to the second reactor. The quantity of hydrogen added to R² may be expressed as the parts-per-million (ppm) of hydrogen in R2 relative to the total mass in reactor R2; hereafter H₂^{R2} (ppm). In some cases H₂^{R2} (ppm) ranges from about 100 ppm to 0 ppm, in other cases from about 50 ppm to 0 ppm, in alternative cases from about 20 ppm to 0 ppm and in still other cases from about 2 ppm to 0 ppm. In embodiments, the upper limit on I₂² may be about 20,000 dg/min; or about 10,000 dg/min; or about 1,500 dg/min, or about 1,000 dg/min, while the lower limit on I₂² may be about 0.3 dg/min, or about 0.4 dg/min, or about 0.5 dg/min, or about 0.6 dg/min.

In an embodiment of the disclosure the second polyethylene has a melt index, I₂² of ≥50.0 g/10 min.

In embodiments of the disclosure the second polyethylene has a melt index, I₂² of from 10 to 10,000 including any narrower ranges within this range and any values encompassed by these ranges. For example, in embodiments of the disclosure, the melt index, I₂² of the second polyethylene is from 10 to 5,000 g/10 min, or from 15 to 2,500 g/10 min, or from 20 to 5,000 g/10 min, or from 20 to 2,500 g/10 min, or from 50 to 5,000 g/10 min, or from 50 to 2,500 g/10 min, or from 20 to 1,000 g/10 min, or from 50 to 1,000 g/10 min, or from 20 to 500 g/10 min, or from 50 to 500 g/10 min, or from 20 to 250 g/10 min, or from 50 to 250 g/10 min.

In an embodiment of the disclosure, the melt index, I₂ of the second polyethylene is greater than the melt index, I₂ of first polyethylene.

In an embodiment of the disclosure, the molecular weight (where molecular weight may be defined by, for example, Mn, Mw, or Mz) of the second polyethylene is less than the molecular weight of the first polyethylene.

In an embodiment of the disclosure, the second polyethylene has a weight average molecular weight, M_{w} of ≤75,000 g/mol, or ≤60,000 g/mol, or ≤50,000 g/mol, or ≤45,000 g/mol, or ≤40,000 g/mol, or ≤35,000 g/mol, or ≤30,000 g/mol. In another embodiment the second polyethylene has a weight average molecular weight, M_{w} of from 5,000 to 75,000 g/mol, including any narrower ranges within this range and any values encompassed by these ranges. For example, in embodiments of the disclosure, the second polyethylene has a weight average molecular weight, M_{w} of from 10,000 to 75,000 g/mol, or from 15,000 to 75,000 g/mol, or from 15,000 to 65,000 g/mol, or from 15,000 to 60,000 g/mol, or from 15,000 to 50,000 g/mol, or from 20,000 to 60,000 g/mol, or from 20,000 to 55,000 g/mol, or from 20,000 to 50,000 g/mol, or from 20,000 to 45,000 g/mol or from 20,000 to 40,000 g/mol.

In embodiments of the disclosure, the second polyethylene has a molecular weight distribution, M_{w}/Mₙ of ≥2.1, or >2.1, or ≥2.2, or >2.2, or ≥2.3, or >2.3, or ≥2.5, or >2.5, or ≥2.7, or >2.7, or ≥2.9, or >2.9, or ≥3.0, or 3.0. In embodiments of the disclosure, the second ethylene copolymer has a molecular weight distribution, M_{w}/Mₙ of from 2.3 to 6.0, or from 2.3 to 5.5, or from 2.3 to 5.0, or from 2.3 to 4.5, or from 2.3 to 4.0, or from 2.3 to 3.5, or from 2.3 to 3.0, or from 2.5 to 5.0, or from 2.5 to 4.5, or from 2.5 to 4.0, or from 2.5 to 3.5, or from 2.7 to 5.0, or from 2.7 to 4.5, or from 2.7 to 4.0, or from 2.7 to 3.5, or from 2.1 to 3.5, or from 2.2 to 3.5.

In embodiments of the disclosure, the second ethylene copolymer has no long chain branching present or does not have any detectable levels of long chain branching.

In embodiments of the disclosure, the weight percent (wt %) of the second polyethylene in the polyethylene composition (i.e. the weight percent of the second polyethylene based on the total weight of the first polyethylene, the second polyethylene and the optionally present third polyethylene) may be from about 95 wt % to about 20 wt %, including any narrower ranges within this range and any values encompassed by these ranges. For example, in embodiments of the disclosure, the weight percent (wt %) of the second polyethylene in the polyethylene composition may be from about 95 wt % to about 25 wt %, or from about 95 wt % to about 35 wt %, or from about 80 wt % to about 20 wt %, or from about 80 wt % to about 25 wt %, or from about 75 wt % to about 25 wt % or from about 70 wt % to about 30 wt %, or from about 90 wt % to about 40 wt %, or from about 90 to 50 wt %, or from about 90 to 55 wt %, or from about 90 to 60 wt %, or from about 80 to 50 wt %, or from about 85 to 50 wt %, or from about 85 to 60 wt %, or from about 80 to 60 wt %, or from about 80 to 65 wt %.

### The Optional Third Polyethylene Made in an Optional Third Polymerization Reactor

The third polyethylene is produced in the presence of single site catalyst or a Ziegler-Natta catalyst, and in an embodiment, and with regard to FIG. 2, is produced in a downstream reactor, reactor 3, R3. Referring to the embodiment shown in FIG. 2, if the optional α-olefin is not added to reactor 3 (R3), then the third polyethylene produced in R3 will be an ethylene homopolymer if there are no substantial amounts of unreacted α-olefin present in the second effluent stream coming from the second reactor, R2. If an α-olefin is added directly to the third reactor or is present in the second effluent stream, then the third polyethylene produced in R3 will be an ethylene copolymer.

In embodiments of the disclosure, alpha-olefins which may be copolymerized with ethylene to make the third polyethylene may be selected from the group comprising 1-propene, 1-butene, 1-pentene, 1-hexene and 1-octene and mixtures thereof.

In an embodiment of the disclosure, the third polyethylene is an ethylene/1-octene copolymer.

In embodiments and with reference to FIG. 2, if optional a-olefin is added directly to the third reactor, either by a fresh a-olefin stream and/or carried over from the second reactor effluent stream 2′, then the third polyethylene formed in third reactor is an ethylene copolymer and the following weight ratio determines the density of the third polyethylene:((a-olefin)/(ethylene))^{R3}. The upper limit on ((a-olefin)/(ethylene))^{R3} may be about 3; in other cases about 2 and in still other cases about 1. The lower limit on ((a-olefin)/(ethylene))^{R3} may be 0; in other cases about 0.25 and in still other cases about 0.5. Hereafter, the term “d3” refers to the density of the third polyethylene produced in R³.

In embodiments, the upper limit on d3 may be about 0.975 g/cm³, or about 0.965 g/cm³, or about 0.955 g/cm³, while the lower limit on d3 may be about 0.865 g/cm³, or about 0.875 g/cm³, or about 0.88 g/cm³, or about 0.89 g/cm³, or about 0.90 g/cm³, or about 0.91 g/cm³.

In embodiments of the disclosure the density of the third polyethylene, d3 may be from about 0.875 g/cm³ to about 0.965 g/cm³, or from about 0.875 g/cm³ to about 0.960 g/cm³, or from about 0.875 g/cm³ to about 0.955 g/cm³, or from about 0.875 g/cm³ to about 0.950 g/cm³, or from about 0.88 g/cm³ to about 0.945 g/cm³, or from about 0.89 g/cm³ to about 0.941 g/cm³, or from about 0.89 g/cm³ to about 0.940 g/cm³, or from about 0.89 g/cm³ to about 0.936 g/cm³, or from about 0.875 g/cm³ to about 0.936 g/cm³, or from about 0.880 g/cm³ to about 0.936 g/cm³, or from about 0.880 g/cm³ to about 0.935 g/cm³, or from about 0.880 g/cm³ to about 0.932 g/cm³, or from about 0.88 g/cm³ to about 0.930 g/cm³, or from about 0.875 g/cm³ to about 0.925 g/cm³, or from about 0.89 g/cm³ to about 0.926 g/cm³.

In embodiments, the upper limit on the M_{w}/Mₙ of the third polyethylene may be about 8.0, or about 7.0, or about 6.5, or about 6.0, or about 5.5, or about 5.0, or about 4.8, while the lower limit on the M_{w}/Mₙ of the third polyethylene may be about 4.0, or about 3.5, or about 3.0, or about 2.6, or about 2.5, or about 2.2, or about 2.0, or about 1.8.

In an embodiment of the disclosure, the M_{w}/Mₙ of the third polyethylene may be from about 2.2 to about 7.0, or from about 2.4 to about 6.5, or from about 2.6 to about 6.0, or from about 2.8 to about 5.5, or from about 3.0 to about 6.0, or from about 3.0 to about 5.5.

The amount of hydrogen added to the third reactor (e.g. R³) can vary over a wide range allowing the continuous solution process to produce third polyethylenes that differ greatly in melt index, hereafter 123 (melt index is measured at 190° C. using a 2.16 kg load following the procedures outlined in ASTM D1238). In embodiments, and with reference to FIG. 2, this may be accomplished by adjusting the hydrogen flow rate to the third reactor. The amount of optional hydrogen added to R3 ranges from about 50 ppm to 0 ppm, in some cases from about 25 ppm to 0 ppm, in other cases from about 10 to 0 and in still other cases from about 2 ppm to 0 ppm. In embodiments, the upper limit on I₂³ may be about 2,000 dg/min, or about 1,500 dg/min, or about 1,000 dg/min, or about 500 dg/min, while the lower limit on I₂³ may be about 0.5 dg/min, or about 0.6 dg/min, or about 0.7 dg/min, or about 0.8 dg/min.

In embodiments of the disclosure the melt index of the third polyethylene I₂³ may be from about 0.01 dg/min to about 10,000 dg/min or from about 0.05 dg/min to about 10,000 dg/min, or from about 0.10 to about 10,000, or from about 0.5 dg/min to about 10,000 dg/min, or from about 1.0 dg/min to about 10,000 dg/min, or from about 0.1 dg/min to about 5,000 dg/min, or from about 0.5 dg/min to about 5,000 dg/min, or from about 0.01 dg/min to about 1,000 dg/min, or from about 0.05 to 1,000 dg/min, or from about 0.10 dg/min to about 1,000 dg/min, or from about 0.5 dg/min to about 1,000 dg/min, or from about 1.0 dg/min to about 1,000 dg/min, or from about 0.01 dg/min to about 500 dg/min, or from about 0.05 dg/min to about 500 dg/min, or from about 0.10 dg/min to about 500 dg/min, or from about 0.1 dg/min to about 250 dg/min, or from about 0.5 dg/min to about 250 dg/min, or from about 1.0 dg/min to about 250 dg/min, or from about 0.01 dg/min to about 200 dg/min, or from about 0.05 dg/min to about 200 dg/min, or from about 0.1 dg/min to about 200 dg/min, or from about 0.01 dg/min to about 100 dg/min, or from about 0.05 dg/min to about 100 dg/min, or from about 0.10 dg/min to 100 dg/min, or from about 0.01 dg/min to about 50 dg/min, or from about 0.05 dg/min to about 50 dg/min, or from about 0.10 dg/min to about 50 dg/min, or from about 0.01 dg/min to about 25 dg/min, or from about 0.05 dg/min to about 25 dg/min, or from about 0.10 dg/min to about 25 dg/min, or from 0.01 dg/min to about 10 dg/min, or from 0.50 dg/min to about 10 dg/min, or from 0.10 dg/min to about 10 dg/min, or from about 0.01 dg/min to about 5.0 dg/min, or from about 0.1 dg/min to about 5 dg/min, or from about 0.01 dg/min to about 3 dg/min, or from about 0.1 dg/min to about 3 dg/min.

In embodiments of the disclosure, the third polyethylene has a weight average molecular weight, M_{w} of from about 10,000 to about 400,000 g/mol, or from about 10,000 to about 300,000 g/mol, or from about 10,000 to about 250,000 g/mol, or from about 15,000 to about 225,000 g/mol, or from about 15,000 to about 200,000 g/mol; or from about 10,000 to about 175,000 g/mol, or from about 10,000 to about 150,000 g/mol.

In embodiments, the upper limit on the weight percent (wt %) of the optional third ethylene polymer in the polyethylene composition (i.e. the weight percent of the third polyethylene based on the total weight of the first polyethylene, the second polyethylene and the optionally present third polyethylene) may be about 45 wt %, in other cases about 40 wt %, in other cases about 35 wt %, and in still other cases about 30 wt %, while the lower limit on the wt % of the optional third ethylene polymer in the polyethylene composition may be about 1 wt %; in other cases about 5 wt %, in other cases about 10 wt %, in other cases about 15 wt %, in other cases about 20 wt %, and in still other cases about 25 wt %.

### The (Final) Polyethylene Composition

The polyethylene composition made by the process of the present disclosure comprises a first polyethylene, a second polyethylene and optionally a third polyethylene (as described above). Despite this fact, in an embodiment of the disclosure, the polyethylene composition has a unimodal profile in a gel permeation chromatography (GPC) curve generated according to the method of ASTM D6474-99. The term “unimodal” is herein defined to mean there will be only one significant peak or maximum evident in the GPC-curve. A unimodal profile includes a broad unimodal profile. In contrast, the use of the term “bimodal” is meant to convey that in addition to a first peak, there will be a secondary peak or shoulder which represents a higher or lower molecular weight component (i.e. the molecular weight distribution, can be said to have two maxima in a molecular weight distribution curve). Alternatively, the term “bimodal” connotes the presence of two maxima in a molecular weight distribution curve generated according to the method of ASTM D6474-99. The term “multi-modal” denotes the presence of two or more, typically more than two, maxima in a molecular weight distribution curve generated according to the method of ASTM D6474-99.

In embodiments of the disclosure, the upper limit on the density of the polyethylene composition may be about 0.975 g/cm³, or about 0.965 g/cm³, or about 0.955 g/cm³, while the lower limit on the density of the polyethylene composition may be about 0.869 g/cm³, or 0.879 g/cm³, or about 0.889 g/cm³.

In embodiments of the disclosure, the density of the polyethylene composition may be from about 0.879 g/cm³ to about 0.940 g/cm³, or from about 0.879 g/cm³ to about 0.939 g/cm³, or from about 0.879 g/cm³ to about 0.936 g/cm³, or from about 0.890 g/cm³ to about 0.939 g/cm³, or from about 0.890 to about 0.936 g/cm³, or from about 0.879 g/cm³ to about 0.932 g/cm³, or from about 0.89 g/cm³ to about 0.934 g/cm³, or from about 0.890 g/cm³ to about 0.932 g/cm³, or from about 0.890 g/cm³ to about 0.930 g/cm³, or from about 0.890 to about 0.928 g/cm³, or from about 0.890 to about 0.926 g/cm³, or from about 0.890 g/cm³ to about 0.924 g/cm³, or from about 0.890 g/cm³ to about 0.921 g/cm³, or from about 0.890 g/cm³ to about 0.918 g/cm³.

In embodiments of the disclosure, the density of the polyethylene composition may be from about from about 0.890 g/cm³ to about 0.936 g/cm³, or about 0.890 g/cm³ to about 0.932 g/cm³, or about 0.890 g/cm³ to about 0.930 g/cm³, or about 0.900 g/cm³ to about 0.936 g/cm³, or about 0.900 g/cm³ to about 0.932 g/cm³, or about 0.910 g/cm³ to about 0.936 g/cm³, or about 0.910 g/cm³ to about 0.932 g/cm³, or about 0.910 g/cm³ to about 0.930 g/cm³.

In embodiments of the disclosure, the polyethylene composition has a density of from 0.941 to 0.975 g/cm³, including any narrower ranges within this range and any values encompassed by these ranges. For example, in embodiments of the disclosure, the polyethylene composition has a density of from 0.942 to 0.970 g/cm³, or from 0.942 to 0.965 g/cm³, or from 0.942 to 0.960 g/cm³, or from 0.942 to 0.955 g/cm³, or from 0.942 to 0.950 g/cm³, or from 0.942 to 0.949 g/cm³, or from 0.942 to 0.948 g/cm³, or from 0.943 to 0.955 g/cm³, or from 0.943 to 0.950 g/cm³, or from 0.943 to 0.949 g/cm³, or from 0.943 to 0.948 g/cm³.

In an embodiments of the disclosure, the density of the polyethylene composition may be less than about 0.941 g/cm³, or less than about 0.940 g/cm³, or less than about 0.939 g/cm³, or ≤about 0.939 g/cm³.

In embodiments of the disclosure, the polyethylene composition has a density of ≥0.942 g/cm³, or >0.942 g/cm³, ≥0.943 g/cm³, or >0.9443 g/cm³.

In embodiments, the upper limit on the M_{w}/Mₙ of the polyethylene composition may be about 25, or about 15, or about 9, while the lower limit on the M_{w}/Mₙ of the polyethylene composition may be about 2.0, or about 2.1, or about 2.2.

In embodiments of the disclosure the polyethylene composition, may have a M_{w}/Mₙ of from about 2.0 to about 5.0, or from about 2.0 to about 4.5, or from about 2.1 to about 4.5, or from about 2.0 to about 4.0, or from about 2.1 to about 4.0, or from about 2.0 to about 3.5.

In an embodiment of the disclosure the polyethylene composition, may have a M_{z}/M_{w} of less than about 4.0, or less than about 3.5, or less than about 3.0.

In an embodiment of the disclosure, the polyethylene composition has a stress exponent of less than 1.50, or less than 1.45, wherein the stress exponent is defined by the following relationship: S.Ex.=log (I₆/I₂)/log (6480/2160); wherein I₆ and I₂ are the melt indexes measured at 190° C. using 6.48 kg and 2.16 kg loads respectively.

In embodiments, the upper limit on melt index I₂ of the polyethylene composition may be about 500 dg/min, or about 400 dg/min, or about 300 dg/min, or about 200 dg/min, while the lower limit on the melt index I₂ of the polyethylene composition may be about 0.1 dg/min, or 0.2 dg/min, or 0.3 dg/min, or about 0.4 dg/min, or about 0.5 dg/min, or about 0.6 dg/min.

In embodiments of the present disclosure, the polyethylene composition may have a melt index I₂ of from about 0.05 dg/min to about 500 dg/min, or from about 0.1 dg/min to about 400 dg/min, or from 0.1 dg/min to about 300 dg/min, or from about 0.1 dg/min to about 200 dg/min, or from about 0.1 dg/min to about 100 dg/min, or from 0.1 dg/min to about 50 dg/min, or from about 0.1 dg/min to about 25 dg/min, or from about 0.1 dg/min to about 20 dg/min, or from about 0.1 dg/min to about 15 dg/min, or from about 0.1 dg/min to about 10 dg/min, or from about 0.1 dg/min to about 5.0 dg/min, or from about 0.1 dg/min to about 3.0 dg/min.

In an embodiment of the disclosure the polyethylene composition may have a unimodal profile in a gel permeation chromatograph.

In embodiments of the disclosure the polyethylene composition may have a bimodal or a multimodal profile in a gel permeation chromatograph.

In an embodiment of the disclosure the polyethylene composition may have a multimodal TREF profile in a temperature rising elution fractionation graph. In the context of TREF analysis, the term “multimodal” connotes a TREF profile in which two or more distinct elution peaks are observable.

In an embodiment of the disclosure the polyethylene composition may have a trimodal TREF profile in a temperature rising elution fractionation graph. In the context of TREF analysis, the term “trimodal” connotes a TREF profile in which three distinct elution peaks are observable.

In an embodiment of the disclosure the polyethylene composition may have a multimodal profile in a differential scanning calorimetry (DSC) graph. In the context of DSC analysis, the term “multimodal” connotes a DSC profile in which two or more distinct peaks are observable.

In an embodiment of the disclosure the polyethylene composition may have a trimodal profile in a differential scanning calorimetry (DSC) graph. In the context of DSC analysis, the term “trimodal” connotes a DSC profile in which three distinct peaks are observable.

In an embodiment of the disclosure, the polyethylene composition has a “reversed”) or “partially reversed” comonomer distribution profile as measured using GPC-FTIR. If the comonomer incorporation decreases with molecular weight, as measured using GPC-FTIR, the distribution is described as “normal”. If the comonomer incorporation is approximately constant with molecular weight, as measured using GPC-FTIR, the comonomer distribution is described as “flat” or “uniform”. The terms “reversed comonomer distribution” and “partially reversed comonomer distribution” mean that in the GPC-FTIR data obtained for the polyethylene composition, there is one or more higher molecular weight components having a higher comonomer incorporation than in one or more lower molecular weight components. The term “reversed comonomer distribution” is used herein to mean, that across the molecular weight range of the polyethylene composition, comonomer contents for the various polymer fractions are not substantially uniform and the higher molecular weight fractions thereof have proportionally higher comonomer contents (i.e. if the comonomer incorporation rises with molecular weight, the distribution is described as “reverse” or “reversed”). Where the comonomer incorporation rises with increasing molecular weight and then declines, the comonomer distribution is still considered “reversed”, but may also be described as “partially reversed”.

In an embodiment of the disclosure the polyethylene composition has a reversed comonomer distribution profile as measured using GPC-FTIR.

In an embodiment of the disclosure the polyethylene composition has a partially reverse comonomer distribution profile as measured using GPC-FTIR.

In an embodiment of the disclosure the polyethylene composition has a “partially reversed” comonomer distribution profile and shows a peak or a maximum in the comonomer distribution profile as measured using GPC-FTIR.

It is known in the art of polyethylene polymers that the parameter “flow activation energy” or Ea, may be used as an indicative of the presence of long chain branching in the polyethylene polymers. Generally speaking, Ea values of about 30 kJ/mol or higher may be consistent with the presence of long chain branching, especially if the polyethylene otherwise has a relatively narrow molecular weight distribution, of about 3.0 or less. The use of flow activation energy, Ea (also simply, the “activation energy”) to characterize the thermorheological behavior of polymers, such as polyethylene is described by Laun, H. M. in Prog. Colloid Polym. Sci. 1987, 75, 111-139; Gabriel, C. et. al. in Rheol. Acta 1998, 37, 7-20; or by Wood-Adams, P. et al in Macromolecules 2001, 34, 6281-6290.

In embodiments of the disclosure, the polyethylene composition has a flow activation energy of about 30 kJ/mol, or greater than 30 kJ/mol, or greater than about 35 kJ/mol.

In embodiments of the disclosure, the polyethylene composition has a flow activation energy of from about 30 kJ/mol to about 60 kJ/mol, or from about 35 kJ/mol to about 60 kJ/mol, or from about 30 kJ/mol to about 55 kJ/mol, or from about 35 kJ/mol to about 55 kJ/mol.

In embodiments of the disclosure, the polyethylene composition has a flow activation energy of from 30 kJ/mol to 80 kJ/mol, or from greater than 30 kJ/mol to less than 80 kJ/mol, or from greater than 30 kJ/mol to less than 60 kJ/mol.

In embodiments of the disclosure, the polyethylene composition has a flow activation energy of from about 30 kJ/mol to about 60 kJ/mol and a M_{w}/Mₙ of from about 2.2 to about 4.0, or from about 35 kJ/mol to about 60 kJ/mol and a M_{w}/Mₙ of from about 2.2 to about 4.0, or from about 30 kJ/mol to about 55 kJ/mol and a M_{w}/Mₙ of from about 2.2 to about 4.0, or from about 35 kJ/mol to about 55 kJ/mol and a M_{w}/Mₙ of from about 2.2 to about 4.0.

In embodiments of the disclosure, the polyethylene composition has a flow activation energy of from greater than 30 kJ/mol to less than 80 kJ/mol and a M_{w}/Mₙ of from about 2.0 to about 5.0, or from about 2.0 to about 4.0.

In embodiments of the disclosure, the polyethylene composition has a flow activation energy of from greater than 30 kJ/mol to less than 60 kJ/mol and a M_{w}/Mₙ of from about 2.0 to about 5.0, or from about 2.0 to about 4.0.

In an embodiment of the disclosure, the polyethylene composition contains long chain branching characterized by the long chain branching factor, LCBF disclosed herein. In embodiments of the disclosure, the upper limit on the LCBF of the polyethylene composition may be 0.3000 (dimensionless). In embodiments of the disclosure, the lower limit on the LCBF of the polyethylene composition may be 0.0010, or 0.0020, or 0.0030 (dimensionless).

In embodiments of the disclosure, the LCBF of the polyethylene composition is at least 0.0010, or at least 0.0020, or at least 0.0030, or at least 0.0040, or at least 0.0050, or at least 0.0060. In embodiments of the disclosure, the LCBF of the polyethylene composition is >0.0010, or >0.0020, or >0.0030, or >0.0040, or >0.0050.

In embodiments of the disclosure, the LCBF of polyethylene composition is from 0.0010 to 0.0090, or from 0.0010 to 0.0080 or from 0.0010 to 0.0070, or from 0.0010 to 0.0060, or from 0.0010 to 0.0050.

The following examples are presented for the purpose of illustrating selected embodiments of this disclosure; it being understood, that the examples presented do not limit the claims presented.

### EXAMPLES

Prior to testing, each specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Polyethylene composition densities were determined using ASTM D792-13 (Nov. 1, 2013).

### Melt Index

The polyethylene composition melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. Herein, the term “stress exponent” or its acronym “S.Ex.”, is defined by the following relationship:

S.Ex.=log (I₆/I₂)/log (6480/2160) wherein 16 and 12 are the melt flow rates measured at 190° C. using 6.48 kg and 2.16 kg loads, respectively. In this disclosure, melt index was expressed using the units of g/10 minutes or g/10 min or dg/minutes or dg/min; these units are equivalent.

### Gel Permeation Chromatography (GPC)

Polyethylene composition molecular weights, Mₙ, M_{w} and Mz (in g/mol) as well the as the polydispersity (M_{w}/Mₙ), were determined using ASTM D6474-12 (Dec. 15, 2012). Polymer sample solutions (1 to 2 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° C. on a PL 220 high-temperature chromatography unit equipped with four SHODEX® columns (HT803, HT804, HT805 and HT806) using TCB as the mobile phase with a flow rate of 1.0 mL/minute, with a differential refractive index (DRI) as the concentration detector. BHT was added to the mobile phase at a concentration of 250 ppm to protect GPC columns from oxidative degradation. The sample injection volume was 200 μL. The GPC raw data were processed with the CIRRUS® GPC software. The GPC columns were calibrated with narrow distribution polystyrene standards. The polystyrene molecular weights were converted to polyethylene molecular weights using the Mark-Houwink equation, as described in ASTM D6474-12 (Dec. 15, 2012).

### GPC-FTIR

Polyethylene composition (polymer) solutions (2 to 4 mg/mL) were prepared by heating the polymer in 1,2,4-trichlorobenzene (TCB) and rotating on a wheel for 4 hours at 150° C. in an oven. The antioxidant 2,6-di-tert-butyl-4-methylphenol (BHT) was added to the mixture in order to stabilize the polymer against oxidative degradation. The BHT concentration was 250 ppm. Sample solutions were chromatographed at 140° on a Waters GPC 150C chromatography unit equipped with four SHODEX columns (HT803, HT804, HT805 and HT806) using TCB as the mobile phase with a flow rate of 1.0 mL/minute, with a FTIR spectrometer and a heated FTIR flow through cell coupled with the chromatography unit through a heated transfer line as the detection system. BHT was added to the mobile phase at a concentration of 250 ppm to protect SEC columns from oxidative degradation. The sample injection volume was 300 μL. The raw FTIR spectra were processed with OPUS FTIR software and the polymer concentration and methyl content were calculated in real time with the Chemometric Software (PLS technique) associated with the OPUS. Then the polymer concentration and methyl content were acquired and baseline-corrected with the CIRRUS GPC software. The SEC columns were calibrated with narrow distribution polystyrene standards. The polystyrene molecular weights were converted to polyethylene molecular weights using the Mark-Houwink equation, as described in the ASTM standard test method D6474. The comonomer content was calculated based on the polymer concentration and methyl content predicted by the PLS technique as described in Paul J. DesLauriers, Polymer 43, pages 159-170 (2002); herein incorporated by reference.

The GPC-FTIR method measures total methyl content, which includes the methyl groups located at the ends of each macromolecular chain, i.e. methyl end groups. Thus, the raw GPC-FTIR data must be corrected by subtracting the contribution from methyl end groups. To be more clear, the raw GPC-FTIR data overestimates the amount of short chain branching (SCB) and this overestimation increases as molecular weight (M) decreases. In this disclosure, raw GPC-FTIR data was corrected using the 2-methyl correction. At a given molecular weight (M), the number of methyl end groups (N_{E}) was calculated using the following equation; N_{E}=28000/M, and N_{E} (M dependent) was subtracted from the raw GPC-FTIR data to produce the SCB/1000C (2-Methyl Corrected) GPC-FTIR data.

### Unsaturation Content

The quantity of unsaturated groups, i.e., double bonds, in a polyethylene composition was determined according to ASTM D3124-98 (vinylidene unsaturation, published March 2011) and ASTM D6248-98 (vinyl and trans unsaturation, published July 2012). A polymer sample was: a) first subjected to a carbon disulfide extraction to remove additives that may interfere with the analysis; b) the sample (pellet, film or granular form) was pressed into a plaque of uniform thickness (0.5 mm); and c) the plaque was analyzed by FTIR.

### Composition Distribution Branching Index (CDBI) by CTREF

The “Composition Distribution Branching Index” or “CDBI” of the disclosed Examples and Comparative Examples were determined using a crystal-TREF unit (a “CTREF” unit) commercially available form Polymer Char (Valencia, Spain). The acronym “TREF” refers to Temperature Rising Elution Fractionation. A sample of polyethylene composition (80 to 100 mg) was placed in the reactor of the Polymer Char crystal-TREF unit, the reactor was filled with 35 ml of 1,2,4-trichlorobenzene (TCB), heated to 150° C. and held at this temperature for 2 hours to dissolve the sample. An aliquot of the TCB solution (1.5 mL) was then loaded into the Polymer Char TREF column filled with stainless steel beads and the column was equilibrated for 45 minutes at 110° C. The polyethylene composition was then crystallized from the TCB solution, in the TREF column, by slowly cooling the column from 110° C. to 30° C. using a cooling rate of 0.09° C. per minute. The TREF column was then equilibrated at 30° C. for 30 minutes. The crystallized polyethylene composition was then eluted from the TREF column by passing pure TCB solvent through the column at a flow rate of 0.75 mL/minute as the temperature of the column was slowly increased from 30° C. to 120° C. using a heating rate of 0.25° C. per minute. Using Polymer Char software, a TREF distribution curve was generated as the polyethylene composition was eluted from the TREF column, i.e., a TREF distribution curve is a plot of the quantity (or intensity) of polymeric material eluting from the column as a function of TREF elution temperature. A CDBI₅₀ was calculated from the TREF distribution curve for each polyethylene composition analyzed. The “CDBI₅₀” is defined as the percent of polymer whose composition is within 50% of the median comonomer composition (25% on each side of the median comonomer composition); this definition is consistent with that described in WO 93/03093 assigned to Exxon Chemical Patents Inc.; it is calculated from the TREF composition distribution curve and the normalized cumulative integral of the TREF composition distribution curve. Those skilled in the art will understand that a calibration curve is required to convert a TREF elution temperature to comonomer content, i.e., the amount of comonomer in the polyethylene composition fraction that elutes at a specific temperature. The generation of such calibration curves are described in the prior art, e.g., Wild, et al., J. Polym. Sci., Part B, Polym. Phys., Vol. 20 (3), pages 441-455.

Differential Scanning calorimetry (DSC)

Primary melting peak (° C.), melting peak temperatures (C), heat of fusion (J/g) and crystallinity (%) was determined using differential scanning calorimetry (DSC) as follows: the instrument was first calibrated with indium; after the calibration, a polymer specimen is equilibrated at 0° C. and then the temperature was increased to 200° C. at a heating rate of 10° C./min; the melt was then kept isothermally at 200° C. for five minutes; the melt was then cooled to 0° C. at a cooling rate of 10° C./min and kept at 0° C. for five minutes; the specimen was then heated to 200° C. at a heating rate of 10° C./min. The DSC Tm, heat of fusion and crystallinity are reported from the 2^{nd} heating cycle.

### Dynamic Mechanical Analysis (DMA)

Oscillatory shear measurements under small strain amplitudes were carried out to obtain linear viscoelastic functions at 190° C. under N₂ atmosphere, at a strain amplitude of 10% and over a frequency range of 0.02-126 rad/s at 5 points per decade. Frequency sweep experiments were performed with a TA Instruments DHR3 stress-controlled rheometer using cone-plate geometry with a cone angle of 5°, a truncation of 137 μm and a diameter of 25 mm. In this experiment a sinusoidal strain wave was applied and the stress response was analyzed in terms of linear viscoelastic functions. The zero shear rate viscosity (h₀) based on the DMA frequency sweep results was predicted by Ellis model (see R. B. Bird et al. “Dynamics of Polymer Liquids. Volume 1: Fluid Mechanics” Wiley-Interscience Publications (1987) p.228) or Carreau-Yasuda model (see K. Yasuda (1979) PhD

Thesis, IT Cambridge). The dynamic rheological data were analyzed using the rheometer software (viz., Rheometrics RHIOS V4.4 or Orchestrator Software) to determine the melt elastic modulus G′ (G″=500) at a reference melt viscous modulus (G″) value of G″=500 Pa. If necessary, the values were obtained by interpolation between the available data points using the Rheometrics software. The term “Storage modulus”, G′ (co), also known as “elastic modulus”, which is a function of the applied oscillating frequency, co, is defined as the stress in phase with the strain in a sinusoidal deformation divided by the strain; while the term “Viscous modulus”, G″(ω), also known as “loss modulus”, which is also a function of the applied oscillating frequency, w, is defined as the stress 90 degrees out of phase with the strain divided by the strain. Both these moduli, and the others linear viscoelastic, dynamic rheological parameters, are well known within the skill in the art, for example, as discussed by G. Marin in “Oscillatory Rheometry”, Chapter 10 of the book on Rheological Measurement, edited by A. A. Collyer and D. W. Clegg, Elsevier, 1988.

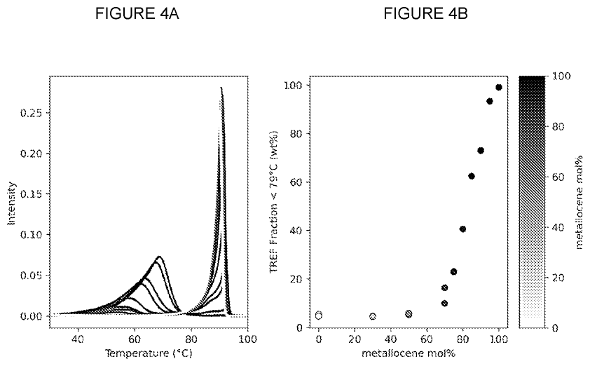

A convenient method for assessing the melt rheology of a polyethylene composition may be based on a small amplitude frequency sweep test. The resulting rheology results are expressed as the phase angle d (in degrees) as a function of complex modulus G⁺ (in Pascals) and are referred to as van Gurp-Palmen plots (as described in M. Van Gurp, J. Palmen, Rheol. Bull. (1998) 67(1): 5-8; and Dealy J, Plazek D. Rheol. Bull. (2009) 78 (2): 16-31) as known to persons skilled in the art. For a typical polyethylene, the phase angle d increases toward its upper bound of 90° with G* becoming sufficiently low. A typical VGP plot is shown in FIG. 4 of U.S. Pat. Appl. No. 2018/0298170 which is incorporated herein in its entirety. The VGP plots are a signature of resin architecture. The rise of d toward 90° is monotonic for an ideally linear, monodisperse polyethylene. The d (G*) for a branched polyethylene or a blend containing a branched polyethylene may show an inflection point that reflects the topology of the branched polyethylene (see S. Trinkle, P. Walter, C. Friedrich, Rheo. Acta (2002) 41:103-113). The deviation of the phase angle d from the monotonic rise may indicate a deviation from the ideal linear polyethylene either due to presence of long chain branching or a blend containing at least two ethylene copolymers having dissimilar branching structure.

In this disclosure, the LCBF (Long Chain Branching Factor) was determined using the DMA determined h₀ (see U.S. Pat. No. 10,442,921).

### Vicat Softening Point (Temperature)

The Vicat softening point of a polyethylene composition was determined according to ASTM D1525-07 (published December 2009). This test determines the temperature at which a specified needle penetration occurs when samples are subjected to ASTM D1525-07 test conditions, i.e., heating Rate B (120±10° C./hour and 938 gram load (10±0.2N load).

### Flow Activation Energy

The Flow Activation Energy, Ea of a polyethylene composition, has dimensions of kJ/mol and was determined using the melt rheology data generated by an Anton Paar MCR501 rotational rheometer; specifically, the melt-state complex viscosity versus angular frequency in a linear regime (from 0.05 to 100 rad/s at 7 data points per decade at a strain-amplitude of 5% at four different temperatures (160, 175, 190 and 205° C.)) were measured. Using 190° C. as the reference temperature, a tTS (time-temperature superposition) shift was carried out to obtain the horizontal and vertical shift factors. The Ea, of each polymer sample was calculated using tTS shifting of the complex viscosity curves and fitting the Arrhenius equation of the horizontal shift factors, aTs, of each temperature with RheoCompass software according to an aT(T)~exp (Ea/RT) relationship.

### Long Chain Branching Factor (LCBF)

The LCBF (dimensionless) was determined for the polyethylene composition using the method described in U.S. Pat. No. 10,442,921 which is incorporated herein by reference.

The long chain branching factor (the “LCBF”) calculation requires the polydispersity corrected Zero Shear Viscosity (ZSV_{c}) and the short chain branching (the “SCB”) corrected Intrinsic Viscosity (IV_{c}) as fully described in the following paragraphs.

The correction to the Zero Shear Viscosity, ZSV_{c}, having dimensions of poise, was performed as shown in equation Eq. (1):

$${ZSV}_{c} = \frac{1.8389 \times {h}_{0}}{{2.411}^{Ln ( Pd )}} \qquad Eq . ( 1 )$$

where η₀, the zero shear viscosity (poise), was measured by DMA as described above; Pd was the dimensionless polydispersity (M_{w}/Mₙ) as measured using conventional GPC as described above and 1.8389 and 2.4110 are dimensionless constants.

The correction to the Intrinsic Viscosity, IV_{c}, having dimensions of dL/g, was performed as shown in equation Eq. (2):

$${IV}_{c} = [ h ] + \frac{A \times SCB \times {M}_{v}^{0.725}}{1000000} \qquad Eq . ( 2 )$$

where the intrinsic viscosity [η] (dL/g) was measured using 3D-SEC described above; the SCB has dimensions of (CH₃ #/1000C) and was determined using FTIR as described above; Mv, the viscosity average molar mass (g/mole), was determined using 3D-SEC as described above, and A was a dimensionless constant that depends on the α-olefin in the ethylene/α-olefin copolymer sample, i.e. A was 2.1626, 1.9772 or 1.1398 for 1-octene, 1-hexene and 1-butene α-olefins, respectively. In the case of an ethylene homopolymer no correction is required for the Mark-Houwink constant, i.e. SCB is zero.

“Linear” ethylene copolymers (or linear ethylene homopolymers), which do not contain LCB or contain undetectable levels of LCB, fall on the Reference Line defined by Eq. (3).

$$Log ( {IV}_{c} ) = 0.21 \times Log ( {ZSV}_{c} ) - 0.7879 \qquad Eq . ( 3 )$$

The calculation of the LCBF was based on the Horizontal-Shift (Sₕ) and Vertical-Shift (Sᵥ) from the linear reference line, as defined by the following equations:

$${S}_{h} = Log ( {ZSV}_{c} ) - 4.7619 \times Log ( {IV}_{c} ) - 3.7519 \qquad Eq . ( 4 )$$

$${S}_{v} = 0.21 \times Log ( {ZSV}_{c} ) - Log ( {IV}_{c} ) - 0.7879 . \qquad Eq . ( 5 )$$

In Eq. (4) and (5), it is required that ZSV_{c} and IV_{c} have dimensions of poise and dL/g, respectively. The Horizontal-Shift (Sn) was a shift in ZSV_{c} at constant Intrinsic Viscosity (IV_{c}), if one removes the Log function its physical meaning is apparent, i.e. a ratio of two Zero Shear Viscosities, the ZSV_{c} of the sample under test relative to the ZSV_{c} of a linear ethylene copolymer (or a linear ethylene homopolymer) having the same IV_{c}. The Horizontal-Shift (Sₕ) was dimensionless. The Vertical-Shift (Sᵥ) was a shift in IV_{c} at constant Zero Shear Viscosity (ZSV_{c}), if one removes the Log function its physical meaning is apparent, i.e. a ratio of two Intrinsic Viscosities, the IV_{c} of a linear ethylene copolymer (or a linear ethylene homopolymer) having the same ZSV_{c} relative to the IV_{c} of the sample under test. The Vertical-Shift (Sᵥ) was dimensionless.

The dimensionless Long Chain Branching Factor (LCBF) was defined by Eq. (6):

$$LCBF = \frac{{S}_{h} \times {S}_{v}}{2} \qquad Eq . ( 6 )$$

In an embodiment of the disclosure, ethylene polymers (e.g. polyethylene compositions) having LCB are characterized as having a LCBF≥0.0010 (dimensionless); in contrast, ethylene polymers having no LCB (or undetectable LCB) are characterized by a LCBF of less than 0.0010 (dimensionless).

### Solution Phase Polymerization: Continuous Ethylene/1-Octene Copolymerization

A continuous solution phase polymerizations unit (CPU) was used to assess the use of two different single site catalysts in a single continuous solution phase polymerization reactor. Specifically, different amounts of a metallocene catalyst and a phosphinimine catalyst, having the structures A and B respectively, were fed to a CPU along with catalyst activator components and a hindered phenol.

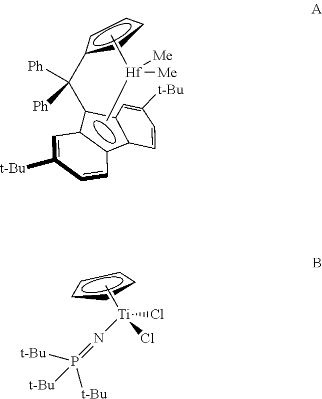

The continuous solution phase polymerizations were conducted in a continuously stirred, 71.5 mL reactor unit using cyclohexane as the process solvent. The reactor was operated at 165° C. An upstream mixing reactor having a 20 mL volume was operated at 5° C. lower than the polymerization reactor. The mixing reactor was used to pre-heat the ethylene, 1-octene and make-up solvent streams. Catalyst feeds (ortho-xylene or cyclohexane solutions of the metallocene catalyst, the phosphinimine catalyst, the boron-based catalyst activator, (Ph₃C)[B(C₆F₅)₄] (“trityl borate”), an aluminum based co-catalyst (modified methylaluminoxane, “MMAO-7”), a hindered phenol (2,6-di-tert-butyl-4-ethylphenol, “BHEB”), and additional cyclohexane solvent flow were added directly to the polymerization reactor in a continuous process or combined as described below. The aluminum co-catalyst solution was either added directly to the polymerization reactor or was combined in-line with the solution of the metallocene or phopshinimine catalyst molecule prior to injection into the polymerization reactor. In cases where a hindered phenol, BHEB, was used, solutions of MMAO-7 and BHEB were combined upstream of the reactor or upstream of the mixing point with the solution of metallocene or phosphinimine catalyst molecule. The solution of boron-based catalyst activator was either added directly to the reactor or combined with a solution of metallocene or phosphinimine catalyst complex immediately before combining with the solution of aluminum co-catalyst. A total continuous flow of 27 mL/min into the polymerization reactor was maintained. The B/Total group 4 metal molar ratio was 1.2 unless otherwise stated in the table. The Al/Total group 4 metal molar ratio was 80 unless otherwise stated in the table. The BHEB/AI molar ratio was maintained at 0.3.

Ethylene/1-octene copolymers were made at a 1-octene/ethylene weight ratio of 0.30. The ethylene was fed at a rate of 3.0 g/min. The CPU system operated at a pressure of 10.5 MPa. The solvent, monomer, and comonomer streams were all purified by purification trains before being fed to the reactor. The polymerization activity, kₚ (expressed in mM⁻¹×min⁻¹), is defined as:

$${k}_{p} = ( \frac{Q}{100 - Q} ) ( \frac{1}{[ Ti ]} ) ( \frac{1}{HUT} )$$

where Q is ethylene conversion (%) (measured using an online NIR detector), [Ti] is catalyst concentration in the reactor (μM), and HUT is hold-up time in the reactor (2.6 min). Copolymer samples were collected at 90±1% ethylene conversion (Q) unless otherwise stated, dried in a vacuum oven, and then ground and homogenized prior to analysis. General copolymerization conditions are listed in Table 1.

TABLE 1
CPU Polymerization Run Conditions Using a Mixed Single Site Catalyst (Metallocene/Phosphinimine)

| | | | | | | | Metallocene |
|---|---|---|---|---|---|---|---|
| | | | | | | | mol % of |
| | | | | | Phosphinimine | Metallocene | Total SSC |
| Polymerization | FC-1/FE | Kₚ | Q | Temp. | Concentration | Concentration | Catalyst |
| Run No. | (w/w) | (mM · min⁻¹) | (%) | (° C.) | (μmol) | (μmol) | Molecules |
| A | 0.30 | 4,232 | 90.7 | 165 | 0.89 | 0.00 | 00.0 |
| B | 0.30 | 1,512 | 89.7 | 165 | 0.56 | 1.67 | 75.0 |
| C | 0.30 | 1,296 | 89.9 | 165 | 0.53 | 2.11 | 80.0 |
| D | 0.30 | 1,289 | 90.2 | 165 | 0.41 | 2.33 | 85.0 |
| E | 0.30 | 4,086 | 90.4 | 165 | 0.89 | 0.00 | 00.0 |
| F | 0.30 | 1,176 | 90.0 | 165 | 0.30 | 2.67 | 90.0 |
| G | 0.30 | 1,761 | 91.0 | 165 | 0.11 | 2.11 | 95.0 |
| H | 0.30 | 2,096 | 90.6 | 165 | 0.00 | 1.78 | 100.0 |
| I | 0.30 | 5,126 | 90.3 | 165 | 0.70 | 0.00 | 00.0 |
| J | 0.30 | 3,338 | 90.6 | 165 | 0.56 | 0.56 | 50.0 |
| K | 0.30 | 2,312 | 89.6 | 165 | 0.43 | 1.00 | 70.0 |
| L | 0.30 | 3,987 | 90.5 | 165 | 0.65 | 0.28 | 30.0 |

The GPC-FTIR analysis of the polyethylene compositions made during the CPU polymerization runs A to L are shown in FIG. 3. The TREF analysis of the polyethylene compositions made during the CPU polymerization runs A to L are shown in FIG. 4A. The corresponding weight percent of polymer material eluting in a TREF analysis at a temperature of below 79° C. is shown plotted against the mol ratio of metallocene catalyst to phosphinimine catalyst used in the reactor during polymerization runs A to L is shown FIG. 4B.

The data presented in FIGS. 3, 4A and 4B shows that feeding single site catalyst mixtures having up to about 50 mol % of the metallocene catalyst (as a mol percentage of the total single site catalyst fed to the reactor) indicated that the polyethylene product properties were being dominated by the presence of the phosphinimine catalyst in the reactor. However, as the concentration of the metallocene catalysts was increased further, beyond about 50 mol %, the product properties obtained began to indicate that significant amounts of the polyethylene product being made in the reactor was the result of the presence of both the phosphinimine catalyst and the metallocene catalyst. These results are consistent with the fact that the phosphinimine catalyst having the formula A, is a more active (in terms of Kp) ethylene polymerization catalyst than the metallocene catalyst having the formula B.

The CPU results were used to establish appropriate reactor conditions as well as single site catalyst loading conditions for use in a larger scale pilot plant polymerization process. In particular, pilot plant polymerization targeting differentiated polyethylene compositions using two different single site catalysts in a first upstream reactor and a Ziegler-Natta catalyst in a second downstream reactor, was explored in the next set of experiments in an attempt to further identify appropriate polymerization process operating parameters.

### Solution Phase Polymerization: Pilot Plant Scale

Polyethylene compositions were prepared in a pilot plant using two continuously stirred tank reactors (two “CSTRs”) configured in series with one another (reactors 1 and 2, “R1” and “R2” respectively). An “in series” dual reactor, solution phase polymerization process has been described in U.S. Pat. Appl. No. 10,442,921. Basically, in an “in-series” dual reactor system the exit or effluent stream from a first polymerization reactor (R1) flows directly into a second downstream polymerization reactor (R2). The R1 pressure was from about 14 MPa to about 18 MPa; while R2 was operated at a lower pressure to facilitate continuous flow from R1 to R2. Both R1 and R2, continuously stirred reactors, were agitated to give conditions in which the reactor contents were well mixed. The process was operated continuously by feeding fresh process solvent, ethylene, 1-octene and hydrogen to the reactors and in the removal of product. Methylpentane was used as the process solvent (a commercial blend of methylpentane isomers). The volume of the first CSTR reactor (R1) was 3.2 gallons (12 L), and the volume of the second CSTR reactor (R2) was 5.8 gallons (22 L). Monomer (ethylene) and comonomer (1-octene) were purified prior to addition to the reactor using conventional feed preparation systems (such as contact with various absorption media to remove impurities such as water, oxygen and polar contaminants). The reactor feeds were pumped to the reactors at the ratios shown in Table 2. Average residence times for the reactors are calculated by dividing average flow rates by reactor volume and is primarily influenced by the amount of solvent flowing through each reactor and the total amount of solvent flowing through the solution process.

Two different single site catalysts were fed to the first reactor (“R1”): a phopshinimine catalyst and a metallocene catalyst to make a first polyethylene and a second polyethylene within the first reactor. Accordingly, the following single site catalyst components, including activators and a hindered phenol were fed to the first reactor: cyclopentadienyl tri (tert-butyl) phosphinimine titanium dichloride, Cp ((t-Bu)₃PN)TiCl₂; diphenylmethylene(cyclopentadienyl)(2,7-di-t-butylfluorenyl)hafnium dimethide, (2,7-tBu₂Flu)Ph₂C(Cp)HfMe₂; modified methylaluminoxane (MMAO-07); trityl tetrakis(pentafluoro-phenyl)borate (“trityl borate”); and 2,6-di-tert-butyl-4-ethylphenol (“BHEB”). Methylaluminoxane (MMAO-07) and 2,6-di-tert-butyl-4-ethylphenol were premixed in-line and then combined with the two single site catalysts (Cp((t-Bu)₃PN)TiCl₂ and (2,7-tBu₂Flu)Ph₂C(Cp)HfMe₂) as well as tetrakis(pentafluoro-phenyl)borate just before entering the polymerization reactor (R1). The single site catalyst system components were dissolved in methylpentane or xylene. The quantity of the single site catalyst components added to the first reactor are shown in Table 2.

A Ziegler-Natta catalyst was fed to the second reactor (“R2”) to make the third polyethylene. The following Ziegler-Natta (ZN) catalyst components were used in the second reactor, R2: butyl ethyl magnesium; tertiary butyl chloride; titanium tetrachloride; diethyl aluminum ethoxide; and triethyl aluminum. Methylpentane was used as the catalyst component solvent and the in-line Ziegler-Natta catalyst formulation was prepared using the following steps and then injected into the second reactor (R2). In step one, a solution of triethylaluminum and butyl ethyl magnesium (Mg:Al=20, mol:mol) was combined with a solution of tertiary butyl chloride and allowed to react for about 30 seconds to produce a MgCl₂ support. In step two, a solution of titanium tetrachloride was added to the mixture formed in step one and allowed to react for about 14 seconds prior to injection into second reactor (R2). The in-line Ziegler-Natta catalyst was activated in the reactor by injecting a solution of diethyl aluminum ethoxide into R2. The quantity of titanium tetrachloride added to the reactor is shown in Table 2. The efficiency of the in-line Ziegler-Natta catalyst formulation was optimized by adjusting the mole ratios of the catalyst components (further details are provided in Table 2).

Polymerization in the continuous solution polymerization process was terminated by adding a catalyst deactivator to the second reactor exit stream. The catalyst deactivator used was octanoic acid (caprylic acid), commercially available from P&G Chemicals, Cincinnati, OH, U.S.A. The catalyst deactivator was added such that the moles of fatty acid added were 50% of the total molar amount of hafnium, titanium and aluminum added to the polymerization process; to be clear, the moles of octanoic acid added=0.5×(moles hafnium+moles titanium+moles aluminum).

A two-stage devolatilization process was employed to recover the polyethylene composition from the process solvent, i.e. two vapor/liquid separators were used and the second bottom stream (from the second V/L separator) was passed through a gear pump/pelletizer combination. DHT-4V® (hydrotalcite), supplied by Kyowa Chemical Industry Co. Ltd., Tokyo, Japan was used as a passivator, or acid scavenger, in the continuous solution process. A slurry of DHT-4V in process solvent was added prior to the first V/L separator.

Prior to pelletization the polyethylene composition was stabilized by adding about 500 ppm of IRGANOX® 1076 (a primary antioxidant) and about 500 ppm of IRGAFOS® 168 (a secondary antioxidant), based on weight of the polyethylene composition. Antioxidants were dissolved in process solvent and added between the first and second V/L separators.

Table 2 shows the reactor conditions used to make the polyethylene compositions. Table 2 includes process parameters, such as the ethylene and 1-octene splits between the reactors (R1 and R2), the reactor temperatures, the ethylene conversions, etc. The properties of a polyethylene composition produced according the polymerization runs of Examples 1-5 are provided in Table 3.

TABLE 2
Polymerization Reactor Conditions

| | 1 | | | | |
|---|---|---|---|---|---|
| Example No. | (comparative) | 2 | 3 | 4 | 5 |
| Total Solution Rate | 500.1 | 500.1 | 499.9 | 500.5 | 500.3 |
| (TSR) (kg/h) | | | | | |
| TSR R1 (kg/h) | 264.7 | 264.6 | 264.5 | 264.7 | 264.6 |
| TSR R2 (kg/h) | 235.5 | 235.5 | 235.4 | 235.7 | 235.7 |
| Ethylene Concentration | 14.7 | 14.7 | 14.7 | 14.7 | 14.7 |
| (wt % overall) | | | | | |
| 1-Octene to Ethylene | 0.638 | 0.638 | 0.638 | 0.638 | 0.638 |
| Ratio Total | | | | | |
| ES^{R1} (%), Ethylene Split | 45.0 | 45.0 | 45.0 | 45.0 | 45.0 |
| between First Reactor | | | | | |
| (R1) and Second | | | | | |
| Reactor (R2) | | | | | |
| CS^{R1} (%), 1-Octene Split | 28.91 | 28.91 | 28.91 | 28.91 | 28.91 |
| between First Reactor | | | | | |
| (R1) and Second | | | | | |
| Reactor (R2), | | | | | |
| Ethylene Fresh Feed to | 12.49 | 12.51 | 12.50 | 12.52 | 12.51 |
| R1 Concentration (wt %) | | | | | |
| 1-Octene to Ethylene | 0.41 | 0.41 | 0.41 | 0.41 | 0.41 |
| Ratio in R1 Fresh Feed | | | | | |
| (g/g) | | | | | |
| Ethylene Fresh Feed to | 17.15 | 17.18 | 17.20 | 17.13 | 17.18 |
| R2 Concentration (wt %) | | | | | |
| 1-Octene/ethylene in | 0.83 | 0.82 | 0.82 | 0.82 | 0.82 |
| Fresh Feed to R2 (g/g) | | | | | |
| Reactor 1 Temperature | 163.6 | 163.5 | 163.2 | 164.4 | 163.1 |
| (° C.) | | | | | |
| Reactor 2 Temperature | 199.9 | 200.1 | 200.0 | 199.8 | 200.2 |
| (° C.) | | | | | |
| Hydrogen in Reactor 1 | 3.25 | 3.23 | 3.24 | 3.22 | 2.57 |
| (ppm) | | | | | |
| Hydrogen in Reactor 2 | 15.06 | 14.92 | 14.90 | 14.92 | 11.52 |
| (ppm) | | | | | |
| Q^{R1} (%), Ethylene | 79.77 | 79.62 | 81.86 | 80.50 | 78.12 |
| Conversion in Reactor 1 | | | | | |
| Q^{R2} (%), Ethylene | 90.14 | 90.34 | 90.09 | 89.96 | 90.38 |
| Conversion in Reactor 2 | | | | | |
| (%) | | | | | |
| R1 Hold Up Time (s) | 85.31 | 85.32 | 85.35 | 85.28 | 85.34 |
| R2 Hold Up Time (s) | 93.02 | 93.02 | 93.05 | 92.95 | 92.99 |
| Catalysts Fed to R1 | metallocene | phosphinimine/ | phosphinimine/ | phosphinimine/ | phosphinimine/ |
| | | metallocene | metallocene | metallocene | metallocene |
| SSC 1 - Phosphinimine | 0 | 0.18 | 0.31 | 0.38 | 0.46 |
| Catalyst Fed to R1 (ppm) | | | | | |
| SSC 2- Metallocene | 0.57 | 0.62 | 0.50 | 0.38 | 0.33 |
| Catalyst Fed to R1 (ppm) | | | | | |
| Mol Percent of Total | 100% | 95% | 90% | 85% | 80% |
| SSCs Fed to R1 | metallocene | metallocene | metallocene | metallocene | metallocene |
| SSC - Al from MMAO- | 72.7 | 63.7 | 75 | 93.7 | 101.2 |
| 7/Hf + Ti in R1 (mol/mol) | | | | | |
| FIGSSC - BHEB/Al from | 0.3 | 0.3 | 0.3 | 0.3 | 0.3 |
| MMAO-7 in R1 (mol/mol) | | | | | |
| SSC - B/Hf + Ti in R1 | 1.30 | 1.30 | 1.30 | 1.30 | 1.30 |
| (mol/mol) | | | | | |
| Catalyst Fed to R2 | Ziegler-Natta | Ziegler-Natta | Ziegler-Natta | Ziegler-Natta | Ziegler-Natta |
| Catalyst Feed to R2 | 5.33 | 5.59 | 5.51 | 5.76 | 6.11 |
| (Titanium tetrachloride, | | | | | |
| TiCl₄ in ppm) | | | | | |
| ZN - tert-tert-Butyl | 1.91 | 1.91 | 1.90 | 1.92 | 1.91 |
| chloride/ | | | | | |
| Butyl(ethyl)magnesium in | | | | | |
| R2 (mol/mol) | | | | | |
| ZN - Diethylaluminum | 1.35 | 1.34 | 1.36 | 1.33 | 1.34 |
| ethoxide/TiCl₄ in R2 | | | | | |
| (mol/mol) | | | | | |
| ZN - Triethylaluminum/ | 0.37 | 0.37 | 0.37 | 0.37 | 0.37 |
| TiCl₄ in R2 (mol/mol) | | | | | |
| ZN - | 7.4 | 7.4 | 7.4 | 7.4 | 7.4 |
| Butyl(ethyl)magnesium/ | | | | | |
| TiCl₄ in R2 (mol/mol) | | | | | |
| Polyethylene | 78.3 | 78.6 | 79.0 | 78.5 | 78.2 |
| Composition Production | | | | | |
| Rate (kg/h) | | | | | |

TABLE 3
Polyethylene Composition Properties

| Example No. | 1 | 2 | 3 | 4 | 5 |
|---|---|---|---|---|---|
| Density (g/cm³) | 0.9144 | 0.9184 | 0.9234 | 0.9253 | 0.926 |
| I₂ (dg/min) | 1.2 | 1.55 | 3.57 | 4.2 | 3.58 |
| I₆ (dg/min) | 5.57 | 7.37 | 15.5 | 16.79 | 14.15 |
| I₂₁ (dg/min) | 39.33 | 56.36 | 103.37 | 98.68 | 81.84 |
| Melt Flow Ratio (I₂₁/I₂) | 32.91 | 36.36 | 28.99 | 23.5 | 22.86 |
| Stress Exponent | 1.4 | 1.42 | 1.34 | 1.26 | 1.25 |
| DSC - Melting Point (° C.) | 96.2 | 110.8 | 122.7 | 122.4 | 122.7 |
| Heat of Fusion (J/g) | 129.8 | 134.6 | 150.6 | 141.5 | 143.1 |
| Crystallinity (%) | 44.8 | 46.4 | 51.9 | 48.8 | 49.3 |
| GPC | | | | | |
| Mₙ - Number Average (g/mol) | 32,917 | 31,113 | 29,202 | 30,131 | 30,195 |
| M_{W} - Weight Average (g/mol) | 93,650 | 94,179 | 77,027 | 77,652 | 82,761 |
| M_{Z} - Z Average (g/mol) | 194,831 | 232,345 | 166,835 | 169,613 | 202,380 |
| Mw/Mn | 2.85 | 3.03 | 2.64 | 2.58 | 2.74 |
| Comonomer Content, FT-IR | 17.4 | 15.9 | 13.3 | 11.4 | 10.5 |
| Comonomer Weight % | 12.6 | 11.6 | 9.8 | 8.6 | 7.9 |
| Comonomer Mole % | 3.5 | 3.2 | 2.7 | 2.3 | 2.1 |
| CTREF Analysis | | | | | |
| High Elution Temperature (° C.) | 96.9 | 96.1 | 95.5 | 95.2 | 95 |
| CDBI-25 | 31.5 | 15.5 | 14.6 | 14.4 | 17.1 |
| CDBI-50 | 59.2 | 31.1 | 33.2 | 39.2 | 42.2 |
| C_{O}/H_{O} Ratio | 4.9 | 3.3 | 1.8 | 1.5 | 1.4 |
| Fraction Eluted at 30-60° C. (wt. %) | 19.9 | 29.1 | 19.6 | 13.6 | 11.5 |
| Fraction Eluted at 60-75° C. (wt. %) | 39.8 | 20.7 | 15.3 | 15.7 | 15.1 |
| Fraction Eluted at 75-90° C. (wt. %) | 23.4 | 26.8 | 30.0 | 30.0 | 31.1 |
| Fraction Eluted at 90-105° C. (%) | 16.9 | 23.4 | 35.1 | 40.7 | 42.3 |
| VICAT (° C.) | 98.2 | 100.4 | 106.2 | 109 | 110.5 |
| Activation Energy (kJ/mol) | 48.27 | 46.75 | 41.44 | 37.45 | 35.79 |

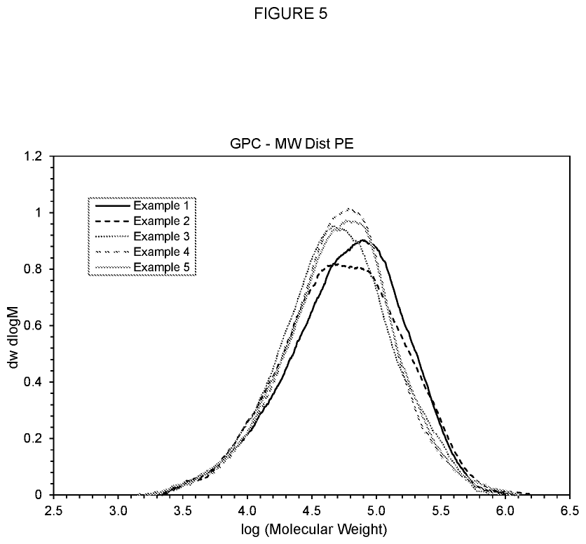

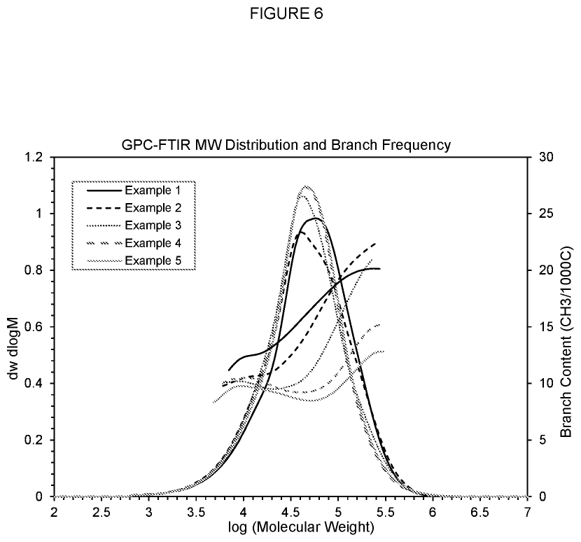

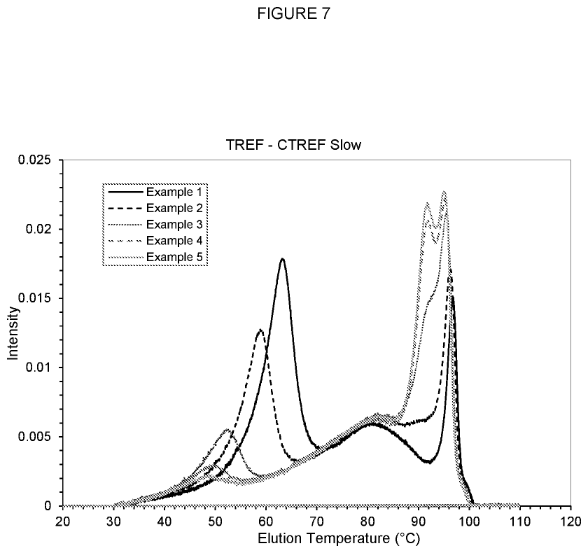

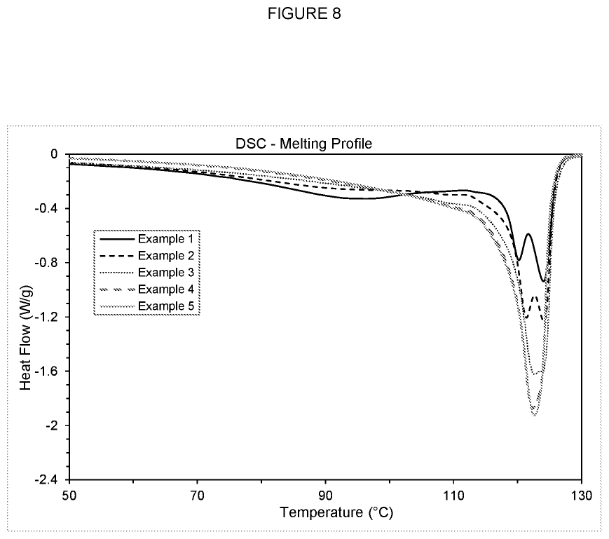

The GPC analysis of the polyethylene compositions of Examples 1-5 are shown in FIG. 5. The GPC-FTIR analysis of the polyethylene compositions of Examples 1-5 are shown in FIG. 6. The CTREF analysis of the polyethylene compositions of Examples 1-5 are shown in FIG. 7. Finally, the DSC analysis of the polyethylene compositions of Examples 1-5 are shown in FIG. 8.

The GPC data in FIG. 5 shows that the polyethylene compositions of Examples 1-5 have similar, and relatively narrow molecular weight distributions (Mw/Mn values) which range from about 2.5 to about 3.0. The CTREF data in FIG. 7 shows that the polyethylene compositions of Example 1-5 have a multimodal composition distribution despite their relatively narrow molecular weight distribution.

The GPC-FTIR data in FIG. 6 shows that as the molar ratio of the different single site catalysts used in the first reactor is changed, there is a change in the comonomer distribution. As the amount of metallocene catalyst is increased relative to the amount of phosphinimine catalyst, the comonomer distribution becomes more “reversed”. That is, increasingly greater amounts of 1-octene are located at higher molecular weights relative to amounts of 1-octene located at lower molecular weights. Hence, the data in FIG. 6 demonstrates that the comonomer distribution within the polyethylene composition can be tuned by using different molar ratios of metallocene to phosphinimine in a first upstream reactor. The GPC-FTIR data is also consistent with the fact that the metallocene catalyst has both a higher comonomer reactivity ratio (K_{1-octene}/K_{ethylene}) and a lower hydrogen response than does the phopshinimine catalyst. The CTREF analysis of the polyethylene compositions of Examples 1-5 are shown in FIG. 7. FIG. 7 shows that relative to an example in which only one single site catalyst is fed to the first reactor (Example 1), when two different single site catalysts are fed to a first reactor (Examples 2-5), the polyethylene composition has an enhanced multimodality in their composition distribution. Correspondingly, the DSC data in FIG. 8, clearly shows that relative to an example in which only one single site catalyst is fed to the first reactor (Example 1), when two different single site catalysts are fed to a first reactor (Examples 2-5), there is a decrease in the size of the peak appearing at above about 120° C. which can be attributed to changes in the comonomer distribution in the polyethylene composition as the molar ratio of metallocene to phosphinimine catalysts used in the first reactor is changed.

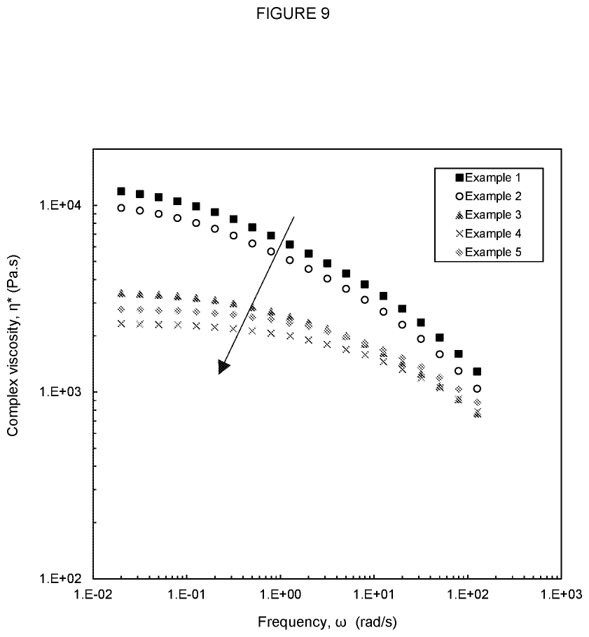

FIG. 9 shows the viscosity profiles from DMA frequency sweep experiments (viscosity, h* in Pa·s vs. the frequency, w in radians/s) carried out at 190° C. for polyethylene compositions made according to the present disclosure.

Without wishing to be bound by theory, the shape of the viscosity profile, and in particular the reduction in viscosity with the increasing rate of deformation will have a strong influence on the flow distribution and melt pressure requirements during extrusion and molding applications. FIG. 9 demonstrates that Examples 1 and 2 have improved shear thinning behavior (improved processability due to a higher degree of shear thinning), relative to Examples 3-5 because their viscosity decreases more rapidly as the shear rate increases. Without wishing to be bound by theory, the good shear thinning behavior is thought to be due to the presence of long chain branches.

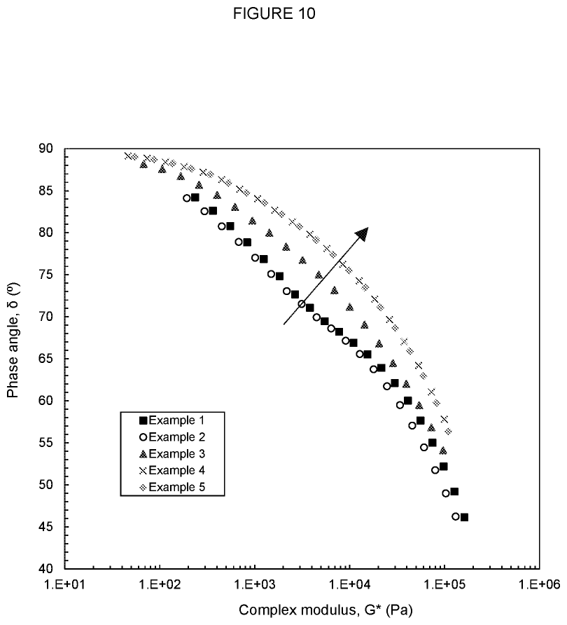

The different levels of long chain branching present in the polyethylene compositions of Examples 1-5 is further indicated by an observable difference in a Van Gurp Palmen (VGP) plots (see FIG. 10). A person skilled in the art examining the VGP plots, will realize that for Examples 1 and 2, in particular, a higher amount of long chain branching is indicated, and that this is consistent with use of a larger molar ratio of the metallocene catalyst relative to the phosphinimine catalyst in the first polymerization reactor. This data indicates, along with the flow activation energy (Ea) data provided in Table 3 that although long chain branching is present in all of the Inv. Examples 1-5, the degree of long chain branching can be tuned by changing the relative concentrations of the two different single site catalysts present in the first reactor.

A further series of pilot plant scale experiments was carried out in which two different single site catalysts (catalysts A and B) were fed to a first upstream polymerization reactor and a Ziegler-Natta catalyst was fed to a second downstream reactor, while targeting a polyethylene composition having a melt index of around 0.85 g/10 min and density of either 0.919 g/cm³ or 0.914 g/cm³ (Examples 7 and 9 respectively). The resulting polyethylene compositions were compared to polyethylenes having a similar melt index and density but which were made using only one single site catalyst (catalyst A) in a first upstream reactor and a Ziegler-Natta catalyst in a downstream reactor (Examples 6 and 8). The polymerization conditions are given in Table 4 and characterization data for the resulting polyethylene compositions is provided in Table 5.

TABLE 4
Polymerization Conditions

| | 6 | | 8 | |
|---|---|---|---|---|
| Example No. | (comparative) | 7 | (comparative) | 9 |
| Total Solution Rate (TSR) | 550.0 | 500.0 | 500.0 | 500.0 |
| (kg/h) | | | | |
| TSR R1 (kg/h) | 271.8 | 260.3 | 264.6 | 246.3 |
| TSR R2 (kg/h) | 278.2 | 239.7 | 235.5 | 253.7 |
| Ethylene Concentration | 15.1 | 14.2 | 14.7 | 12.7 |
| (wt % overall) | | | | |
| 1-Octene to Ethylene Ratio | 0.530 | 0.665 | 0.634 | 0.755 |
| Total | | | | |
| ES^{R1} (%), Ethylene Split | 45.0 | 45.0 | 45.0 | 45.0 |
| between First Reactor (R1) | | | | |
| and Second Reactor (R2) | | | | |
| CS^{R1} (%), 1-Octene Split | 22 | 37.90 | 29.10 | 39.88 |
| between First Reactor (R1) | | | | |
| and Second Reactor (R2), | | | | |
| Ethylene Fresh Feed to R1 | 13.75 | 12.30 | 12.51 | 11.60 |
| Concentration (wt %) | | | | |
| 1-Octene to Ethylene Ratio | 0.26 | 0.56 | 0.41 | 0.67 |
| in R1 Fresh Feed (g/g) | | | | |
| Ethylene Fresh Feed to R2 | 16.42 | 16.34 | 17.18 | 13.78 |
| Concentration (wt %) | | | | |
| 1-Octene/ethylene in Fresh | 0.75 | 0.75 | 0.82 | 0.83 |
| Feed to R2 (g/g) | | | | |
| Reactor 1 Temperature (° C.) | 170.1 | 155.1 | 163.9 | 154.1 |
| Reactor 2 Temperature (° C.) | 204.9 | 196.7 | 200.3 | 184.6 |
| Hydrogen in Reactor 1 | 3.50 | 3.50 | 3.25 | 3.00 |
| (ppm) | | | | |
| Hydrogen in Reactor 2 | 9.79 | 1.00 | 2.37 | 0.99 |
| (ppm) | | | | |
| Q^{R1} (%), Ethylene | 77.95 | 78.00 | 80.09 | 79.45 |
| Conversion in Reactor 1 | | | | |
| Q^{R2} (%), Ethylene | 91.14 | 91.30 | 90.95 | 91.58 |
| Conversion in Reactor 2 (%) | | | | |
| R1 Hold Up Time (s) | 83.01 | 86.74 | 85.3 | 91.67 |
| R2 Hold Up Time (s) | 84.58 | 93.04 | 93.03 | 93.04 |
| Catalysts Fed to R1 | metallocene | phosphinimine/ | metallocene | phosphinimine/ |
| | | metallocene | | metallocene |
| SSC 1 - Phosphinimine | 0 | 0.16 | 0 | 0.17 |
| Catalyst Fed to R1 (ppm) | | | | |
| SSC 2 - Metallocene | 0.41 | 0.53 | 0.63 | 0.58 |
| Catalyst Fed to R1 (ppm) | | | | |
| Mol Percent of Total SSCs | 100% | 95% | 100% | 95% |
| Fed to R1 | metallocene | metallocene | metallocene | metallocene |
| SSC - Al from MMAO-7/Hf + | 60 | 60 | 60 | 60 |
| Ti in R1 (mol/mol) | | | | |
| SSC - BHEB/Al from | 0.2 | 0.3 | 0.3 | 0.3 |
| MMAO-7 in R1 (mol/mol) | | | | |
| SSC - B/Hf + Ti in R1 | 1.31 | 1.30 | 1.30 | 1.30 |
| (mol/mol) | | | | |
| Catalyst Fed to R2 | Ziegler-Natta | Ziegler-Natta | Ziegler-Natta | Ziegler-Natta |
| Catalyst Feed to R2 | 5.35 | 5.67 | 6.44 | 4.49 |
| (Titanium tetrachloride, TiCl₄ | | | | |
| in ppm) | | | | |
| ZN - tert-tert-Butyl chloride/ | 1.92 | 1.91 | 1.92 | 1.91 |
| Butyl(ethyl)magnesium in | | | | |
| R2 (mol/mol) | | | | |
| ZN - Diethylaluminium | 1.35 | 1.35 | 1.35 | 1.35 |
| ethoxide/TiCl₄ in R2 | | | | |
| (mol/mol) | | | | |
| ZN - Triethylaluminium/ | 0.37 | 0.37 | 0.37 | 0.37 |
| TiCl₄ in R2 (mol/mol) | | | | |
| ZN - Butyl(ethyl)magnesium/ | 7.4 | 7.4 | 7.4 | 7.4 |
| TiCl₄ in R2 (mol/mol) | | | | |
| Polyethylene Composition | 85.1 | 77.7 | 79.0 | 71.4 |
| Production Rate (kg/h) | | | | |

TABLE 5
Polyethylene Composition Properties

| | 6 | | 8 | |
|---|---|---|---|---|
| Example No. | (comparative) | 7 | (comparative) | 9 |
| Density (g/cm³) | 0.9192 | 0.9187 | 0.9143 | 0.9156 |
| I₂ (dg/min) | 0.88 | 0.84 | 0.78 | 0.7 |
| I₆ (dg/min) | 4.13 | 4.0 | 3.59 | 3.28 |
| I₂₁ (dg/min) | 28.62 | 31.77 | 24.82 | 26.04 |
| Melt Flow Ratio (I₂₁/I₂) | 32.52 | 37.82 | 31.81 | 37.47 |
| Stress Exponent | 1.41 | 1.42 | 1.39 | 1.41 |
| DSC - Melting Point (° C.) | 105 | 123 | 96 | 122.7 |
| Heat of Fusion (J/g) | 131.1 | 130.9 | 120 | 121.4 |
| Crystallinity (%) | 45.2 | 45.2 | 41.4 | 41.9 |
| GPC | | | | |
| Mₙ - Number Average (g/mol) | 32,772 | 36,698 | 40,090 | 35,016 |
| M_{w} - Weight Average (g/mol) | 95,553 | 114,739 | 100,312 | 109,214 |
| M_{z} - Z Average (g/mol) | 197,540 | 313,116 | 195,597 | 271,247 |
| Mw/Mn | 2.92 | 3.13 | 2.50 | 3.12 |
| LCBF | 2.24E−02 | 3.47E−03 | 1.91E−02 | 6.97E−04 |
| Comonomer Content, FT-IR | 14 | 15.6 | 17.6 | 17.5 |
| Comonomer Weight % | 10.3 | 11.4 | 12.7 | 12.7 |
| Comonomer Mole % | 2.8 | 3.1 | 3.5 | 3.5 |
| CTREF Analysis | | | | |
| High Elution Temperature (° C.) | 96.2 | 96.2 | 96.7 | 96.5 |
| CDBI-25 | 50.8 | 16.3 | 27.5 | 22.1 |
| CDBI-50 | 71.0 | 35.4 | 56.3 | 39.2 |
| C_{O}/H_{O} Ratio | 7.1 | 1.8 | 4.5 | 1.0 |
| Fraction Eluted at 30-60° C. | 7.0 | 16.4 | 25.3 | 9.1 |
| (wt. %) | | | | |
| Fraction Eluted at 60-75° C. | 36.6 | 14.7 | 34.2 | 16.2 |
| (wt. %) | | | | |
| Fraction Eluted at 75-90° C. | 44.0 | 33.3 | 22.2 | 39.8 |
| (wt. %) | | | | |
| Fraction Eluted at 90-105° C. | 12.4 | 35.6 | 18.3 | 34.9 |
| (%) | | | | |
| Melt Strength (cN) | 4.72 | 4.38 | 5.31 | 4.6 |
| VICAT (° C.) | 105.1 | 86.2 | 97 | 101 |
| Activation Energy (kJ/mol) | — | 39.24 | 45.57 | 37.31 |

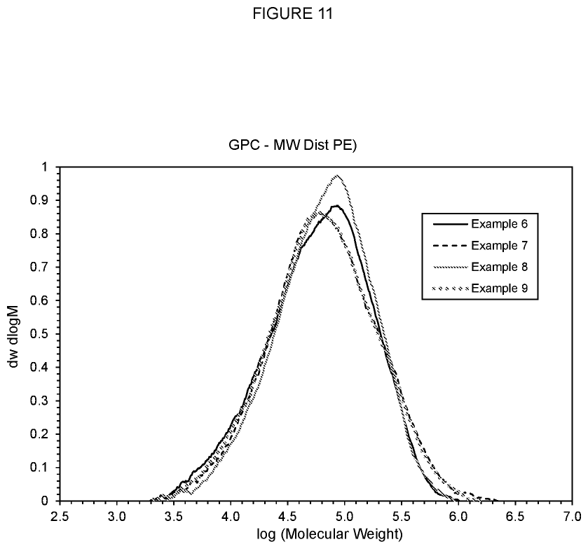

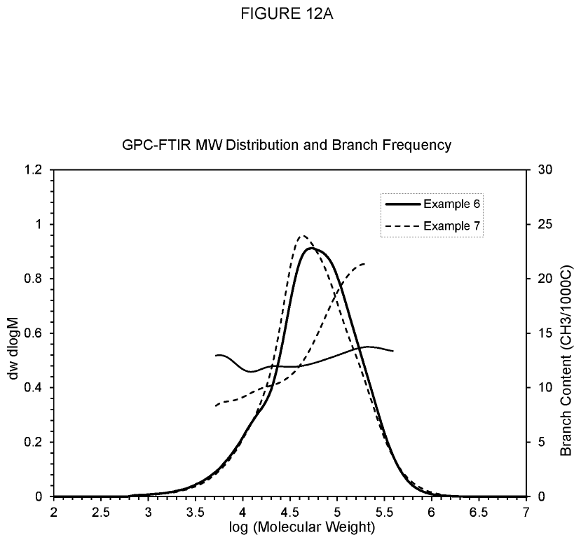

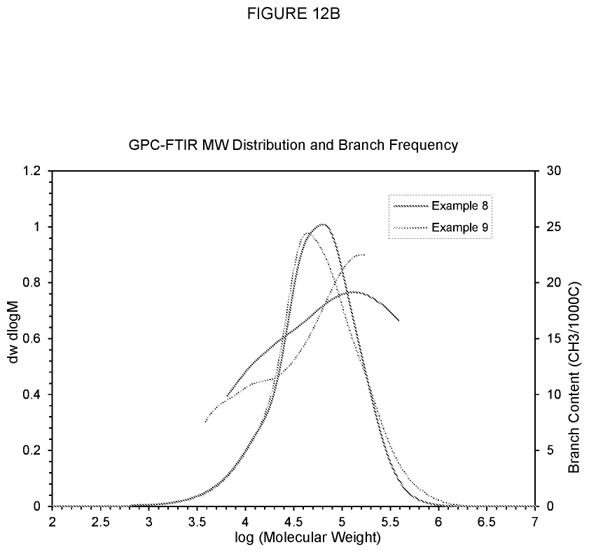

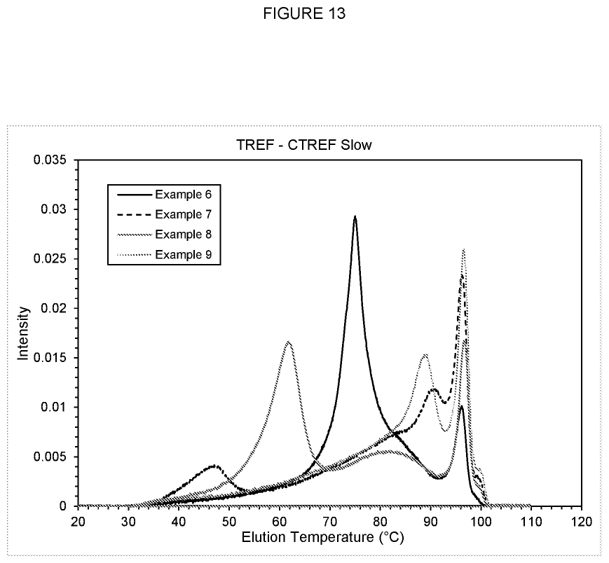

The GPC analysis of the polyethylene compositions of Examples 6-9 are shown in FIG. 11. The GPC-FTIR analysis of the polyethylene compositions of Examples 6-9 are shown in FIGS. 12A and 12B. The CTREF analysis of the polyethylene compositions of Examples 6-9 are shown in FIG. 13.

The data provided in FIGS. 11, 12A, 12B, and 13 show that the polyethylene compositions of Examples 7 and 9 which are made using two different single site catalysts in the first upstream reactor (Catalysts A and B), have a similar molecular weight distributions to those of Example 6 and 8 which are made using only a metallocene in the first upstream reactor (Catalyst A), while also having an enhanced multimodality in their composition distribution (see the CTREF profiles in FIG. 13) and a more highly reverse comonomer distribution (compare the GPC-FTIR data provided in each of FIG. 12A and FIG. 12B) even when the polyethylene compositions made have a similar melt index and density.

Non-limiting embodiments of the present disclosure include the following:

Embodiment A. A continuous solution phase polymerization process to make a polyethylene composition, the process comprising:
feeding ethylene, a process solvent, a metallocene catalyst, a phosphinimine catalyst, optionally one or more than one α-olefin and optionally hydrogen into a first polymerization reactor to produce a first effluent stream comprising a first polyethylene which is made in the first reactor;
feeding the first effluent stream, ethylene, a process solvent, a Ziegler-Natta catalyst, optionally one or more than one α-olefin and optionally hydrogen into a second polymerization reactor configured in series with the first polymerization reactor to produce a second effluent stream comprising the first polyethylene, and a second polyethylene which is made in the second reactor; and
a) recovering the polyethylene composition from the second effluent stream; or,
b) feeding the second effluent stream, optionally ethylene, optionally a process solvent, optionally a polymerization catalyst selected from a single site catalyst or a Ziegler-Natta catalyst, optionally one or more than one α-olefin, and optionally hydrogen into a third polymerization reactor configured in series with the second polymerization reactor to produce a third effluent stream comprising the first polyethylene, the second polyethylene, and a third polyethylene which is made in the third reactor; and
recovering the polyethylene composition from the third effluent stream.

Embodiment B. The process of Embodiment A wherein the first polymerization reactor is operated at lower temperature than the second polymerization reactor.

Embodiment C. The process of Embodiment A or B wherein the metallocene catalyst is defined by the formula (I):

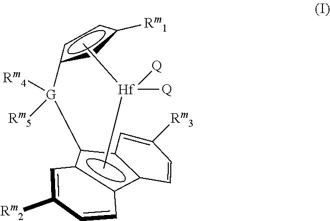

wherein G is a group 14 element selected from carbon, silicon, germanium, tin or lead; R^{m}₁ is a hydrogen atom, a C₁₋₂₀ hydrocarbyl radical, a C₁₋₂₀ alkoxy radical or a C₆₋₁₀ aryl oxide radical; R^{m}₂ and R^{m}₃ are independently selected from a hydrogen atom, a C₁₋₂₀ hydrocarbyl radical, a C₁₋₂₀ alkoxy radical or a C₆₋₁₀ aryl oxide radical; R^{m}₄ and Rms are independently selected from a hydrogen atom, a C₁₋₂₀ hydrocarbyl radical, a C₁₋₂₀ alkoxy radical or a C₆₋₁₀ aryl oxide radical; and Q is independently an activatable leaving group.

Embodiment D. The process of Embodiment A, B, or C wherein the phosphinimine catalyst is defined by the formula (II):

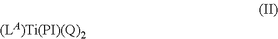

wherein L^{A} is selected from the group consisting of unsubstituted cyclopentadienyl, substituted cyclopentadienyl, unsubstituted indenyl, substituted indenyl, unsubstituted fluorenyl and substituted fluorenyl; PI is a phosphinimine ligand; and Q is independently an activatable leaving group.

Embodiment E. The process of Embodiment A, B, C, or D wherein the first, second and third polymerization reactors operate at a temperature of from 80° C. to 310° C. and a pressure of from 3 MPag to 45 MPag.

Embodiment F. The process of Embodiment A, B, C, D, or E wherein the first polymerization reactor operates at a temperature which is at least 15° C. lower than the temperature at which the second polymerization reactor operates.

Embodiment G. The process of Embodiment A, B, C, D, or E wherein the first polymerization reactor operates at a temperature which is at least 30° C. lower than the temperature at which the second polymerization reactor operates.

Embodiment H. The process of Embodiment A, B, C, D, E, F, or G wherein the first polymerization reactor operates at a temperature of from 125° C. to 180° C., the second polymerization reactor operates at a temperature of from 165° C. to 205° C. and the third polymerization reactor operates at a temperature of from 185° C. to 240° C.

Embodiment I. The process of Embodiment A, B, C, D, E, F, G, or H wherein the first polymerization reactor and the second polymerization reactor are continuously stirred tank reactors.

Embodiment J. The process of Embodiment A, B, C, D, E, F, G, H, or I wherein the third polymerization reactor is a tubular reactor.

Embodiment K. The process of Embodiment A, B, C, D, E, F, G, H, I, or J wherein the molar ratio of the metallocene catalyst to the phosphinimine catalyst fed to the first polymerization reactor is at least 80:20.

Embodiment L. The process of Embodiment A, B, C, D, E, F, G, H, I, or J wherein the molar ratio of the metallocene catalyst to the phosphinimine catalyst fed to the first polymerization reactor is at least 90:10.

Embodiment M. The process of Embodiment A, B, C, D, E, F, G, H, I, or J wherein the molar ratio of the metallocene catalyst to the phosphinimine catalyst fed to the first polymerization reactor is at least 95:5.

Embodiment N. The process of Embodiment A, B, C, D, E, F, G, H, I, or J wherein the molar ratio of the metallocene catalyst to the phosphinimine catalyst fed to the first polymerization reactor is from 90:10 to 99:1.

Embodiment O. The process of Embodiment A, B, C, D, E, F, G, H, I, or J wherein the molar ratio of the metallocene catalyst to the phosphinimine catalyst fed to the first polymerization reactor is from 95:5 to 99:1.

Embodiment P. The process of Embodiment A, B, C, D, E, F, G, H, I, J, K, L, M, N, or O wherein the first polyethylene comprises a higher molecular weight polyethylene component made by the metallocene catalyst and a lower molecular weight polyethylene component made by the phosphinimine catalyst.

Embodiment Q. The process of Embodiment P wherein the higher molecular weight polyethylene component made by the metallocene catalyst has a lower density than the density of the lower molecular weight polyethylene component made by the phosphinimine catalyst.

Embodiment R. The process of Embodiment P or Q wherein when one or more than one α-olefin is fed to the first polymerization reactor, the higher molecular weight polyethylene component made by the metallocene catalyst has more short chain branches per thousand carbon atoms, SCB/1000 carbon atoms, than the lower molecular weight polyethylene component made by the phosphinimine catalyst.

Embodiment 5. The process of Embodiment A, B, C, D, E, F, G, H, I, J, K, L, M, N, O, P, Q, or R wherein the polyethylene composition has a molecular weight distribution, Mw/Mn, of from 2.0 to 5.0.

Embodiment T. The process of Embodiment A, B, C, D, E, F, G, H, I, J, K, L, M, N, O, P, Q, or R wherein the polyethylene composition has a molecular weight distribution, Mw/Mn, of from 2.0 to 4.0.

Embodiment U. The process of Embodiment A, B, C, D, E, F, G, H, I, J, K, L, M, N, O, P, Q, R, S, or T wherein the polyethylene composition has a unimodal profile in a gel permeation chromatogram.

Embodiment V. The process of Embodiment A, B, C, D, E, F, G, H, I, J, K, L, M, N, O, P, Q, R, S, T, or U wherein the polyethylene composition has a reversed comonomer incorporation.

Embodiment W. The process of Embodiment A, B, C, D, E, F, G, H, I, J, K, L, M, N, O, P, Q, R, S, T, U, or V wherein the polyethylene composition has a multimodal profile in a temperature rising elution fractionation analysis.

Embodiment X. The process of Embodiment A, B, C, D, E, F, G, H, I, J, K, L, M, N, O, P, Q, R, S, T, U, V, or W wherein the polyethylene composition has an activation energy of flow, Ea, of greater than 30 kJ/mol.

Embodiment Y. The process of Embodiment A, B, C, D, E, F, G, H, I, J, K, L, M, N, O, P, Q, R, S, T, U, V, or W wherein the polyethylene composition has an activation energy of flow, Ea, of greater than 30 kJ/mol and less than 80 kJ/mol.

Embodiment Z. The process of Embodiment A, B, C, D, E, F, G, H, I, J, K, L, M, N, O, P, Q, R, S, T, U, V, or W wherein the polyethylene composition has an activation energy of flow, Ea, of greater than 30 kJ/mol and less than 60 kJ/mol.

### INDUSTRIAL APPLICABILITY

Multiple solution phase polymerization reactors are used in combination with mixed single site catalysts and a Ziegler-Natta catalyst to provide a polyethylene composition.

1. A continuous solution phase polymerization process to make a polyethylene composition, the process comprising:
feeding ethylene, a process solvent, a metallocene catalyst, a phosphinimine catalyst, optionally one or more than one α-olefin and optionally hydrogen into a first polymerization reactor to produce a first effluent stream comprising a first polyethylene which is made in the first reactor;
feeding the first effluent stream, ethylene, a process solvent, a Ziegler-Natta catalyst, optionally one or more than one α-olefin and optionally hydrogen into a second polymerization reactor configured in series with the first polymerization reactor to produce a second effluent stream comprising the first polyethylene, and a second polyethylene which is made in the second reactor; and
a) recovering the polyethylene composition from the second effluent stream; or,
b) feeding the second effluent stream, optionally ethylene, optionally a process solvent, optionally a polymerization catalyst selected from a single site catalyst or a Ziegler-Natta catalyst, optionally one or more than one α-olefin, and optionally hydrogen into a third polymerization reactor configured in series with the second polymerization reactor to produce a third effluent stream comprising the first polyethylene, the second polyethylene, and a third polyethylene which is made in the third reactor; and
recovering the polyethylene composition from the third effluent stream.

2. The process of claim 1 wherein the first polymerization reactor is operated at lower temperature than the second polymerization reactor.

3. The process of claim 1 wherein the metallocene catalyst is defined by the formula (I): 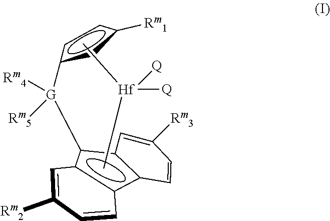
wherein G is a group 14 element selected from carbon, silicon, germanium, tin or lead; R^{m}₁ is a hydrogen atom, a C₁₋₂₀ hydrocarbyl radical, a C₁₋₂₀ alkoxy radical or a C₆₋₁₀ aryl oxide radical; R^{m}₂ and R^{m}₃ are independently selected from a hydrogen atom, a C₁₋₂₀ hydrocarbyl radical, a C₁₋₂₀ alkoxy radical or a C₆₋₁₀ aryl oxide radical; R^{m}₄ and R^{m}₅ are independently selected from a hydrogen atom, a C₁₋₂₀ hydrocarbyl radical, a C₁₋₂₀ alkoxy radical or a C₆₋₁₀ aryl oxide radical; and Q is independently an activatable leaving group.

4. The process of claim 1 wherein the phosphinimine catalyst is defined by the formula (II): 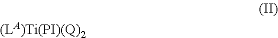
wherein L^{A} is selected from the group consisting of unsubstituted cyclopentadienyl, substituted cyclopentadienyl, unsubstituted indenyl, substituted indenyl, unsubstituted fluorenyl and substituted fluorenyl; PI is a phosphinimine ligand; and Q is independently an activatable leaving group.

5. The process of claim 1 wherein the first, second and third polymerization reactors operate at a temperature of from 80° C. to 310° C. and a pressure of from 3 MPag to 45 MPag.

6. The process of claim 1 wherein the first polymerization reactor operates at a temperature which is at least 15° C. lower than the temperature at which the second polymerization reactor operates.

7. The process of claim 1 wherein the first polymerization reactor operates at a temperature which is at least 30° C. lower than the temperature at which the second polymerization reactor operates.

8. The process of claim 1 wherein the first polymerization reactor operates at a temperature of from 125° C. to 180° C., the second polymerization reactor operates at a temperature of from 165° C. to 205° C. and the third polymerization reactor operates at a temperature of from 185° C. to 240° C.

9. The process of claim 1 wherein the first polymerization reactor and the second polymerization reactor are continuously stirred tank reactors.

10. The process of claim 1 wherein the third polymerization reactor is a tubular reactor.

11. The process of claim 1 wherein the molar ratio of the metallocene catalyst to the phosphinimine catalyst fed to the first polymerization reactor is at least 80:20.

12. The process of claim 1 wherein the molar ratio of the metallocene catalyst to the phosphinimine catalyst fed to the first polymerization reactor is at least 90:10.

13. The process of claim 1 wherein the molar ratio of the metallocene catalyst to the phosphinimine catalyst fed to the first polymerization reactor is at least 95:5.

14. The process of claim 1 wherein the molar ratio of the metallocene catalyst to the phosphinimine catalyst fed to the first polymerization reactor is from 90:10 to 99:1.

15. The process of claim 1 wherein the molar ratio of the metallocene catalyst to the phosphinimine catalyst fed to the first polymerization reactor is from 95:5 to 99:1.

16. The process of claim 1 wherein the first polyethylene comprises a higher molecular weight polyethylene component made by the metallocene catalyst and a lower molecular weight polyethylene component made by the phosphinimine catalyst.

17. The process of claim 16 wherein the higher molecular weight polyethylene component made by the metallocene catalyst has a lower density than the density of the lower molecular weight polyethylene component made by the phosphinimine catalyst.

18. The process of claim 16 wherein when one or more than one α-olefin is fed to the first polymerization reactor, the higher molecular weight polyethylene component made by the metallocene catalyst has more short chain branches per thousand carbon atoms, SCB/1000 carbon atoms, than the lower molecular weight polyethylene component made by the phosphinimine catalyst.

19. The process of claim 1 wherein the polyethylene composition has a molecular weight distribution, Mw/Mn, of from 2.0 to 5.0.

20. The process of claim 1 wherein the polyethylene composition has a molecular weight distribution, Mw/Mn, of from 2.0 to 4.0.

21. The process of claim 1 wherein the polyethylene composition has a unimodal profile in a gel permeation chromatogram.

22. The process of claim 1 wherein the polyethylene composition has a reversed comonomer incorporation.

23. The process of claim 1 wherein the polyethylene composition has a multimodal profile in a temperature rising elution fractionation analysis.

24. The process of claim 1 wherein the polyethylene composition has an activation energy of flow, Ea, of greater than 30 kJ/mol.

25. The process of claim 1 wherein the polyethylene composition has an activation energy of flow, Ea, of greater than 30 kJ/mol and less than 80 kJ/mol.

26. The process of claim 1 wherein the polyethylene composition has an activation energy of flow, Ea, of greater than 30 kJ/mol and less than 60 kJ/mol.
